(19) United States
(12) Patent Application Publication
(10) Pub. No.: US 2020/0272963 A1
(43) Pub. Date: Aug. 27, 2020

(54) SYSTEM, DEVICE AND METHODS FOR AUDIT MANAGEMENT

(71) Applicant: Mitchell Chait, Las Vegas, NV (US)

(72) Inventor: Mitchell Chait, Las Vegas, NV (US)

(21) Appl. No.: 16/802,493

(22) Filed: Feb. 26, 2020

Related U.S. Application Data
(60) Provisional application No. 62/810,948, filed on Feb. 26, 2019.

(51) Int. Cl. G06Q 10/06

(52) U.S. Cl. CPC G06Q 10/0635

(57) ABSTRACT

An audit management system that monitors auditor behavior and observations to detect outliers during the execution of an audit by deriving a pattern of behavior and observations from audit metadata and comparing the derived data to historical audit data. The system and methods improve the accuracy, validity and reliability of product and process audits.

### CROSS-REFERENCE TO RELATED APPLICATIONS

This application claims priority to U.S. Provisional Application Ser. No. 62/810,948 filed Feb. 26, 2019, the contents of which is incorporated in their entirety herein.

### FIELD

The present invention relates to a system, device and method for audit management. More particularly, but not exclusively, the present invention relates to systems, devices and methods to improve accuracy and reliability of audits through the capture and analysis of data that is unique to the location, personnel, and performance of such audits.

### BACKGROUND

Many industries use audits to manage risk and maintain quality. Audits can be categorized based on the auditor-auditee relationship. First-Party audits are self-assessments that offer internal verification that procedure and management strategies meet the requirements of a defined criteria. Second-Party audits assess the performance of suppliers or contractors to a criteria defined by the first party, and Third-Party audits relate to the conduction of audits by independent parties that are not employed by the auditee and may lead to certification against an externally recognized standard or scheme.

The food industry, for example, is one in which food safety and quality audits are widely used. Audits are typically used in the food industry to evaluate management systems, obtain certifications to certain food safety and quality standards or schemes, assess the condition of the premises and products, and confirm legal compliance, etc. Nowadays, the increased interest in consumers on food safety and quality matters, triggered mainly by recent food scandals, has enabled the public and private food sectors to develop a variety of food safety and quality standards and schemes. K. Kotsanospoulos, The Role of Auditing, Food Safety, and Food Quality Standards in the Food Industry: A Review, Comprehensive Reviews in Food Science and Food Safety Vol. 16, 2017 (Jul. 3, 2017). These standards have both the advantages and disadvantages and their effectiveness depends on several factors such as competency and skills of the auditors and the standards used in each case. Id. Although the industry continuously invests in developing and improving these systems, the number of foodborne outbreaks per year appears to be quite stable in both Europe and the United States. Id. This may be an indication that additional measures and techniques or a different approach would be required to improve the effectiveness of the food safety and quality management systems. Id. The disclosed invention may also detect fraudulent audits.

With respect to the food industry, for example, human consumption of food relies upon the production and provision of safe, quality food through complex, global supply chains. Yet, according to the World Health Organization, “[a]n estimated 600 million—almost 1 in 10 people in the world—fall ill after eating contaminated food and 420,000 die every year, resulting in the loss of 33 million healthy life years . . . [u]nsafe food creates a vicious cycle of disease and malnutrition, particularly affecting infants, young children, elderly and the sick.” (https://www.who.int/news-room/fact-sheets/detail/food-safety). The principle form of protection against this prevalent problem is achieved through the auditing of food supply chains, yet only a small proportion of organizations in this sector are actually audited. For example, there are approximately 570 million farms globally (https://www.globalagriculture.org/report-topics/industrial-agriculture-and-small-scale-farming.html) of which an estimated 300,000 are certified against recognized food safety criteria by undergoing an audit. These figures highlight a number of alarming issues that affect the risk, health and mortality of large human populations. There is a need, therefore, for a system, device and method for improving the effectiveness of safety and quality of audited goods, such as food products, but also the need for improvements across all industries and sectors for a variety of criteria, including but not limited to quality, environment, health, sustainability and human rights.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

It is well documented that fraud in an audit network may lead to illegitimate ISO certificates that are difficult to detect. This problem is described in Is it Legitimate? How to tell if your ISO Certificate is Real or Fake, (https://streamline.business/is-it-legitimate-how-to-tell-ifyour-iso-certificate-is-reakor-fake/) the contents of which are hereby incorporated by reference thereto. In one aspect, there is provided an audit system capable of detecting fraud in an audit network. In this aspect, fraud may include activity that is an abuse of position, false representation, or prejudicing someone's rights for personal gain or more specifically include food fraud. See, e.g., Louise Manning et al., Food Safety, Food Fraud, and Food Defense: A Fast Evolving Literature, Institute of Food Technologies, (2016) and Global Perspectives on Food Fraud, results from a WHO survey of members of the International Food Safety Authorities Network (INFOSAN), NPJ Science of Food, (2019), the contents of each of which are hereby incorporated by reference. The system includes a device that is configured to receive from one or more devices real-time behavior and observations of a user, such as an auditor. The receipt of the real-time behavior and observations may be in the form of metadata transmitted from the one or more devices. The device may further include a database having one or more storage modules. The one or more storage modules may include historical data or metadata comprising the behavior and observations of a plurality of auditors. The device further includes a processor that is configured to receive the audit metadata from the first auditor device. The generated audit metadata includes behavior or observations of the auditor during a period of time. The data analytics operation is configured to derive patterns of behavior or observations during an audit and compare those patterns to historical patterns of audit behavior or observations stored in the database to determine whether there is an outlier based on that comparison. In this regard, the management device may detect single or multiple fraud events or wide-scale fraud in auditing of an industry or with one or more auditors.

In another aspect, a system is provided. The system includes a first device comprising a processor and one or more sensors. The first device is configured to monitor behavior or observations of an auditor through the one or more sensors in real-time during execution of an audit to generate audit metadata. The system further includes a second device comprising a processor and a database. The second device is operatively connected to the first device through a network interface. The second device is configured to receive the audit metadata from the first device. The generated audit metadata includes behavior or observations of the auditor during a period of time. The second device is configured to perform a data analytics operation on the received audit metadata. The data analytics operation generates or derives patterns of behavior or observation during the audit. A comparison of patterns of audit behavior or observations to historical patterns of audit behavior or observation stored in the database may be done to determine an outlier based on the comparison. The outlier may be an indication of fraud or other malfeasance.

Embodiments of the audit system described above include the audit system wherein: the period of time is the execution of an audit, the second device is configured to perform the data analytics operation in real-time as the audit metadata is received, the second device is configured to transmit an alert notification when an outlier is determined. The alert may be transmitted to a technical reviewer or an auditee or other individual. At least one of the first or second device is a portable or mobile device.

In some embodiments, the sensor is selected from the group consisting of: gyroscope, accelerometer, image sensor or camera, proximity sensor, and microphone sensor, or a combination thereof. The audit metadata includes electronic location information, timestamp information, specific gesture information, or duration information.

The processor associated with the second device is configured to receive the pattern of behavior or observation completed by a particular auditor and further generates a distance or path traveled by the auditor as the locations of the particular auditor are received by the first device.

The specified patterns of fraudulent audit execution indicate that the net distance traveled is less than a threshold distance stored in the historical pattern of behavior or observation.

The second device is configured to receive the audit metadata, and further wherein the second device derives a trust rating associated with a particular auditor based on the comparison of the audit metadata to the historical pattern of behavior or observation of the audit metadata.

The audit system may comprise any of the above embodiments alone or in any combination.

Another aspect of the disclosed subject matter provides a virtual audit marketplace in which a method of identifying an auditor based on electronic location information and qualifications or rating information is provided to an auditee or audit requester seeking an audit.

In one embodiment, the method includes registering, by one or more processors, an auditee and a plurality of auditors with an audit management system including a networked based system or device. In response to the registration of the auditee, a location and market segment of the auditee or audit site is determined based on electronic location information and/or the identity of the auditee or site. Responsive to registering each of the plurality of auditors, respective locations, qualifications, and rating of each of the plurality of auditors is determined for each auditor. The method further includes receiving, over the network, a request for an audit from the auditee or audit requester. Responsive to receiving the audit request, one or more auditors for conducting at least a portion of an audit is automatically identified by the one or more processors. The identity of the one or more auditors is transmitted, via the network, to the auditee or audit requestor. The request for quotation may be directly to the one or more auditors for bidding on the request. The identities of the auditors may be anonymous during the bidding.

Embodiments of the method described above include the method wherein: a technical reviewer is blind to at least one of the identity of the first auditor and auditee.

The method or virtual audit marketplace may comprise any of the above embodiments alone or in any combination.

In yet another aspect, a non-transitory computer readable medium residing on a computer readable storage device for processing audit metadata, the computer readable storage medium comprising instructions which, when executed by a processor coupled to the computer readable storage device, cause the processor to process, on a plurality of parallel audit processors that are instantiated on the processor, a plurality electronic metadata including behavior and observations generated by one or more auditors, wherein each electronic metadata in the plurality of electronic metadata has one of a plurality of unique identifiers that identifies the metadata as pertaining to a specific auditor, auditee, or audit site and route received electronic metadata to one or more parallel audit processors wherein instructions, which when executed by the processor, cause the one or more audit processors to compare, using the one audit processor the received electronic metadata to historical electronic metadata stored in a database to determine if an outlier exists; and execute, using the audit processor, an alert or notification when an outlier occurs for the received electronic metadata.

These embodiments, and others described in greater detail herein, provide the company with improved efficiency and versatility in placing, and thus executing, audits for commodities such as in the food industry. Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a schematic illustration of an audit system in accordance with an exemplary embodiment of the disclosed subject matter.

FIG. 2 is a detailed schematic illustration of a first device in accordance with the system of FIG. 1.

FIG. 3 is a detailed schematic illustration of a second device in accordance with the system of FIG. 1.

FIG. 4 is a schematic illustration of a data structure in accordance with the system of FIG. 1.

FIGS. 5-6 are process flows in accordance with an exemplary embodiment of the disclosed subject matter.

FIGS. 7-22 are screenshots of a graphical user interface (GUI) in accordance with an exemplary embodiment of the disclosed subject matter showing features of the audit planning modules.

FIGS. 23-25 are screenshots of a graphical user interface (GUI) in accordance with an exemplary embodiment of the disclosed subject matter showing features of the dashboard module.

FIGS. 26-27 are screenshots of a graphical user interface (GUI) in accordance with an exemplary embodiment of the disclosed subject matter showing features of the audit execution module related to travel to an audit site.

FIGS. 28-30 are screenshots of a graphical user interface (GUI) in accordance with an exemplary embodiment of the disclosed subject matter showing features of the audit execution module related to an audit plan overview and scheduling of audit events.

FIGS. 31-40 are screenshots of a graphical user interface (GUI) in accordance with an exemplary embodiment of the disclosed subject matter showing features of the audit execution module related to a first event of an audit comprising an interview and observations including prompts for uploading interview recordings, transcripts, data and auditor comments.

FIGS. 41-48 are screenshots of a graphical user interface (GUI) in accordance with an exemplary embodiment of the disclosed subject matter showing features of the audit execution module related to a second event of an audit comprising a location walk-around including prompts for uploading observations, video, audio, data and auditor comments.

FIGS. 49 and 50 are screenshots of a graphical user interface (GUI) in accordance with an exemplary embodiment of the disclosed subject matter showing features of the audit execution module related to an audit findings log.

FIG. 51 is a screenshot of a graphical user interface (GUI) in accordance with an exemplary embodiment of the disclosed subject matter showing a screen for entry of a non-compliance finding.

FIGS. 52-54 are screenshots of a graphical user interface (GUI) in accordance with an exemplary embodiment of the disclosed subject matter showing features of the audit execution module related to audit report generation including an executive summary and clause summary overview.

FIG. 55 is a screenshot of a graphical user interface (GUI) in accordance with an exemplary embodiment of the disclosed subject matter showing features of the audit execution module related to an audit plan overview with event progress information.

FIG. 56 is a screenshot of a graphical user interface (GUI) in accordance with an exemplary embodiment of the disclosed subject matter showing a screen related to a messaging module with contacts.

FIGS. 57 depicts one embodiment of a page of a graphical user interface (GUI).

FIGS. 58-59 are screenshots of a graphical user interface (GUI) in accordance with an exemplary embodiment of the disclosed subject matter showing features of the dashboard module including audit overview and audit progress information.

FIGS. 60-62 are screenshots of a graphical user interface (GUI) in accordance with an exemplary embodiment of the disclosed subject matter showing features of a map module related to a site map including locations visited during an audit.

FIGS. 63-73 are screenshots of a graphical user interface (GUI) in accordance with an exemplary embodiment of the disclosed subject matter showing features of a CAPA Closeout module.

FIG. 74 is a screenshot of a graphical user interface (GUI) in accordance with an exemplary embodiment of the disclosed subject matter showing an executive summary.

FIG. 75 is a screenshot of a graphical user interface (GUI) in accordance with an exemplary embodiment of the disclosed subject matter showing an audit finding log.

FIG. 76 is a screenshot of a graphical user interface (GUI) in accordance with an exemplary embodiment of the disclosed subject matter showing an interview transcript log (sandbox).

FIG. 77 is a screenshot of a graphical user interface (GUI) in accordance with an exemplary embodiment of the disclosed subject matter showing a clause log (sandbox).

FIG. 78 is a chart showing an example of an audit progress summary in accordance with an exemplary embodiment of the disclosed subject matter.

FIG. 79 is a chart showing an example of an audit scheduling summary in accordance with an exemplary embodiment of the disclosed subject matter.

### DETAILED DESCRIPTION

Reference has been made in detail to select embodiments of the disclosed subject matter, examples of which are illustrated in the accompanying drawings. The method and corresponding steps of the disclosed subject matter will be described in conjunction with the detailed description of the system.

Unless defined otherwise, all technical and scientific terms used herein have the same meaning as commonly understood by one of ordinary skill in the art to which this disclosed subject matter belongs. Although any methods and materials similar or equivalent to those described herein can also be used in the practice or testing of the present disclosed subject matter, this disclosure may specifically mention certain exemplary methods and materials.

As used herein and in the appended claims, the singular forms “a,” “an,” and “the” include plural referents unless the context clearly dictates otherwise.

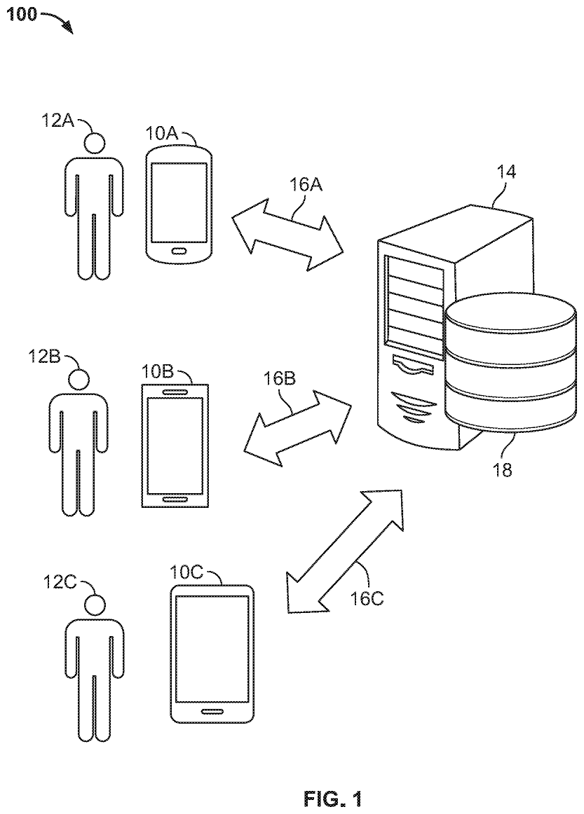

In accordance with the various embodiments of the disclosed subject matter, and audit system 100 is illustrated in FIG. 1. Audit system 100 provides audit services for a plurality of users including one or more auditors 12A, one or more auditees 12B, and one or more audit requestors 12C. For example, but not limitation, auditor 12A may be one or more of an independent auditor, company auditor, Certification Body (CB) auditor. As is understood in the art, an audit requestor 12C is in need of audit services. For example, audit requestor 12C seeks to determine whether the business practices of auditee 12B comply with defined criteria, such as existing standards or schemes concerning, but not limited to environmental, worker safety and food safety. Thus auditor requestor 12C seeks the services of one or more auditors 12A to execute the audit of auditee 12B. In some embodiments, auditor requestor will be the auditee 12B. Further, the audit requestor 12C, which may or may not be the auditee, submits a Request for Quotation (RFQ) to seek services of a pre-qualified auditor.

Accordingly, system 100 includes one or more devices 10A, 10B, or 10C associated respectively with one or more auditors 12A, one or more auditees 12B, and one or more audit requestors 12C. Each of devices 10A, 10B, or 10C can be a mobile device such as a mobile phone, tablet, laptop computer, etc. having an operating system such as Apple OS, Android, Linux and the like. Devices 10A, 10B, or 10C are in communication with device 14 via respective communication interfaces 16A, 16B, or 16C. In some embodiments, interfaces 16A, 16B, or 16C are wireless connections using cellular communications, WiFi communications, or wired communications. Device 14 includes a database 18 for storage of audit data, as will be described in greater detail herein. Storage 18 may further include stored RFQ templates, and defined-criteria, such as audit schemes, audit standards, and audit invoicing templates.

In some embodiments, auditor's device 10A is verified. For example, auditor 12A will provide a verified cell phone number. The auditor can be verified by verification process, such as cellphone number is verified by text message confirmation when auditor resends verification text message or code to system. In some embodiments, unverified auditors cannot engage with audit system.

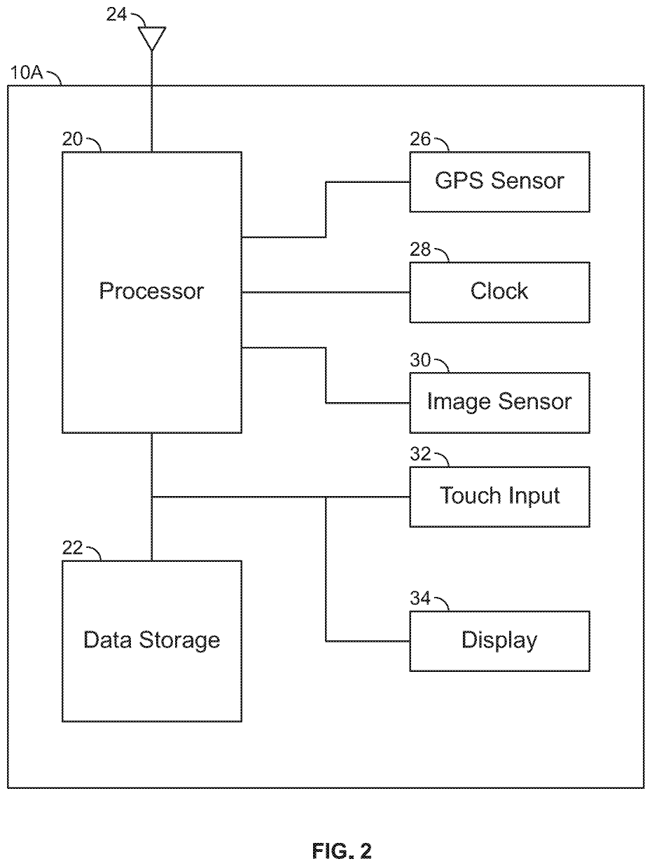

Device 10A is illustrated in greater detail in FIG. 2. Devices 10B and 10C are substantially identical to device 10A. Device 10A includes a processor 20 and associated data storage 22. Antenna 24 provides communications with the device 14, e.g. via cellular or WiFi communications. The processor 20 runs an operating system and operates software to execute the audit functionality described in greater detail herein. The device 10A includes a plurality of sensors useful for the auditor 12A to execute the audit and provide entry of the various audit parameters needed to complete the audit. For example, device 10A can be provided with a GPS sensor 26 to provide geographic location information. A time clock 28 can be provided. In addition device 10A may further include an accelerometer gyroscope, a temperature sensor, a proximity sensor, a light sensor, a humidity sensor (not shown). Additional sensors include an image sensor 30 or camera and a microphone (not shown).

Device 10A provides the ability to generate metadata and record observations during the execution of the audit. For example, in the course of conducting the audit, the GPS sensor 26 and the clock 28 permit each audit entry to be tagged with metadata such as a geolocation and a time stamp. A display 34 provides a graphical user interface enabling entry of information such as auditor observations via the touch input 32. The graphical user interface is described in greater detail below.

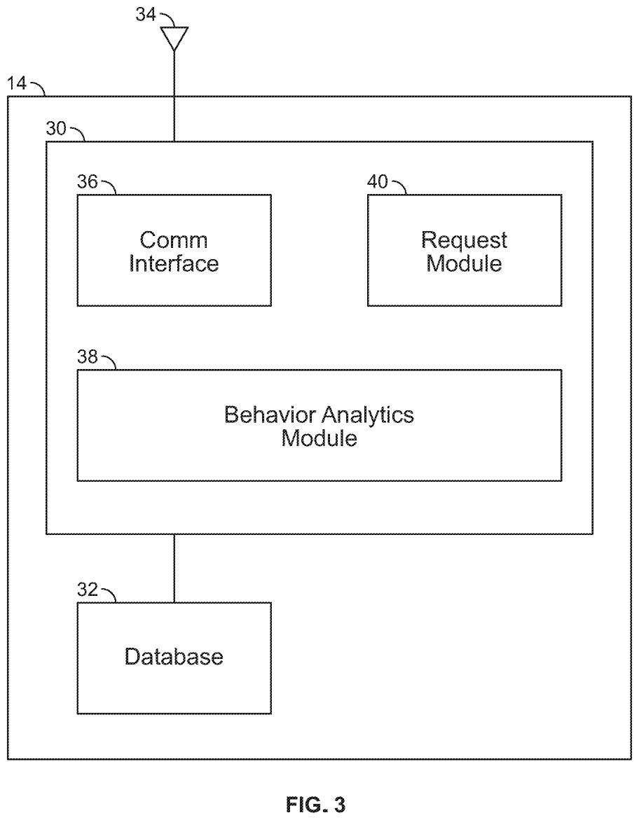

Device 14 is illustrated in greater detail in FIG. 3. Device 14 can be a mobile device, a laptop computer, a desktop computer or a server. Device 14 includes one or more processors 30 and an associated database 32. Antenna 34 provides communications with the device 10A, 10B, or 10C, e.g. via cellular or WiFi communications, with communication interface 36. The processor 30 includes a number of modules, e.g., request module 40 and behavior analytics module, which may be executed as virtual machines on processor 30 in certain embodiments.

Request module 40 interfaces with database 32 in order to register one or more auditee 12B and one or more auditors 12A. Auditee information may be stored on the database 32, including a location and market segment or industry. Auditor information may be stored on the database 32, including location, qualifications and ratings, and scheduling availability. The Request module 40 matches auditee information with auditor information to provide one or more suitable auditors in response to an audit request by an audit requestor 12C.

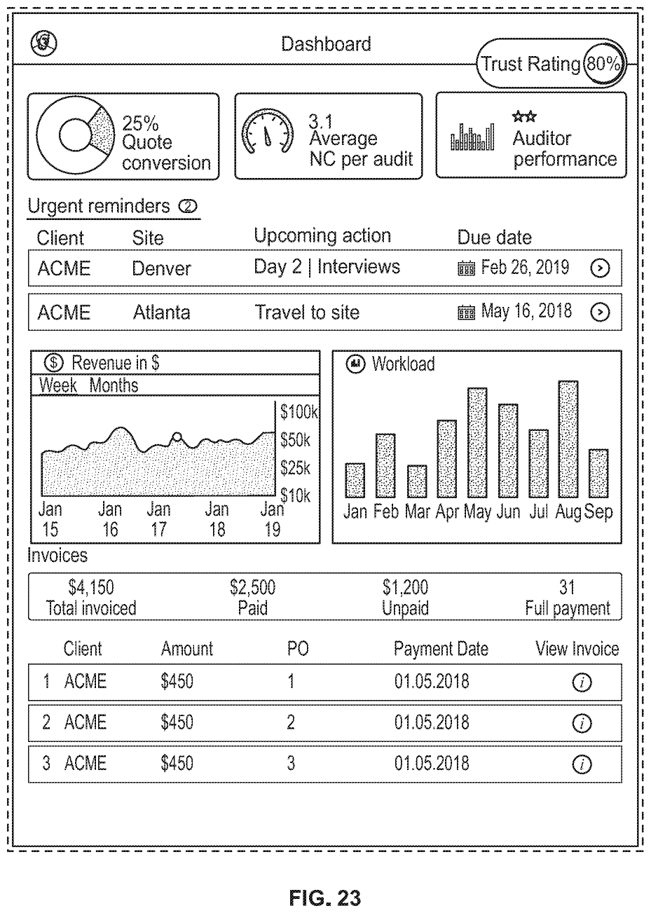

In some embodiments, one goal of the system is to inhibit to “game” the system. For example, if an auditor has a corrupt motive or is “paid off” under today's practices, he may not actually perform the audit but will create a “passing” audit and submit that to the technical committee. Thereafter, a certificate may unknowingly be issued based on corrupt practices. In this regard, the disclosed invention is configured to calculate all of the time and motion of the auditor and auditee from their first contact, including the auditee submitting the RFQ and the auditor winning the bid. All of the auditor's movements and behavior relevant to this audit are then recorded and time stamped—beginning with travel and lodging, which go to costs and reimbursement of expenses. During the audit period (which is a mandatory time period based on the audit type and scope), each step, observation and input is measured against true a location whether in travel or on the property of (outside) or in the property of (inside) the auditee. For example, where did the auditor stop, for how long did he stop and how far was the auditor when the input of the observation was made, in proximity of the observed condition (e.g. a piece of equipment or production line). The audit is measured against the required time (2 man days, 3 man days, etc.). The system then analyzes historical records about the location (e.g. maintenance records, auditor records, etc.) and compares records to current auditor inputs, and generates indications and findings based on the aforementioned that impact the trustworthiness score of the auditor, the auditor's inputs and ultimate the passing grade. In the aggregate, the collected data and information (step by step, second by second) evidences that an auditor arrived at an auditee, performed a certain scope of work, including observations and inputs, and collaborated with one or more devices and technical reviewers. This pattern of behavior would be difficult to replicate if the auditor did not show up or if the auditor showed up with the intent to run down the clock. Also, if the auditor made corrupt inputs, but the inputs conflicted with historical data (e.g. a reported unfixed roof leak), this would indicate untrustworthiness and impact the trustworthiness of the auditor, auditee and audit. Thus, behavior analytics module 38 interfaces with the database 32 in order to determine the integrity or trustworthiness of an audit report generated by an auditor 12A. See, for example, FIG. 23, showing a trust rating 80%. In addition, the auditor may be periodically prompted and/or required to enter and re-enter biometric information (i.e. fingerprint) to confirm that the same user is carrying out the audit and there has been no unauthorized hand over of the audit event to another auditor.

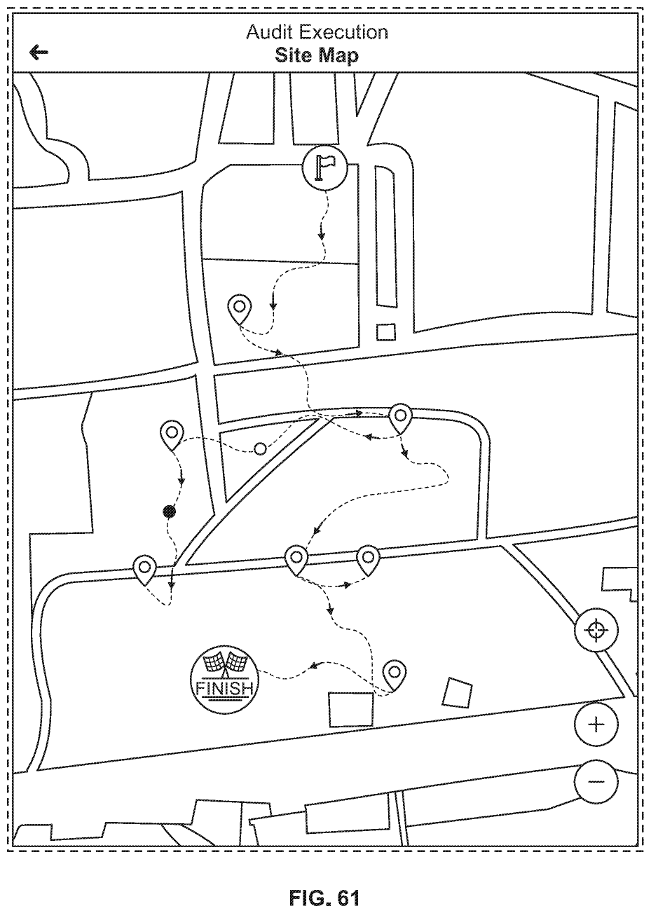

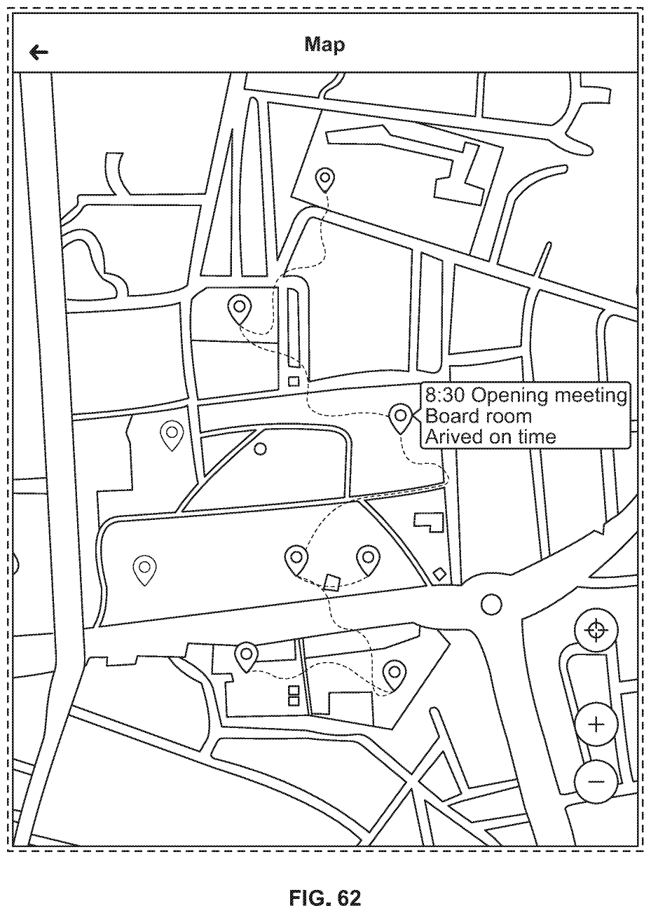

Metadata and auditor observations are received at device 14 from the device 10A. Processor 30, e.g., behavior analytics module 38, determines the integrity of the audit report by generating audit behavior based on the metadata and/or observations of the auditor during a period of time. For example, the auditor observations may include but are not limited to information embodied in audio, video, pictures, and/or text. The behavior analytics module 38 performs a data analytics operation on the received audit metadata, and derives patterns of behavior and/or observations during the audit. Subsequently, the behavior analytics module 38 may compare the patterns of audit behavior or observation to historical patterns of audit behavior or observations stored in the database, and determines an outlier based on the comparison. An outlier in the behavior or observations of the audit will require further investigations into the cause, which may be justified through a change in the local process or environment, or may be indicative of fraud. A high degree of conformity to historical patterns of behavior may be indicative of trustworthiness of the audit. For example, processor 30 may capture and maintain a “trail” of tags derived from the metadata or observations sensed by sensors. This information may reflect a pattern of behavior such as the trail of the auditor during the audit, as shown in FIGS. 61 and 62. The outlier or conformity information may indicate whether the auditor followed a predetermined audit plan for the audit site. Further, the tagging information captured can include collecting data such as fingerprints, wireless handshakes between devices, GPS coordinates, application usage, or other monitored activities and using the collected data to verify that the auditor is following an audit plan.

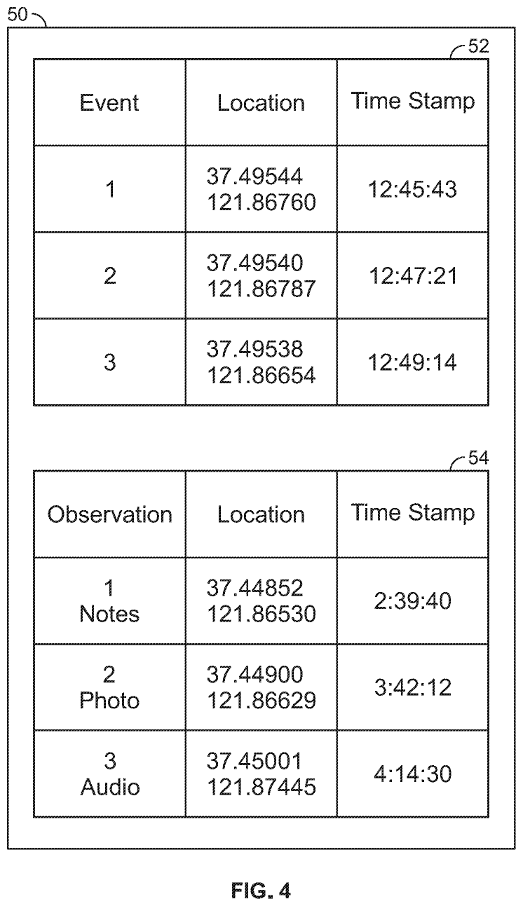

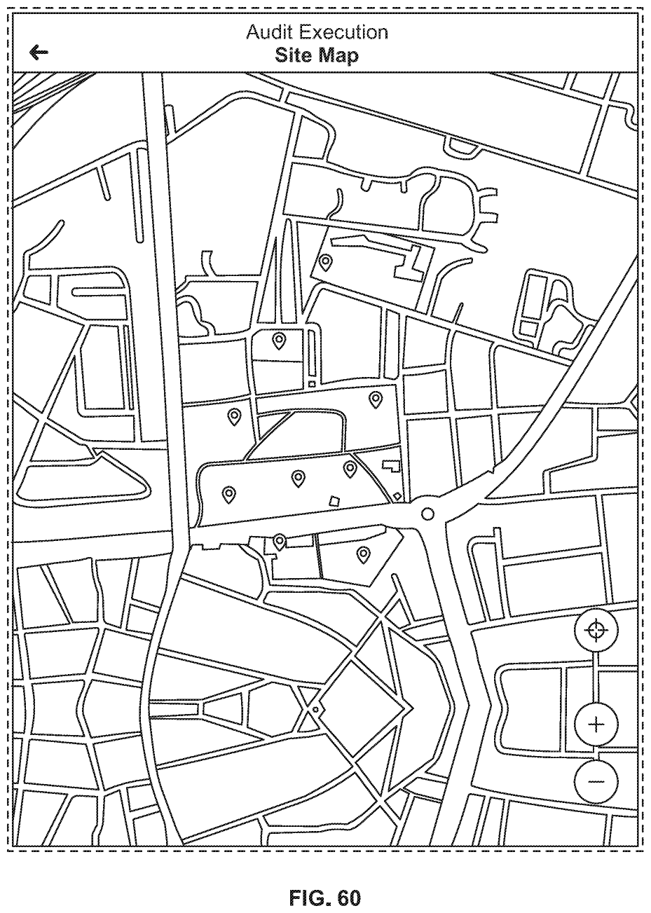

FIG. 4 is a schematic diagram of an exemplary data packet 50 associated with audit evidence generated by an auditor 12A. The data packet 50 can include metadata associated with various events 52 and observations 54. For example, events 1, 2 and 3 may correspond to behavior, such as locations of the auditor 12A during the audit. The auditor may log in one or more plant inspection or tours during a walk-around. Each stop in the walk-around (see FIGS. 60-62) can be tagged with metadata such as geographic location information and a time stamp. Other metadata can include the associated temperature, ambient light, humidity, etc. During the audit, the auditor 12A may make various observations, such writing notes, taking photographs or recording interviews. For example, observations may include climate conditions, equipment status, accompanying persons, etc. Each observation may be tagged with meta data, such as a geographic location and a time stamp. Alternatively, each observation may include a start time and a completion time. The observations and metadata may also trigger notifications to predetermined individuals.

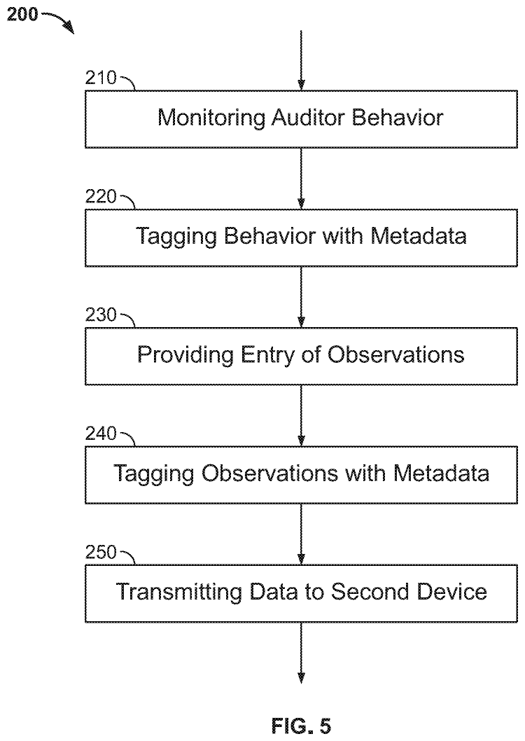

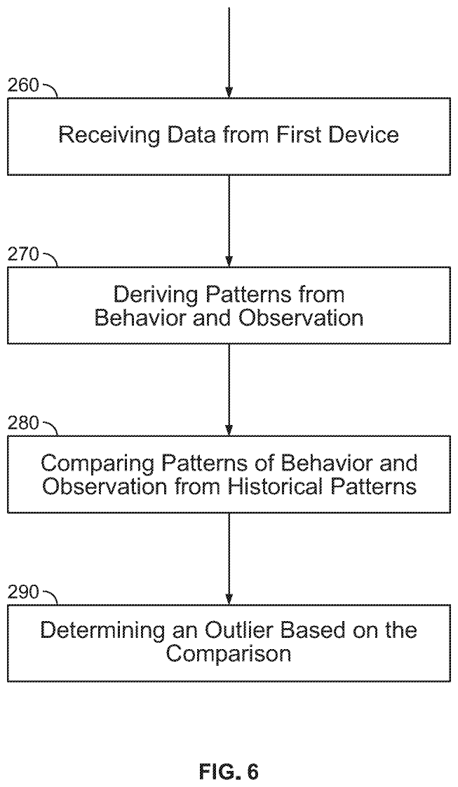

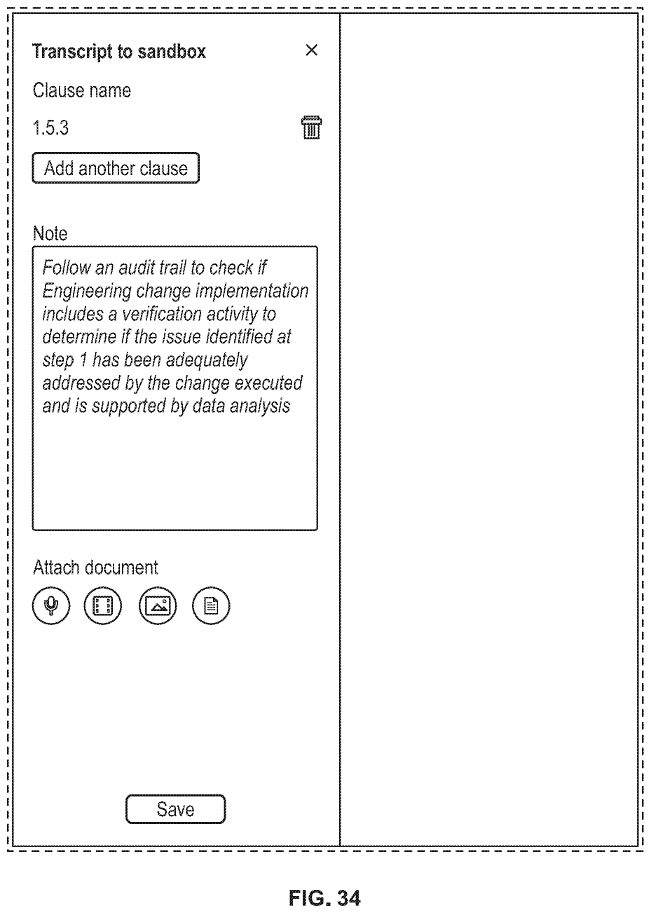

FIGS. 5-6 illustrate operation 200 of the audit system 100 capable of detecting fraud in the execution of an audit. An early step 210 in the process is the monitoring of audit behavior 210. During the execution of the audit, the auditor 12A will execute a plurality of behaviors, such as conducting a walk-around of the auditee's facilities. During this walk-around, the auditor 12A may make certain stops (see FIGS. 60-62). Each stop may be considered a behavioral event. Each behavioral event is tagged with metadata, such as geographic location data and a time stamp or a start time and stop time associated with the event, step 220. Furthermore, during execution of the audit, the software operating the device 10A provides an interface for the entry of observations, step 230. For example, and as explained above, the auditor may make notes, take photographs, or record audio. Each of those observations is also tagged with metadata, step 240. To ensure accuracy, the metadata associated with behaviors and observations (steps 220 and 240) are tagged with the associated behavior or observations in real-time. At some point(s) during the execution of the audit, the data and/or the metadata is transmitted to the device 14, step 250. It is understood that the data may be transferred wirelessly or by a wired interface. The data from the observations may also be stored in a “sandbox” for later consideration and comment, as shown in FIG. 34.

With reference to FIG. 6, device 14 receives the data transmitted from the device 10A, step 260. The processor 30, in particular the behavior analytics module 38, receives the data received from the device 10A and generates patterns of behavior from the data. For example, the behavior analytics module 38 may generate a pattern of behavior that represents the locations traveled by the auditor during the audit (see FIGS. 60-62). A pattern of behavior may represent the duration of various inspections or tests that were performed during the audit, and so on. The patterns of behavior of a particular auditor 10A are then compared to historical patterns of behavior, step 280. The behavior analytics module 38 is trained using historical information aggregated over multiple auditee records and over multiple first party, second party, and third party audits in a relevant industry or sector. When the patterns of behavior substantially conform to historical patterns of behavior, the audit can be considered trustworthy. In particular, the degree to which the pattern of behavior can be statistically quantified, e.g., as 80% trustworthy. However, when the pattern of behavior diverges from the historical records or patterns of behavior, an outlier is determined, step 290. The determination of an outlier may be verified, for example, by the one or more technical reviewers. In some embodiments, determination of an outlier or a pattern of outliers can result in an auditor's and/or auditee's trust ratings changing, e.g., being lowered. In another embodiment, an outlier may be an indication of fraud or other malfeasance in the audit process.

If an outlier is determined, an alert is provided. The alert can be provided by device 14 and communicated to predetermined individuals, such as but not limited to, auditor requestor 12C, or the auditee 12B, or the auditor 12A.

Based on the audit requirements or in the occurrence of an outlier, one or more technical reviewers may be contacted. The technical reviewer(s) conducts a review of the audit report, including the metadata associated with behaviors and observations (and historical datas and analytics against the current auditor). The technical review can receive the audit information with the identity of the auditor 12A and the auditee 12B anonymized to provide an objective evaluation by the technical reviewer. In this regard, device 14 may identify one or more suitable auditors based on the submission of an RFQ by an auditee 12B or audit requestor 12C, described below in greater detail.

The technical reviewer may be associated with a device similar to 10A, 10B or 10C (not shown). Technical reviewer may be in communication with devices 10A, 10B, 10C and/or 14 via respective communication interfaces, such as cellular communications, WiFi communications, or wired communications. The technical reviewer device is capable of receiving, such as by downloading, auditor observations and behavior metadata. The technical review may also be in communication with the sandbox to review and send comments to the auditor and/or other individuals. In some embodiments, the technical reviewer may transmit a corrective action or preventive action plan (“CAPA”) associated with the observations or behavior metadata. In another embodiment, the system 100 includes artificial intelligence configured to suggest corrective actions when a requirement is not met based on the collected observations or metadata.

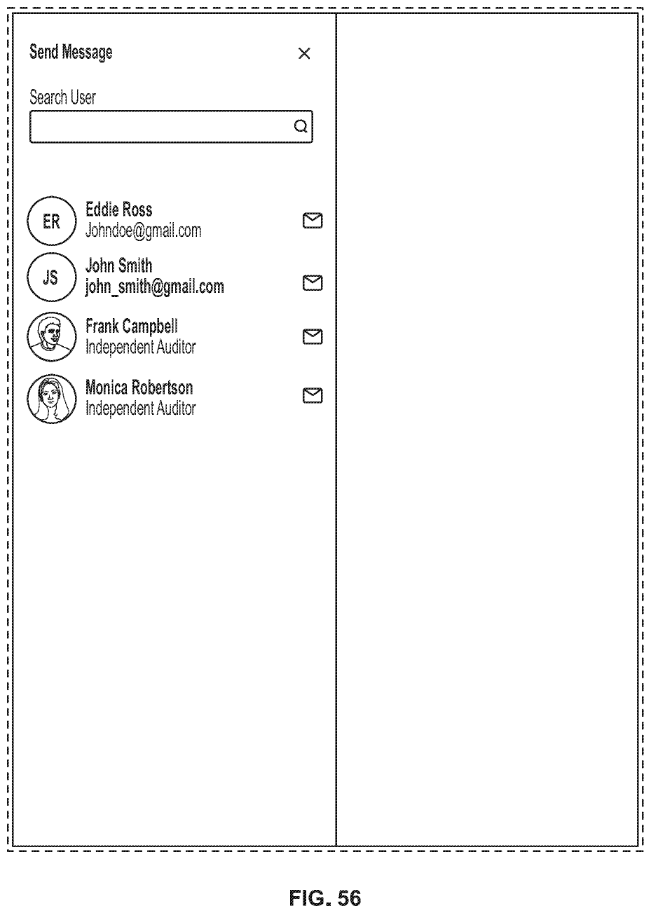

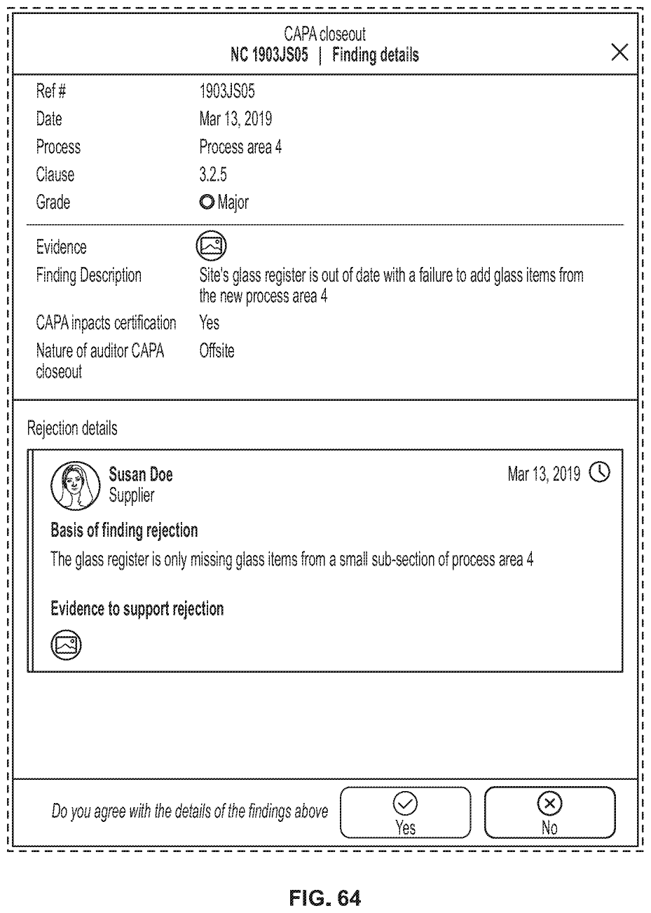

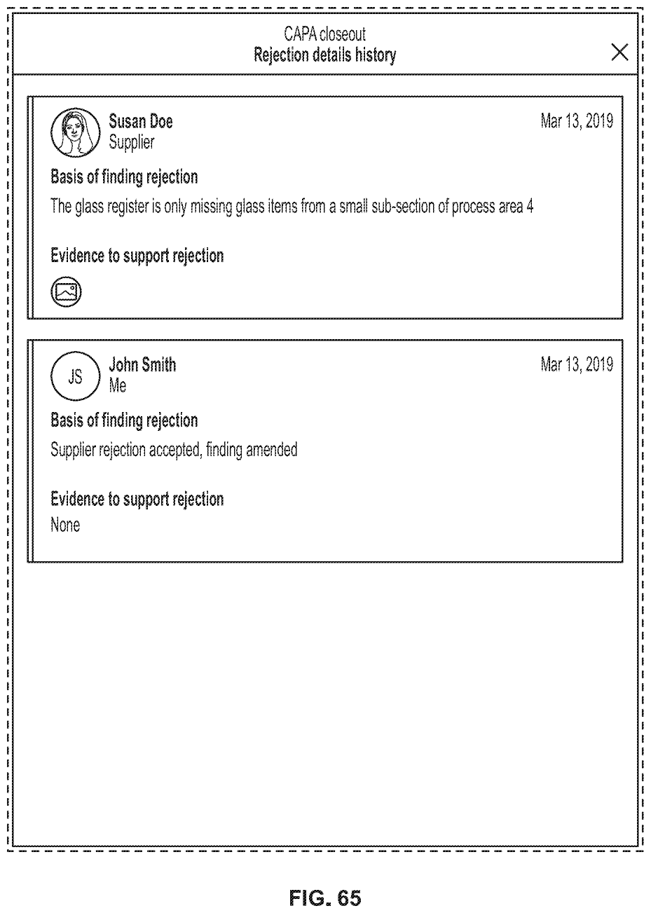

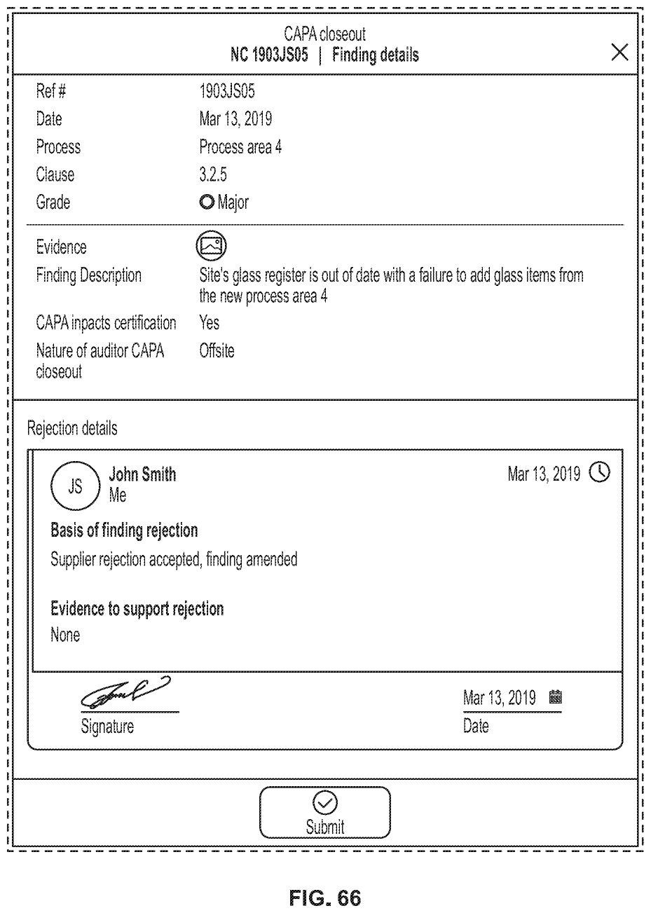

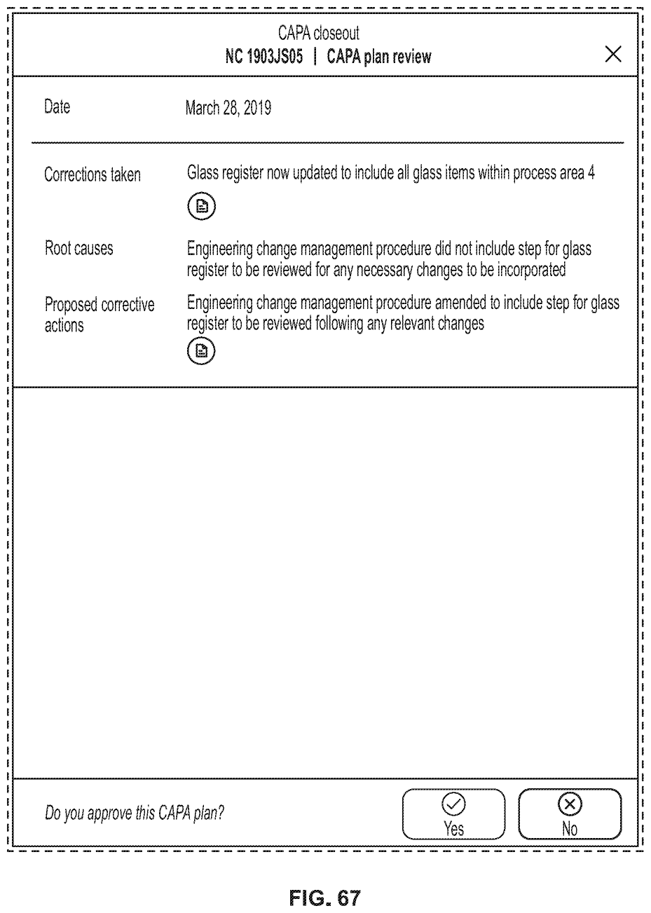

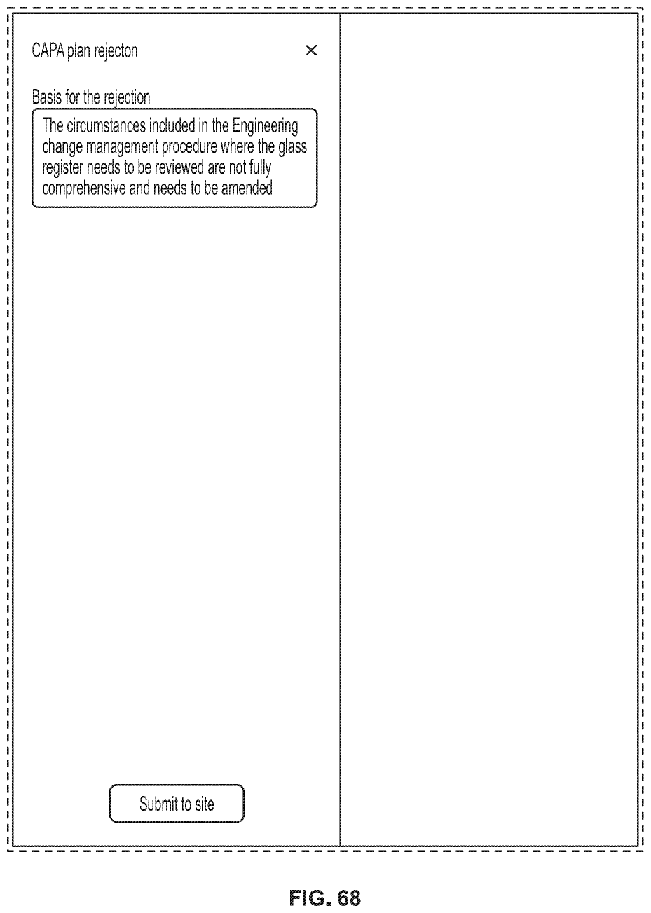

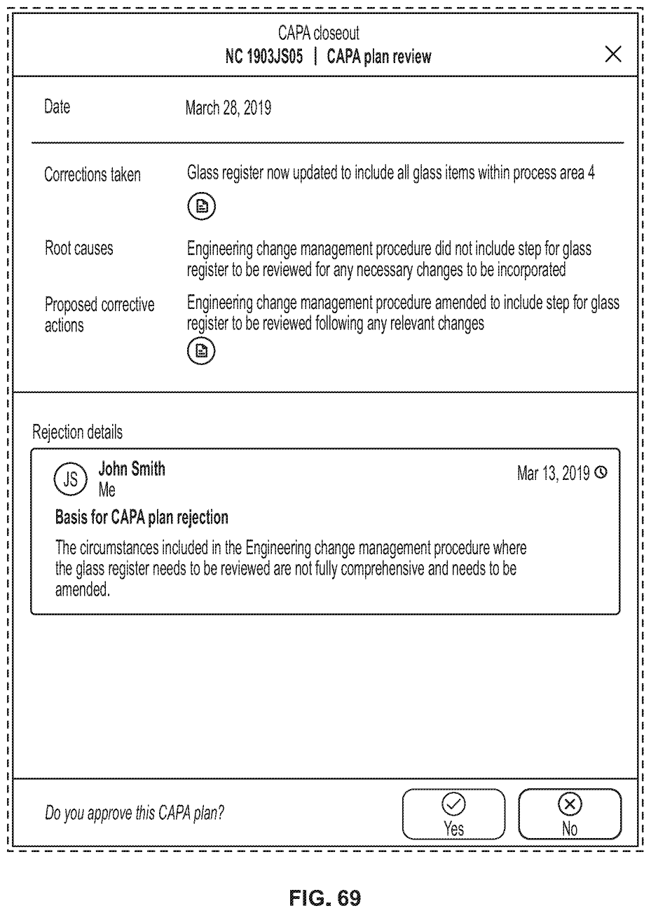

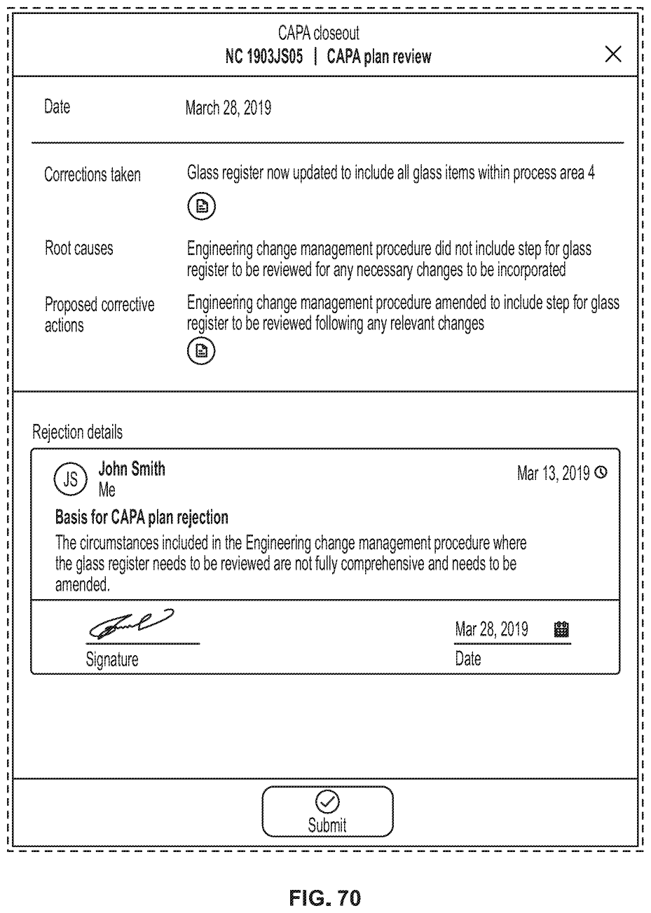

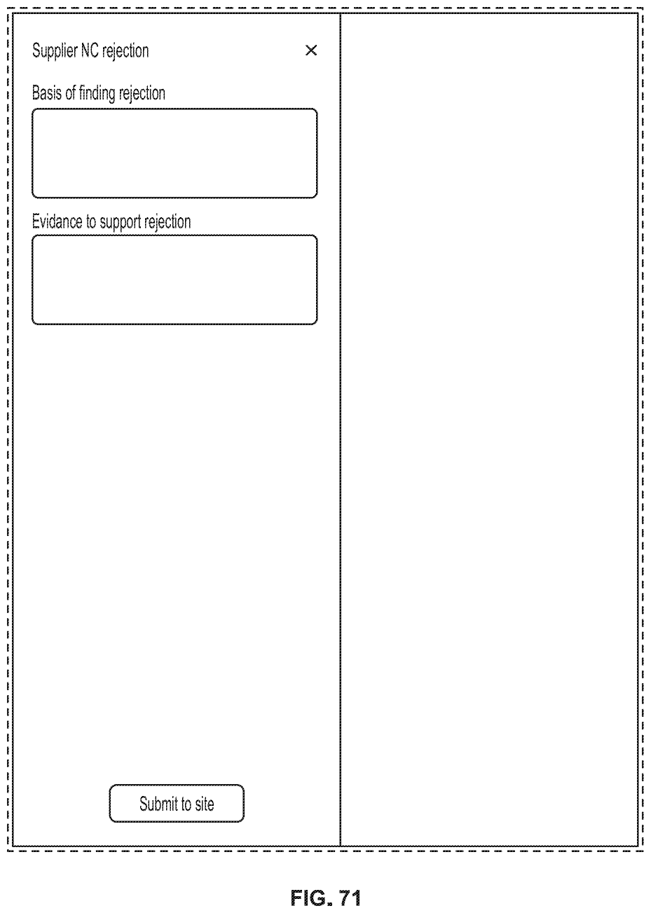

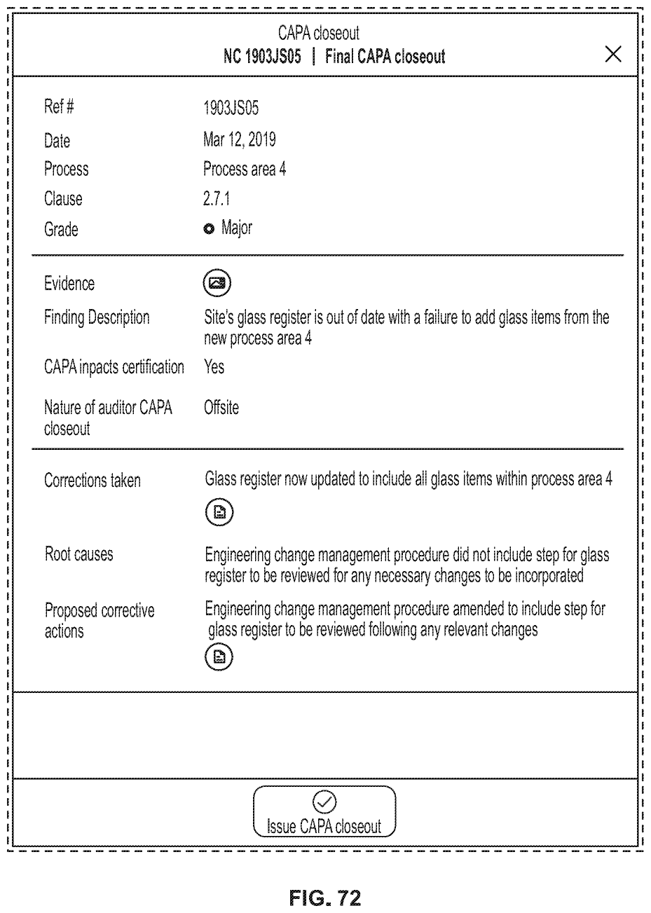

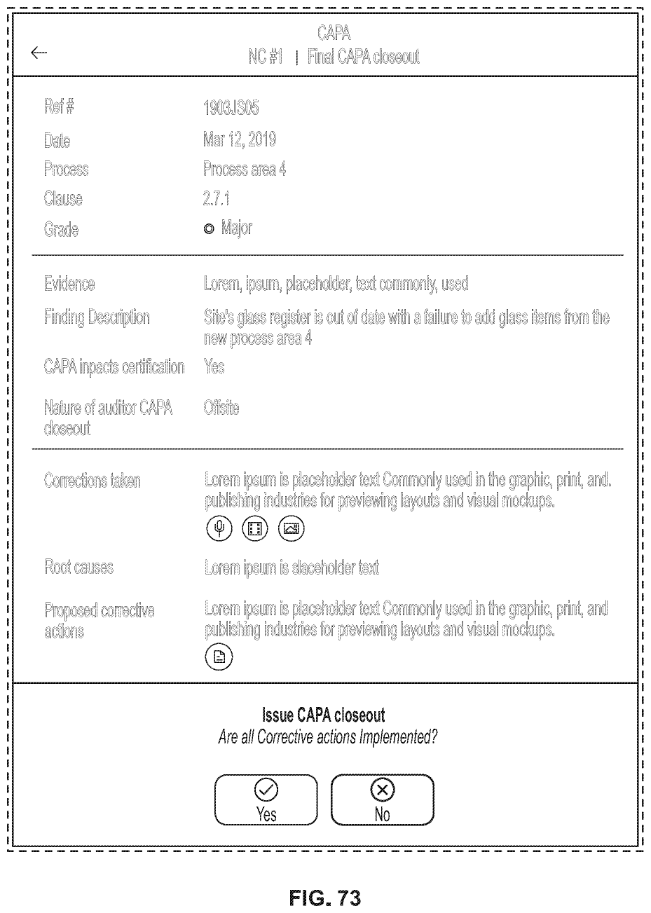

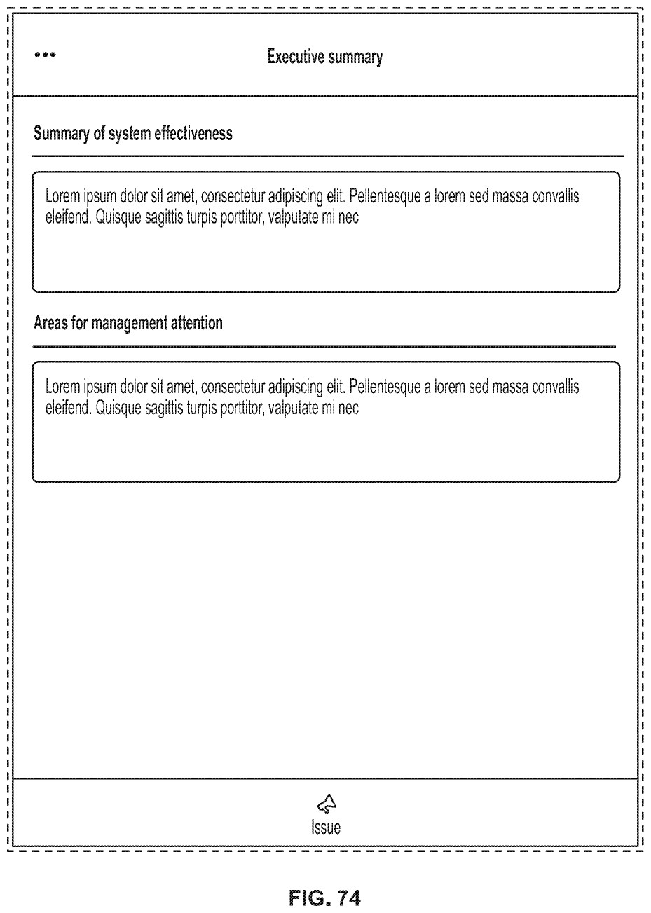

Auditor, auditee, audit requestor, technical reviewer or other individuals may transmit comments to each other through two-way communication processors. See FIG. 56 showing an interactive screen on the system or device for accessing the communication processors for contacting individuals. In some embodiments, communications can occur in real-time, enabling auditee or facility site to address comments between auditor and technical reviewer to final resolution in real-time. See FIGS. 64-73 for examples of communications among auditor, auditee, audit requestor, technical reviewer or other individuals to address and resolve comments. After final resolution, device 10A or device 14 or both may generate a final audit report (See FIGS. 74-77) for screens on the system or device that facilitate generation of a final report. System 100 may be configured to broadcast, multicast, or unicast notifications to the networked devices signaling the final report and CAPA plan availability. Thereafter, the technical reviewer or certified body auditor may make a certification decision.

In some embodiments, storage 18 includes defined-criteria, such as audit schemes and/or standards that are compared with observations and/or audit metadata transmitted from auditor device 10A. In this regard, the processor 30 may determine whether the observations and/or metadata conform to the audit schemes and/or standards.

The device 14 may be configured to generate certification after approval by the technical reviewer. The generated certificate may be transmitted to the auditee, audit requestor, auditor and technical reviewer. The generated certificate, final report and CAPA, may also be stored in memory module on database 18 in entries associated with auditee and/or auditor. Notifications may be issued to the parties once the certificate is issued or any changes are made to the status of an existing certificate (where applicable).

In some embodiments, once the certificate is issued, devices 10A, 10B, 10C and/or 14 have capability to send documents, such as the CAPA, final audit report and certificate to others as needed, by for example, attaching or linking the documents to the system or device, by for example in a portable document format. In other embodiments, the certificates may be paper and mailed, or scanned and made into a pdf and then emailed to the auditee. The auditee then distributes a copy of that certificate to customers, government and industry groups to evidence compliance with one or more standards (e.g. ISO9000, FSSC22000, EFfci, etc.) and regulations (e.g. FSMA, FDA, etc.). Paper and PDF certificates are easy to alter and corruption is difficult to detect at scale. Certificates generated by the present invention are digital and contain the entire digital end to end record from first connectivity of auditee and auditor, to the closing of the audit and the certificate issuance. The “DNA.” There is no possibility of fraudulent certificate. In addition to the unique transaction “DNA,” a certificate issued by the present invention may be coupled with a unique identifier and hashed to a block on the Ethereum block chain. A smart contract maintains the integrity of the data.

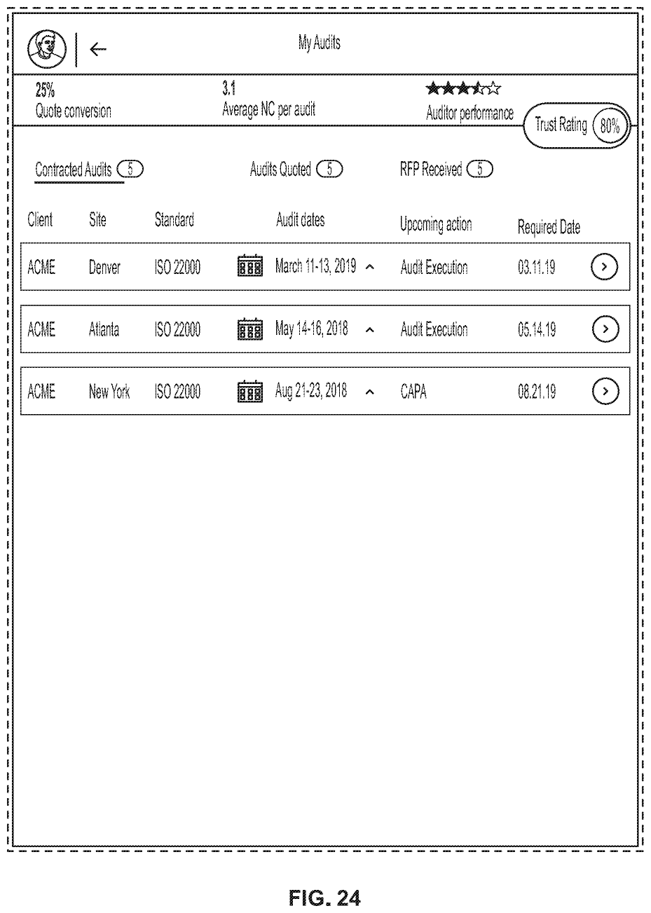

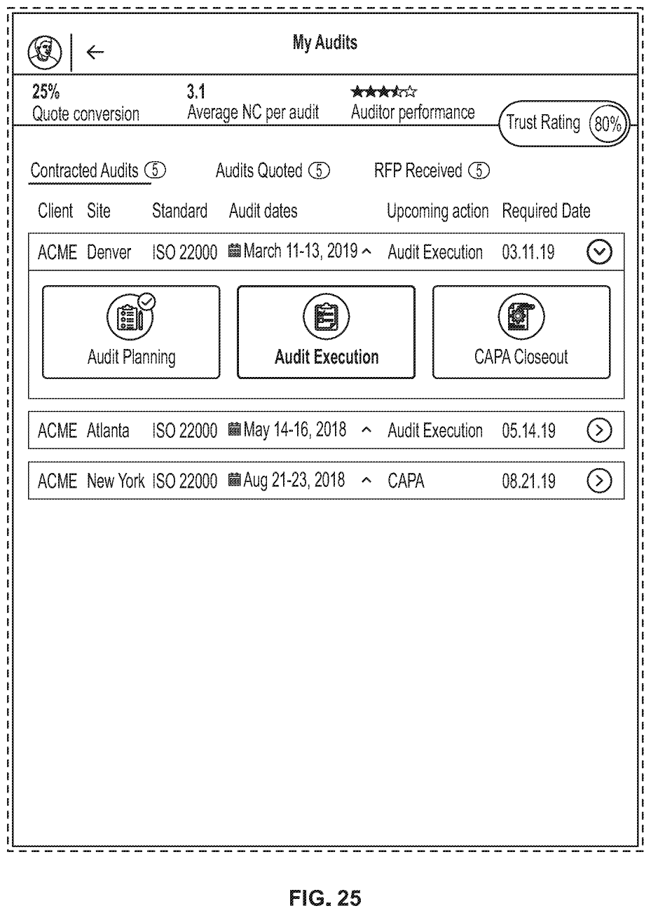

Referring back to FIG. 2, device 14, as well as other devices 10A, 10B, and 10C may include a graphical user interface (GUI) to display information or to schedule events, such as calendaring and notifications discussed in more detail below. The system or device provides interactive screens displayed on the GUI for users to access features of the audit management system. For example, FIG. 23-25 illustrate various pages of an exemplary GUI dashboard of device 10A. As illustrated, FIG. 23 displays information of auditor 12A. As shown, the display shows quote conversions, workload, auditor performance and trust rating, as well as payment information. FIG. 24 shows a summary page of audits contracted to auditor 12A, including client and site. The contracted audits may also be associated with the relevant audit standard, such as ISO 22000 and calendared date for the audit upcoming actions and client/auditee. Drill-down options for each audit may include financial information, including: in-quoting (RFQ), audits quoted, in-contracting, and contracted sites. Referring to FIG. 25, the GUI further includes a drop-down menu that includes access to the audit plan, audit execution and CAPA closeout for one or more sites. The resulting information may be paginated and exportable and printable, for example, as a pdf or csv file.

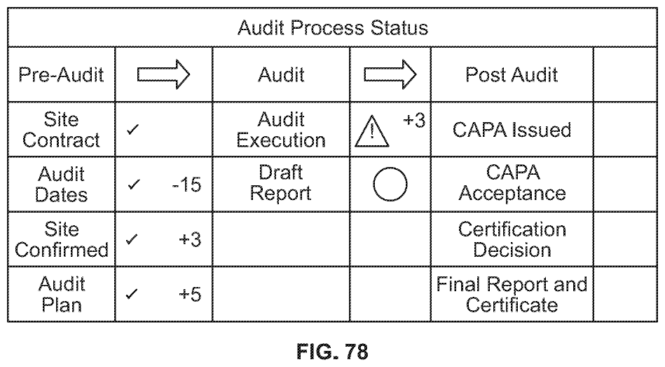

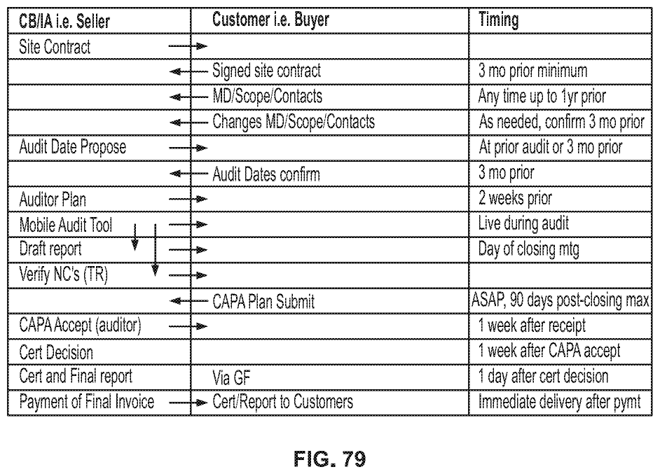

In some embodiments, device 10A provides the capability to search, sort, and filter the information represented in FIGS. 23 to 25, by various parameters including client, upcoming audits, date or timing, or audit standard. The GUI may indicate progress or status of all audits assigned to auditor 12A. The GUI may display established target dates and track relative performance of audit progress to determine whether the audit is behind or ahead of target date, as shown in FIG. 78. The timing schedule may be based on defaults, as shown in FIG. 79.

In one embodiment, the system assists in the scheduling of an audit (calendaring discussed further below), links the requirements of one or more auditing schemes or processes to the underlying requirements of a selected standard, allow the auditor during the audit (audit execution and management discussed further below) to record various types of observations, i.e., evidence such as but not limited to audio, video, picture, text, or sensor data related to one or more observations. The system may be configured to connect the recorded observations to the requirements of the auditing scheme and the underlying requirements of the selected standard. The system may also be configured to share observations made during an audit and suggest corrective and preventative actions (CAPA) with qualified users in real-time during the audit, as discussed further below.

Referring to the trust rating displayed in FIGS. 23-25, device 10A may be configured with the capability of engaging with that section of the GUI to access additional detail about the rating score. For example, the auditor may access information such as detail of specific strengths and weaknesses, such as drilling down into the ratings, and filtering by the technical reviewer(s) or supplier, for example, to gain knowledge about the ratings. In some embodiments, ratings are machine generated, not human-generated. Auditor value, which impacts the auditor rating, is measured by the auditor's performance of each audit and adherence to the auditee/auditor contract, adherence to the standards by which the audit is based, and the results of the technical reviewer(s). The auditee is rated by the results of the audit and diligently closing out CAPA.

The GUI may further include upcoming technical reviews for which one or more technical reviewers are displayed in list view. These technical reviewers may be pre-qualified. The information can be searched, filtered and sorted by the auditor, for example based on audit standard and timing. One or more devices of the system may indicate status of all technical reviews assigned to that technical reviewer, such as waiting draft report, awaiting CAPA plan, in technical review, review comments sent to auditor, responses from auditor to review comments, approved report, CAPA and, if applicable, certificate issued.

Prospective auditee or audit requestor, potential customers (i.e., those not yet contracted) can: view all available auditors by week and standard and geography. For example, all auditors qualified to audit a particular standard, i.e., FSSC22000, and who are available during a particular week, e.g., commencing Dec. 3, 2018, within a particular jurisdiction, e.g, State/Country of audit site may be searched, sorted and viewed on the GUI. The search results may be further refined to limit the return of auditors based on their rating, for example, auditors having a 4-star rating and higher, or all auditors that have audited for the subject site in the past may be filtered and viewed.

Permissions. Certain individuals may have particular permissions granted to view additional information in the GUI. For example, committed audit customers, i.e. those at a contract agreed stage or beyond, corporate customers, i.e., those individuals who coordinate across multiple sites, brand owners, i.e., customer of a customer where a request for audit has been issued and where visibility for the customer of the customer is allowed, and scheme owners, e.g., A1, FSSC 22000, company overseeing their second party audits, may be granted permissions in addition to those described above with respect to prospective auditee or audit requestor, potential customers.

Based on the permissions granted to the class of individuals described above, at least some individuals are enabled to manage or coordinate audits remotely, e.g., from their mobile devices. These permissions enable the individual to select and view details for one, multiple or all audit sites. They may also search for and view identities of all auditors that have audited for a particular organization in the past. For example, LRQA has a contract with Cargill, but then has individual site agreements (e.g., SOW's) for each site. The individual may have access to information identifying the available auditors when doing a site agreement.

The audits scheduled for a particular organization may be viewed in calendar view and map view, with ability to search and filter by, e.g.,: standard to be audited, auditor name, site name, timing/dates, combinations (e.g., all scheduled FSSC audits to be conducted at all USA sites). Individuals at the site under audit, with a permission assigned that allows them to manage or coordinate audits may have access to and view: all audits scheduled for my site in calendar view, with the ability to search and filter by standard to be audited, timing and auditor name.

Individuals may also have access to and view, based on permission level assigned to that individual, financials related to the audit process (e.g., quote to settlement), supplier/site names, Timing/dates, Combinations (e.g., all scheduled EFfCI audits to be conducted at all BASF sites), all qualified auditors by scheme and by total rating achieved with ability to drill down into detail by technical review and/or customer feedback, for example.

Site contacts for a particular audit may have permissions to add other employees to be involved in the audit. Site contact may be defined in the RFQ or as amended by the contract or site agreement. Site contact automatically sees all the dates for their site(s) on the calendar. Site contact may be responsible for certain parts of the audit such as uploading CAPA. If new employee is not already on the system, a connection request may be generated and transmitted to the new employee for connecting to the system. The site contact may define what the employee can do and notifications they receive.

Reports. In some embodiments, the system can generate an audit report or portions thereof based upon the observations provided by the auditor in real-time or another period of time.

In some embodiments, audit execution enables the download of data entry for audit checklists and templates to input non-conformities. The specific template may have categories based on the type or standard of the audit being performed. This may enable non-conformities to be categorized by the system. Additionally, there may be a report template that enables audit information entry in rich text. The report may also be enabled to create or embed other documents and photographs or other recordings of data or information.

In some embodiments, at least one device includes mobile audit functionality configured to support the user or auditor in the ‘HOW while executing the audit. The user or auditor may use the ‘HOW for audit execution or CAPA. In some embodiments in which the audit execution functionality was started as a result of a ‘Certificate Request’, certain milestone documents and information are made available to the issuer of the original “Certificate Request' that triggered the receiver of that request to buy an audit.

In one embodiment, the users of the system may toggle between the requests module and audit execution module of the system. The UI/UX of both mobile/PC is seamlessly integrated. The user is visually informed when he is taken to another module of the system to perform the next step of the audit, such as by headers on the display screens displayed on the GUI. Alternatively or additionally, the Audit summary in the dashboard (FIG. 24) may be used as a “home link” for a user to access modules and information linked to a specific audit for which a user has permission to access. This enables the user to know where retrieval of various documents and information can occur. For example, an auditor in the audit execution module may go to the underlying request issued that resulted in the audit. As another example, an auditor in the requests module reviewing an RFQ received, may go to the in-progress audit in the audit execution module.

On close of prior audit, if there are other audits remaining on the contract for the same site, the auditor and customer are prompted of the due date for the next audit, as well enabling changes to the date by either party. For clarity, other audits remaining means surveillance audit year 2 or 3, or even potentially other audits contracted (the key is any audits contracted for that site). On having it scheduled on the calendar either party can move the date following the process previously described.

Notifications. Each individual receiving a notification can choose to snooze a notification with the user determining how long to snooze for as follows: custom allows the following options, each individual receiving a notification can choose to not receive the notifications any more, or choose to have notifications only sent in groups. Example: send me all notifications related to this audit once a week, once a day etc. Example: send me non-conformity observations at the moment they get reported, or, send me non-conformity observations only once they have been reviewed by the technical reviewer. Each individual can subscribe to notifications available for the audit when they ‘join’ an audit. A primary site contact can set notifications for their other site team members who are part of that site audit. This does not prevent those other site team members from changing the settings, except as noted below e.g., critical non-conformities.

Site contact can set up notifications for their team. Reminder notifications for any stage of the audit, e.g., notify team 1 hour in advance of audit planning meeting or 1 week in advance of audit team being on site, e.g., notify John Smith for any minor non-conformities. Site contact cannot change that everyone at the site is notified of a critical non-conformity. Any Primary site contact can change the primary site contact. Any administrator can change the primary site contact. Any employee wanting to change themselves to the primary site contact is informed they do not have permission to do so (unless they have the permission to manage access and security and would they like a request for that change to be sent to those that can manage access and security. If yes to send a request, the requestor can add comments for why they want to be the Site Contact.

The request and any comments are sent to those who can manage access and security. Notifications/reminders are sent to the administrators every 1 day unless the request for access is accepted or rejected. If accepted, the requestor is informed of the acceptance and becomes the Primary Site contact. If rejected, the requestor is informed of the rejection and can resubmit a request. All site Contacts can define what they want to be notified about during the audit planning and execution (and can switch off the notifications). Certain non-conformities must always be notified and cannot be switched off by the site contacts.

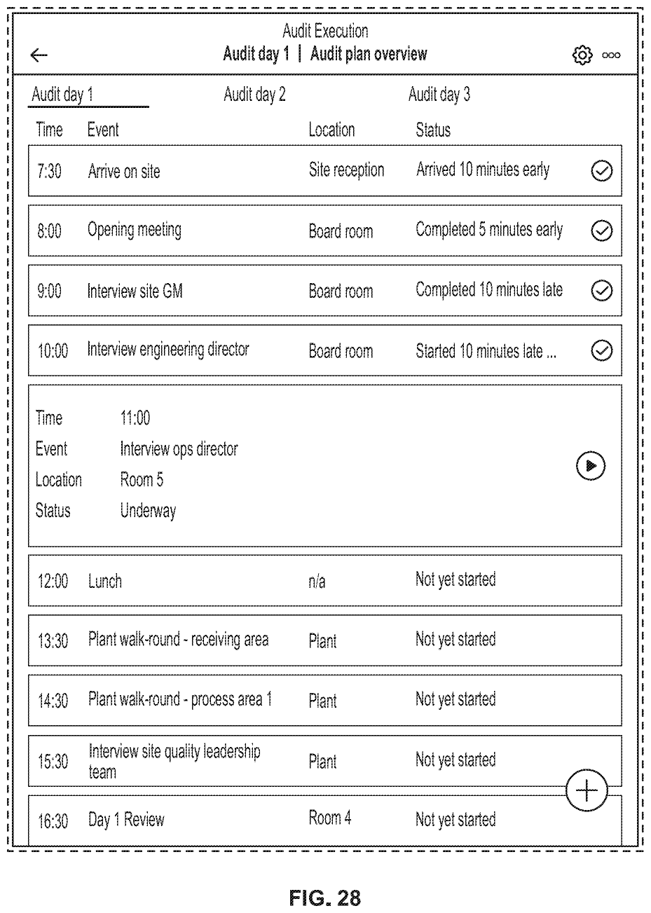

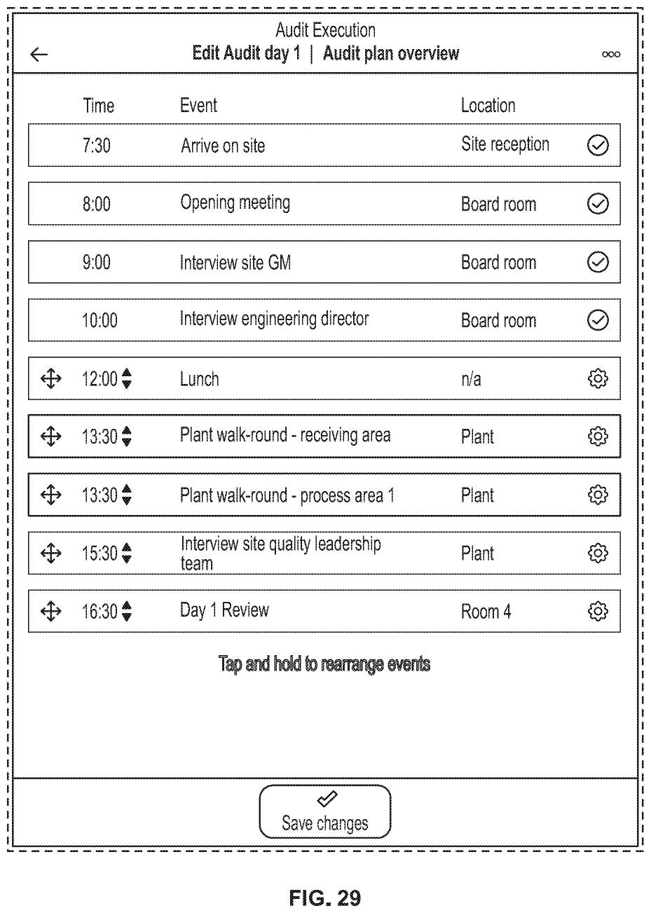

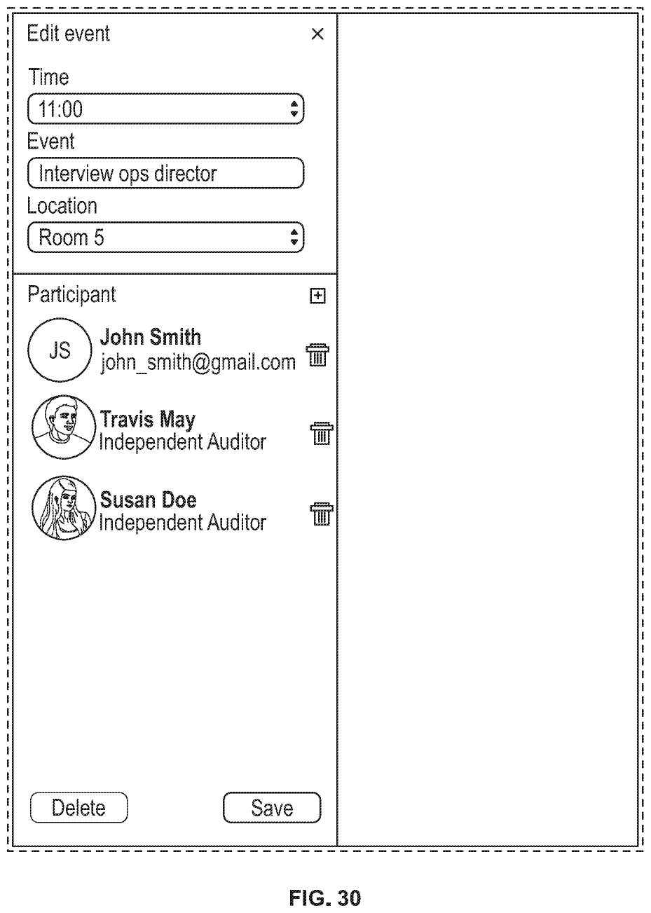

Calendaring and Scheduling. Users of the system are enabled to put dates from the management system calendar onto their own calendar. See FIGS. 28-31 for examples of GUI screens related to scheduling and calendaring. The management system calendar and user calendar may be configured to sync (bi-directional or unidirectional). Users can choose to sync certain entries from system calendar to the user calendar (e.g., Audit Scheduled Date) using an “add to calendar” capability that opens a new entry on their chosen/linked calendar.

In some embodiments, calendaring is shared among the individuals involved in the audit process (i.e., Customer and Auditor) to improve transparency to agreed and planned schedule/dates, as well as setting target dates, increase accountability and improve performance. The calendar may be searchable and filterable based on certain criteria. Audit dates defined in the Contract (or if a Site Agreement is used, per that Agreement) may be reflected in the calendar.

If multiple years, all dates are reflected on the calendar. If dates fall on a Saturday or Sunday, the user is prompted of this and may choose a different date. The system or device provides capability of scheduling ad hoc events related to the audit directly in the calendar. An example is scheduling an audit planning meeting which is not in the Contract or Site Agreement. Desirably, this function follows a shared calendaring concept like doodle or calendly.com type capability.

Any auditor involved in the audit (auditor, technical reviewer etc.) may have one or more entries on their calendar that displays, e.g., customer name, site name, standard and audit stage, links to customer profile, customer reference number, internal reference number maintained by the CB/Independent Auditor (IA), and/or Job/SOW details, all or some of which may be available in the calendar entry. Links to items such as RFQ, PO, Contract (later the invoices), Payments, Company name (if different from site name) may be enabled. Links to profile, company address (if different from site name), site name (this may be included in the ‘title’ of the calendar entry), site profile, site address, link to map, and/or all team members (whether audit or customer, including identification of site primary contact, company contract leader, lead auditor and technical reviewer(s)) from contract/site agreement and/or as updated, may be provided and enabled, such as by drop-down features. A link to a contacts database in storage 18 may be used to show email addresses/cell phone numbers. Audit status (see dashboard/status section), Audit scheme (e.g., A1, FSSC22000, companies for their second party audits)), from contract or as updated may also be shown or linked in the calendar entry. Other links or information in the calendar entry may include Standard or Scheme to be audited against (e.g., EFfCI) (this also goes in the title line of the calendar entry), from contract or as updated, information about audit scope, from contract or as updated, audit dates (system to generate audit days based on dates), from contract or as updated, stage of the audit, e.g., Audit Plan, Certification Date etc. (this also goes in the title line of the calendar entry), from the Contract or Site Agreement, type of audit, e.g., initial Certification, Initial Certification Stage 1, Initial Certification Stage 2, Surveillance, Recertification, from contract or Site Agreement, audit report link (once available in either draft or final), CAPA report link (once available in any version), and audit certificate (once available).

Any customer involved in the audit (by this meaning any employee approving the RFQ, PO, Contract, or any employee of the customer involved in any of processes etc) has an entry on their calendar that displays similar information as described above. Auditor/CB or customer should be able to manually move individual dates in the calendar. Auditor/CB or customer can choose to reschedule subsequent dates based on the first date moving. Audit/CB or Customers can accept or reject the date change, or propose an alternative.

Rejection keeps the original date and sends a notification to the auditor of the rejection. Acceptance notifies anyone involved in the audit (other customers or auditors). Anyone may change their notification preferences for “notify me when an audit is rescheduled”, “notify me by email”, SMS or in app, turn off notifications for any of those sources. If respondent does not accept in three days, a reminder may be sent. Reminders can be snoozed as described in notifications above. If the date changes proposed mean the customer's existing certificate will expire, the user is informed of this but can continue. The customer recipient is similarly informed on accepting such date changes but can also continue.

Setting Target Dates in Calendar. Customers are able to set target dates for performance as per the audit status shown on the GUI. A permission to ‘set target dates’ may control this capability. Target Dates may initially reflect details in the contract or site agreement. In one embodiment, if no dates set, then no target metrics are shown, except for what may be in progress and what has already been completed. Dates may be progressive. For example, a later stage cannot be scheduled prior to an earlier stage. If a later stage is scheduled the same date as the preceding stage, the user may be warned and can either change the date or continue. Customers may have the ability to set target dates from any point in the progress/status.

Dates can be set by calendar, or by choosing days relative to already set dates, e.g. 30 days after any Contract Date. Dates can be set relative to actual dates, e.g., 21 days prior to the Certification Target Date of Dec. 31, 2018. Users setting target dates are able to publish them for use for those entities in their own business they have the ability to set target dates for: The user should be able to select all, select one or multiple, deselect one or multiple or deselect all. The user is presented with a list of those users who will be notified and their respective operations.

At least one individual per operation is notified (unless the user setting target dates is also the individual responsible for managing audits). A permission should be available that enables the user to be able to ‘Manage or coordinate audits of my business.’ The user can deselect individuals (subject to the one individual minimum). The user can send a note with the target date schedule that recipients will receive. Users can choose to share one or multiple dates with the auditor. It follows the process above for internal sharing. The specific auditor allocated to a specific site/operation only receives notification for their allocated site/operation. It may be that an auditor, e.g., a CB is allocated to multiple sites/operations. If so, the auditor can see how this impacts their schedule for all applicable sites. The customer must confirm the intent to share with auditors: Recipients of target dates can view a summary of the note and the target dates that have been shared with them, Recipients can set reminder notifications—x days prior to y date, remind me, reminders can be snoozed as outlined earlier in Notifications. Once they have received target dates, this drives notifications and reminders in the system.

Once dates for a site visit are agreed upon, the calendaring function can be used to schedule events during a site visit date, such as interviews, plant walk-arounds, etc. Auditors and customer personnel will be able to manage scheduling the events using the system or device. Other interested individuals, such as technical reviewers, customer management, etc. may be provided notifications of event scheduling for awareness and/or participate in the scheduling.

### Exemplary Audit

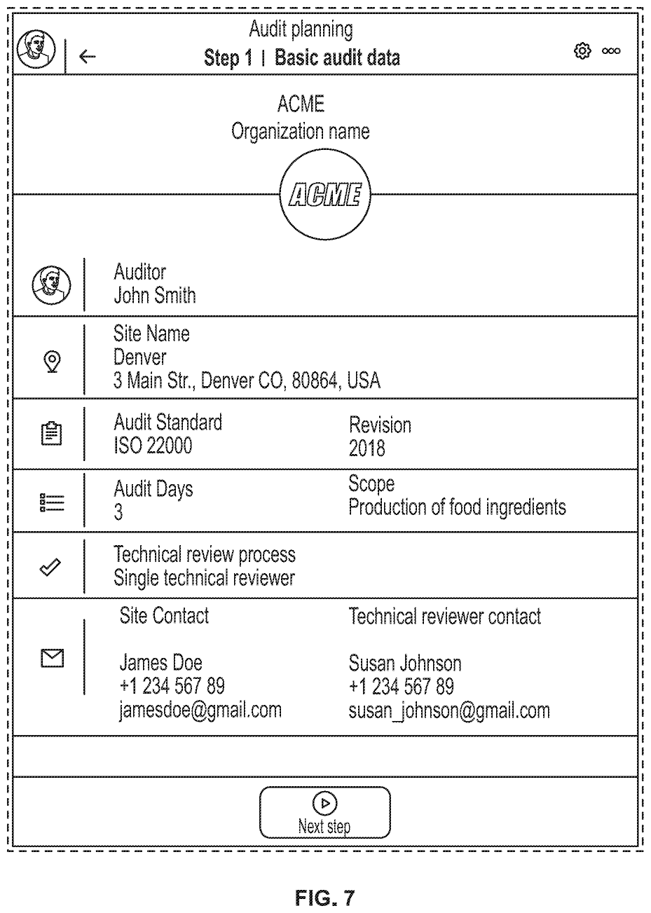

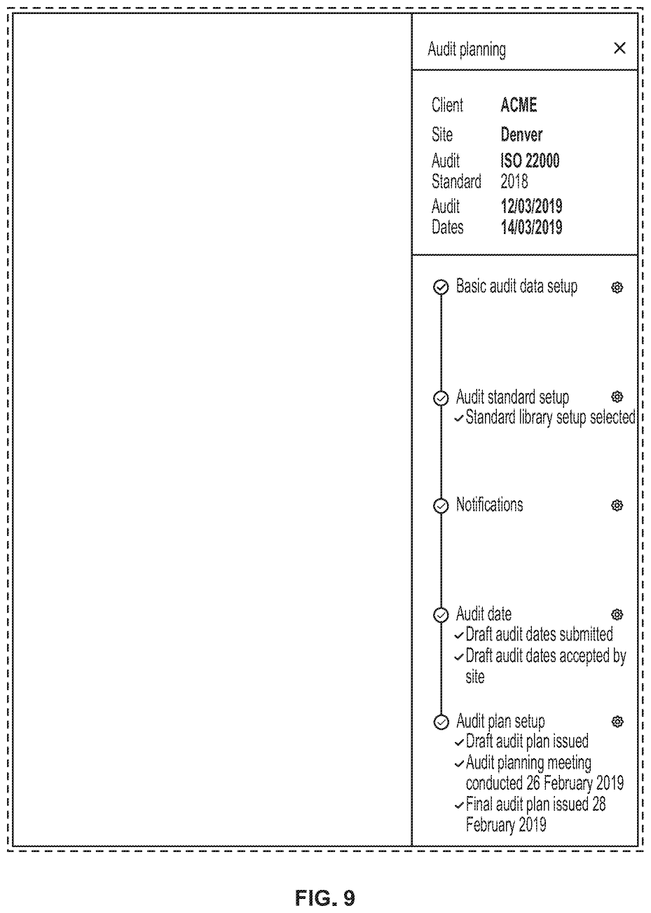

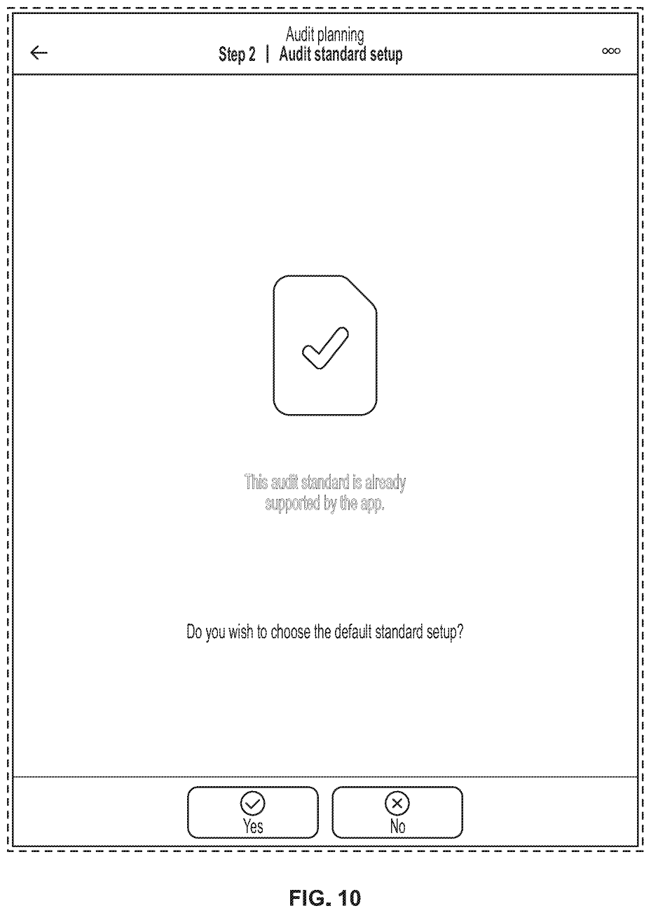

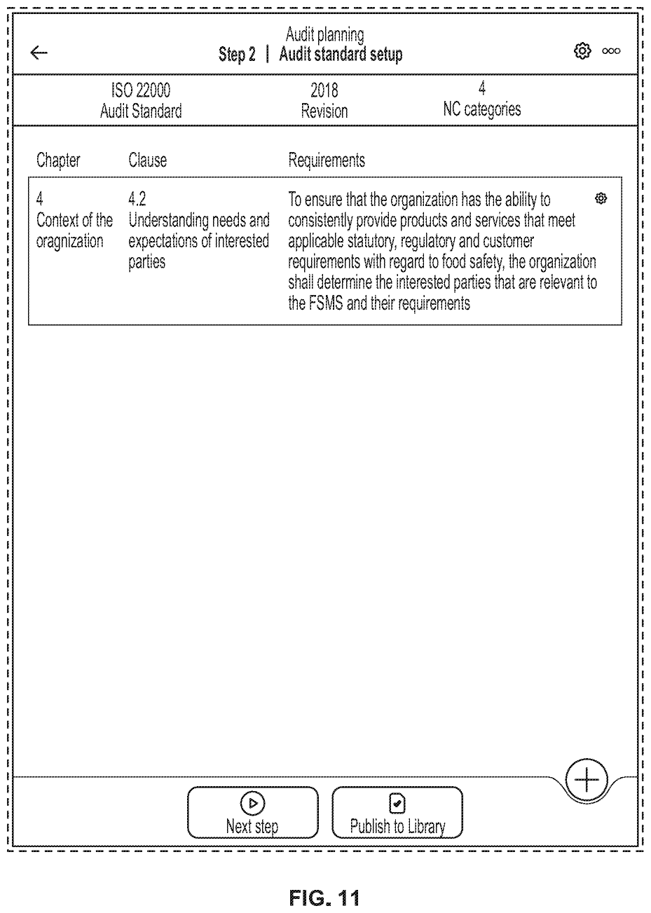

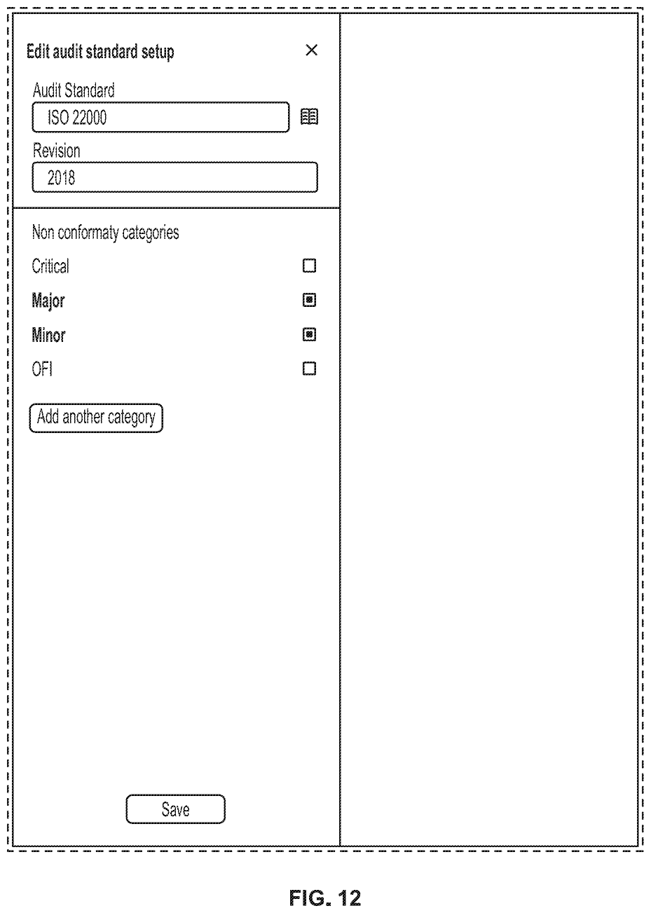

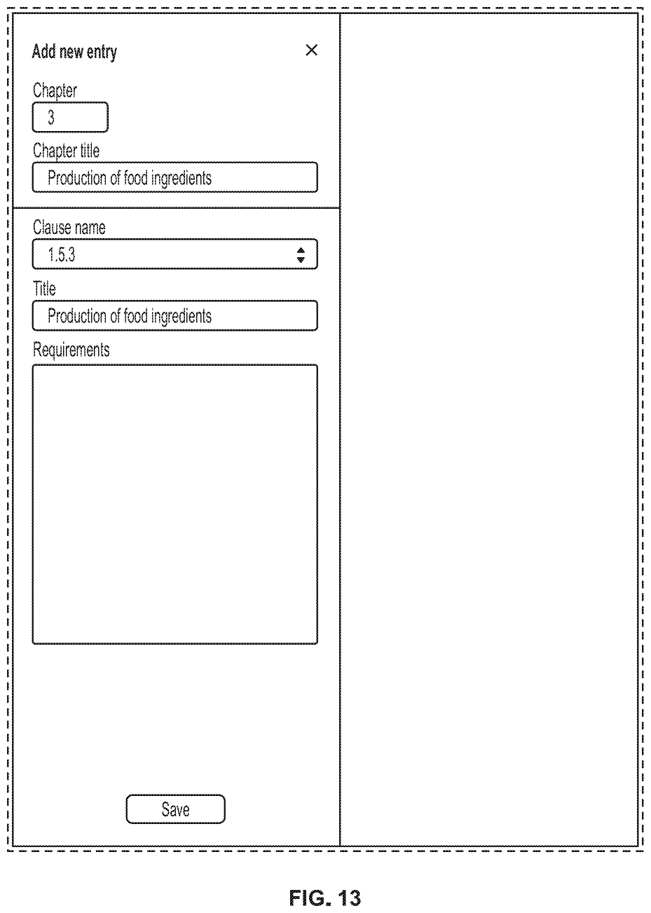

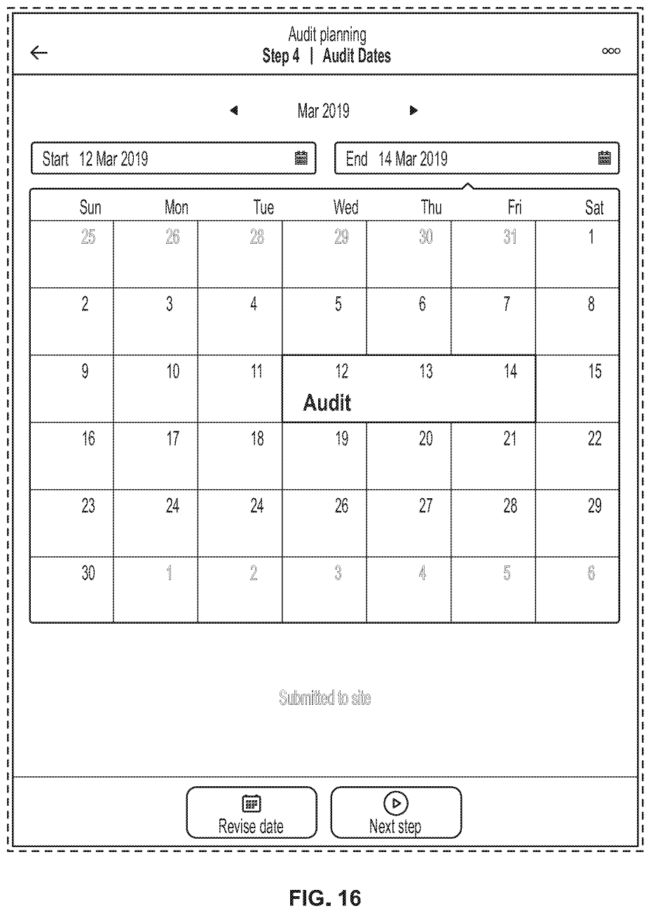

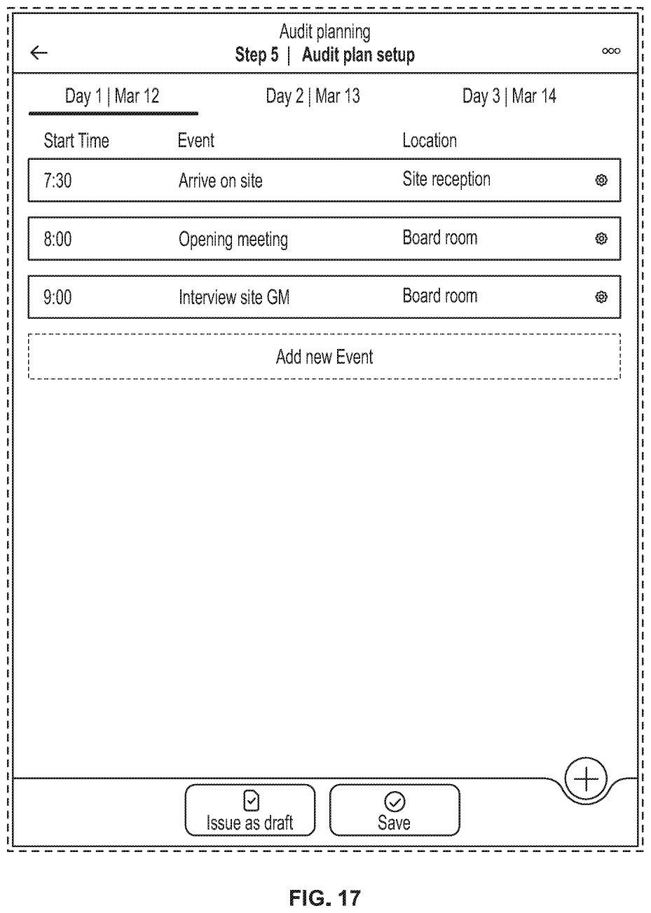

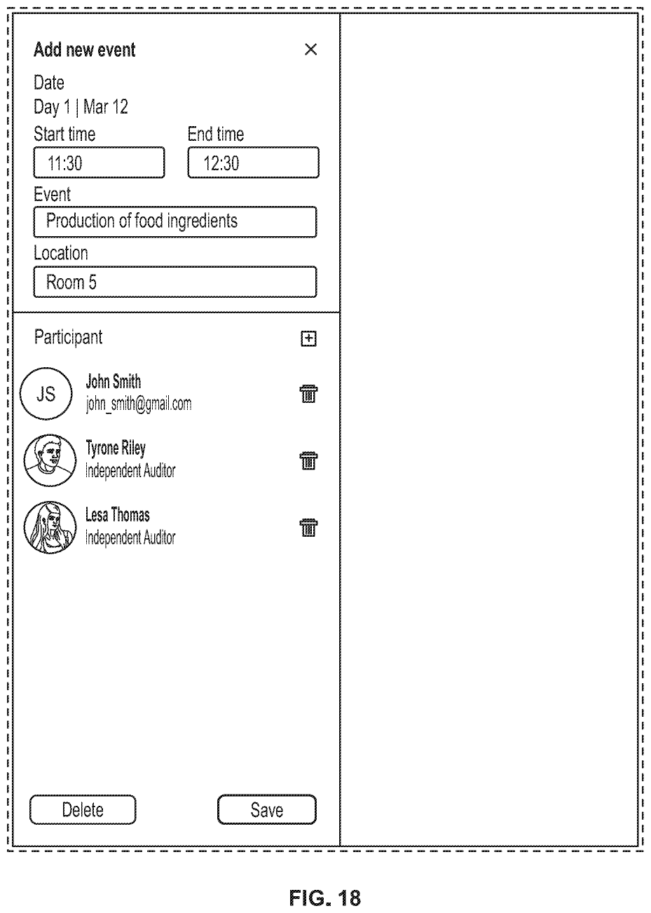

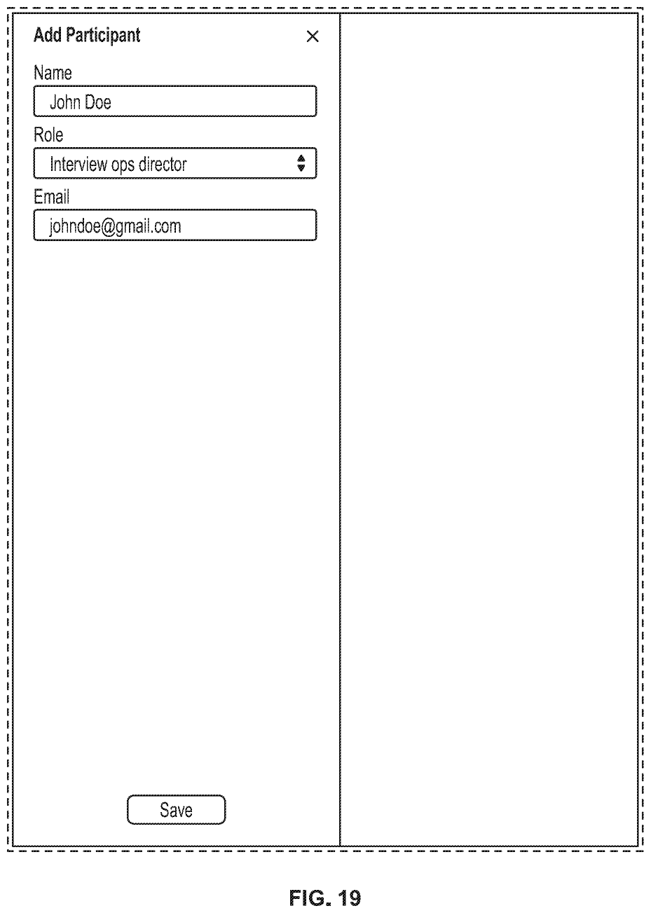

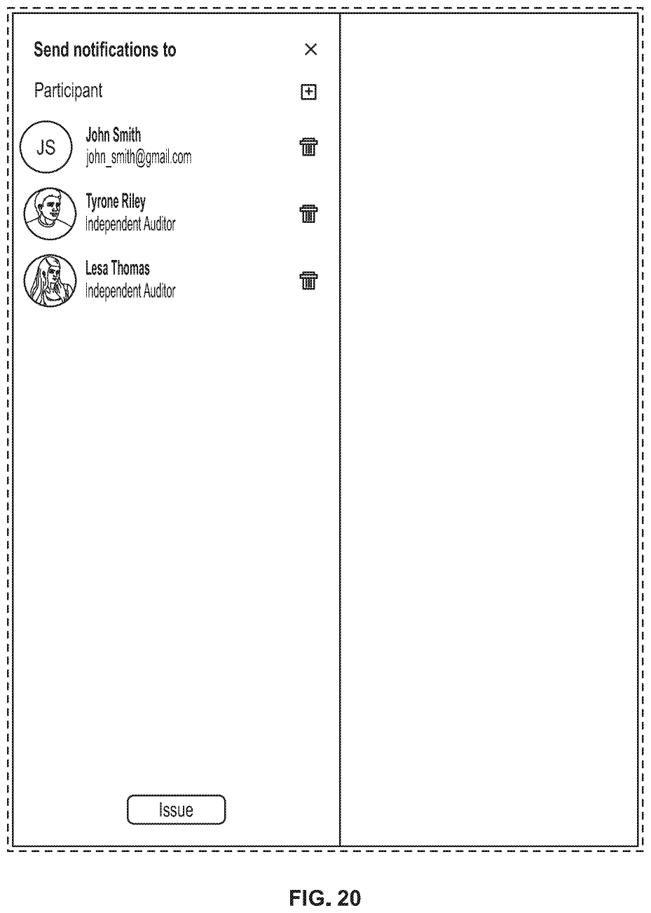

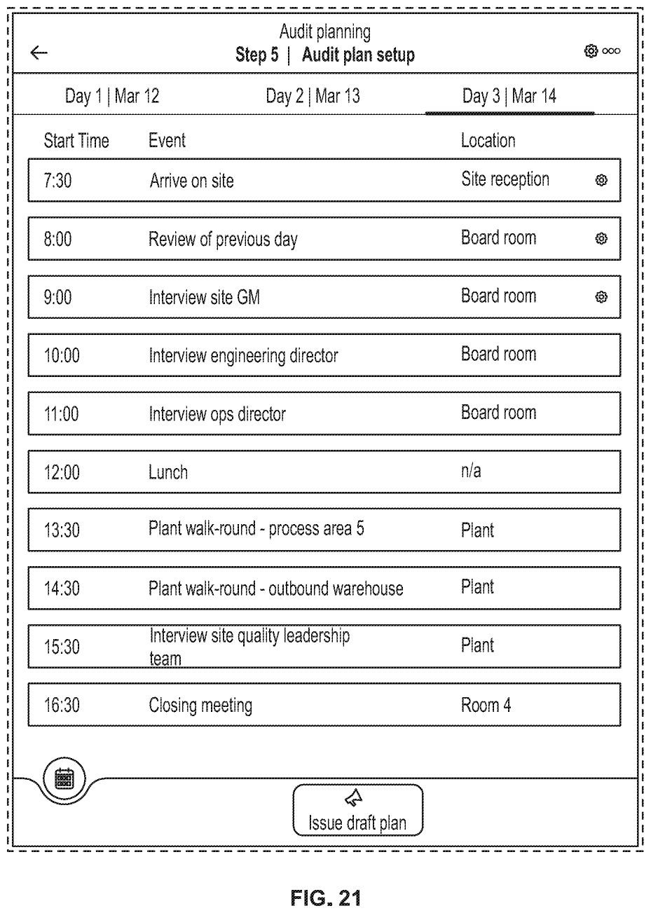

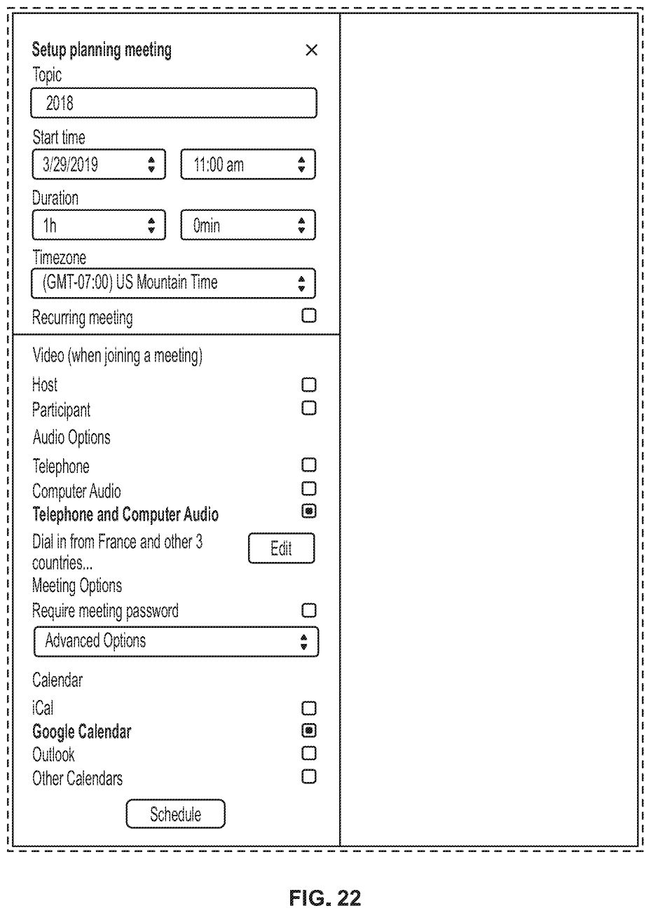

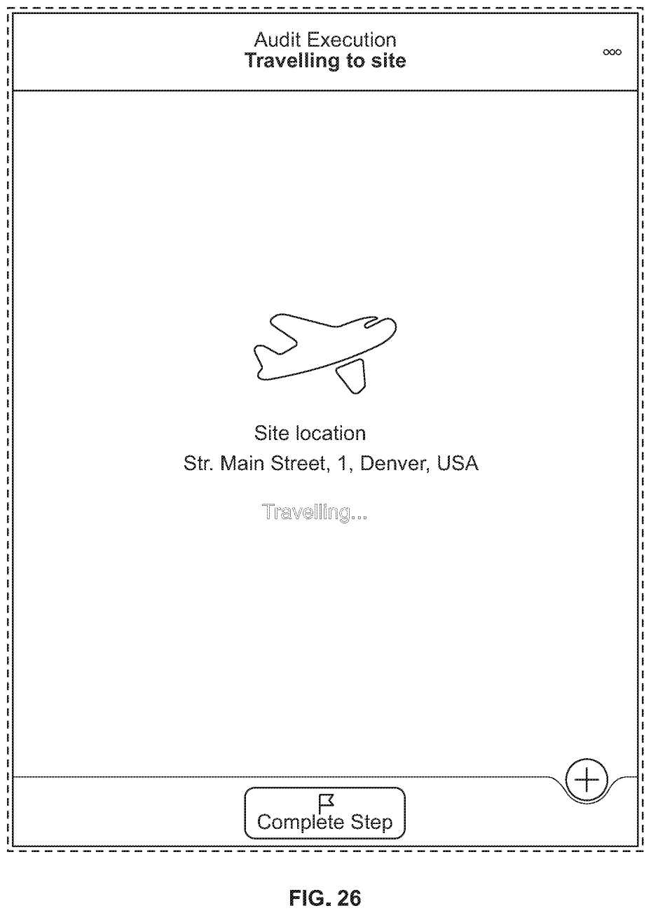

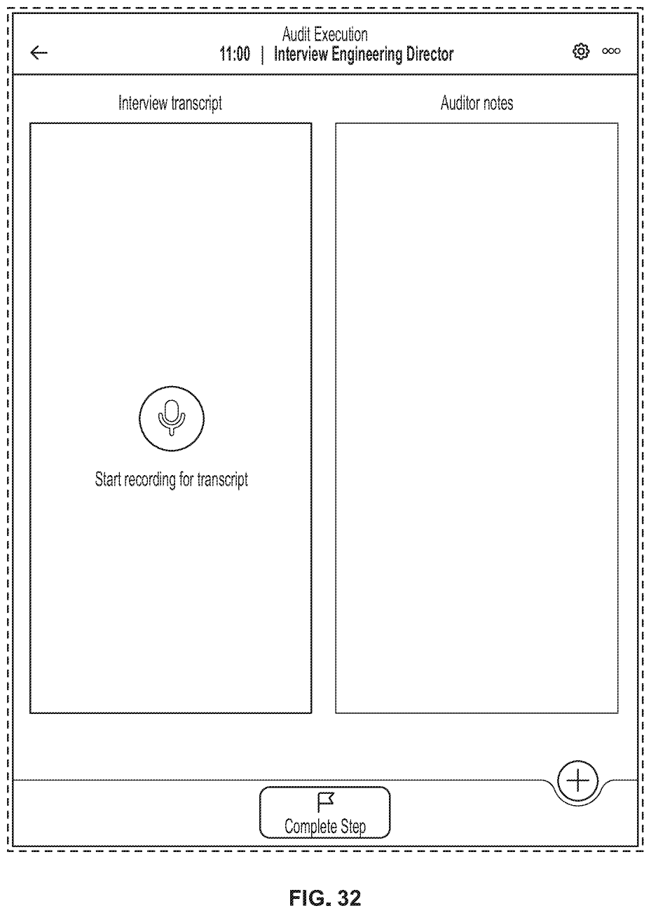

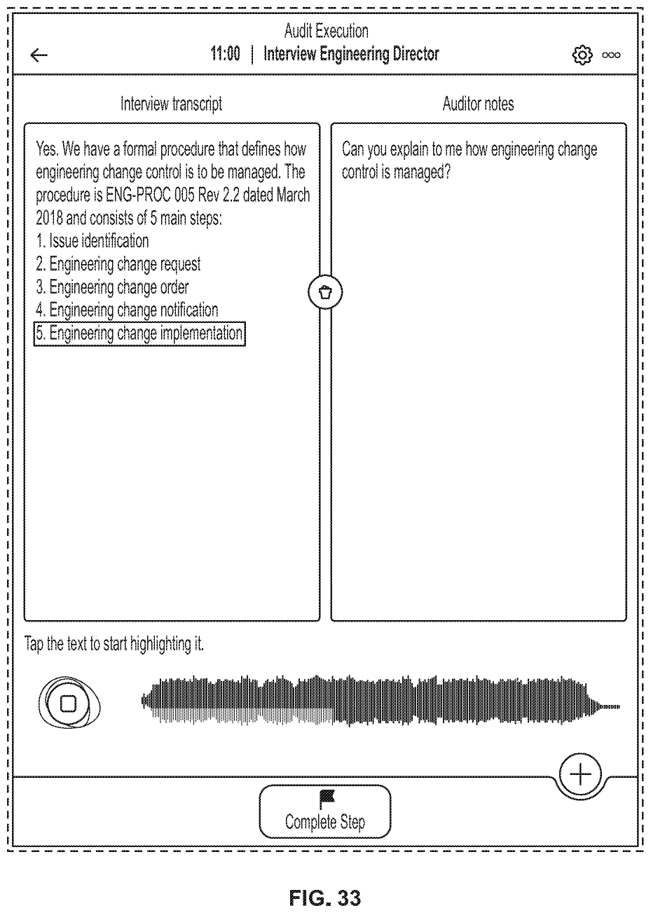

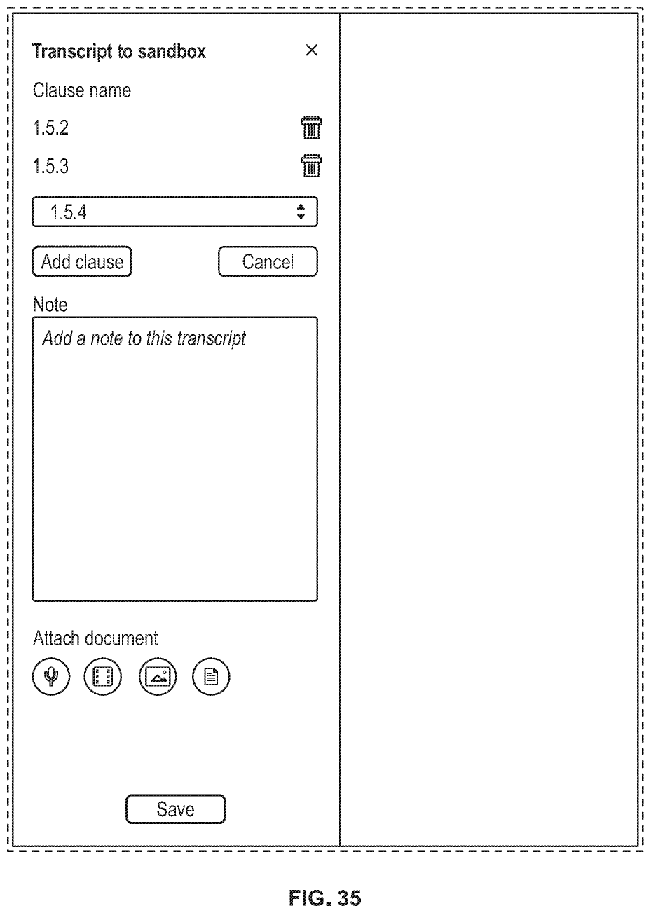

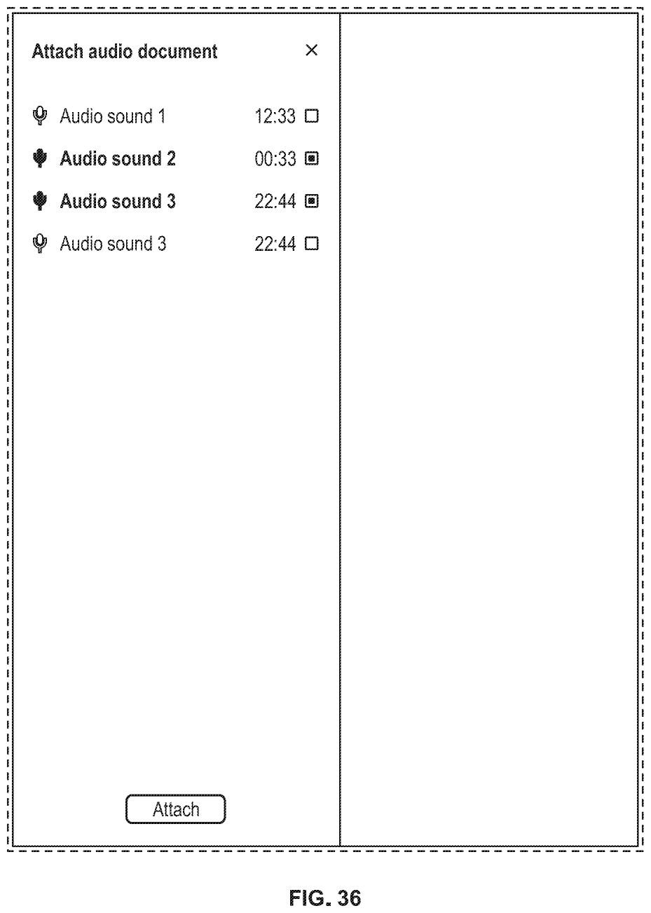

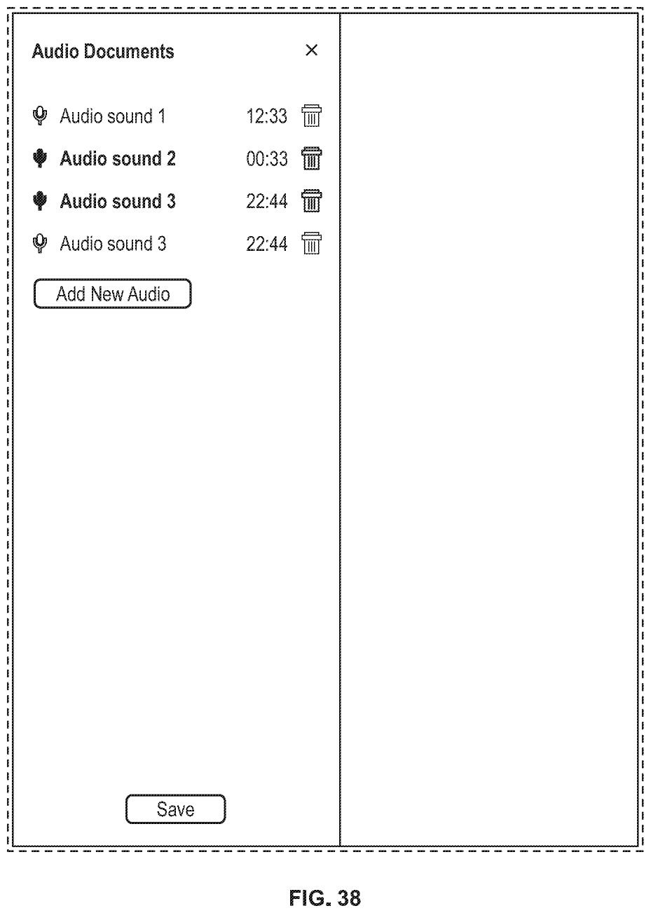

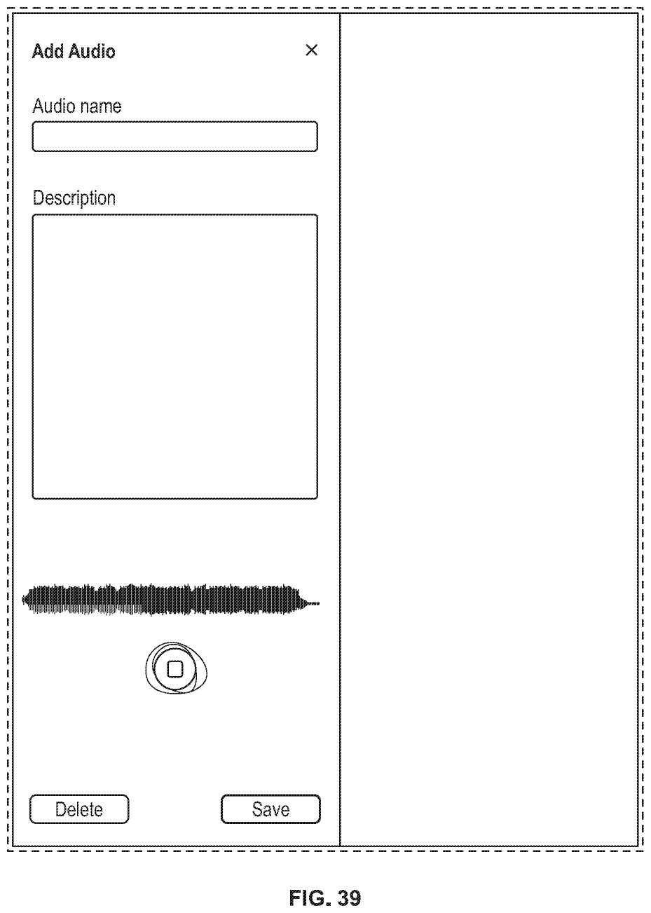

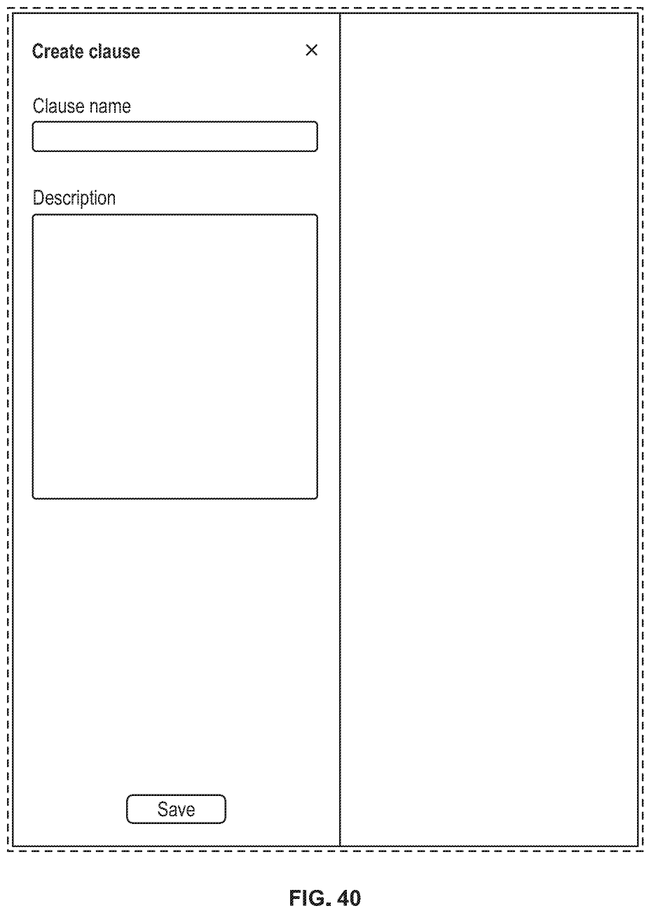

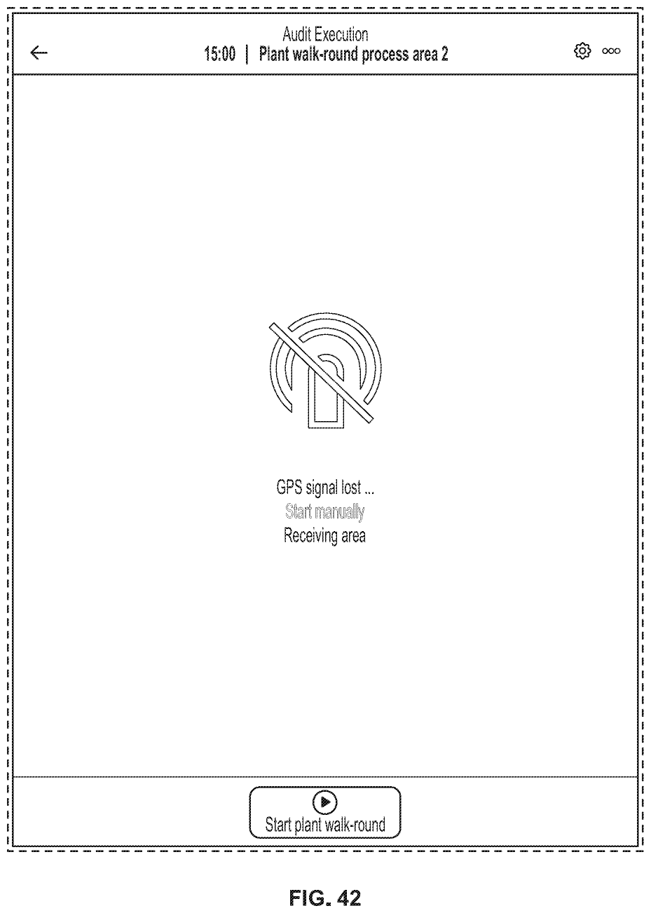

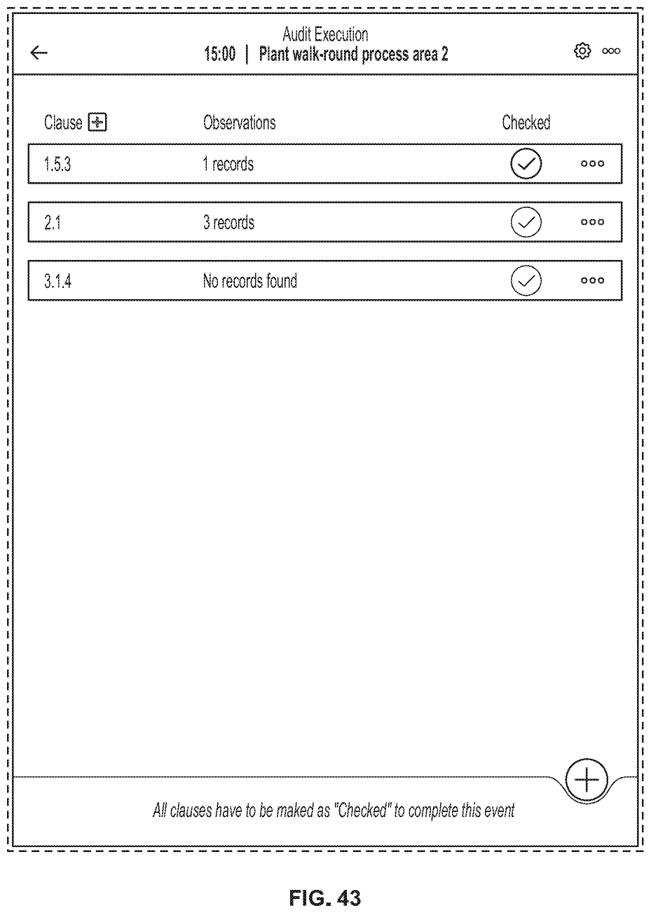

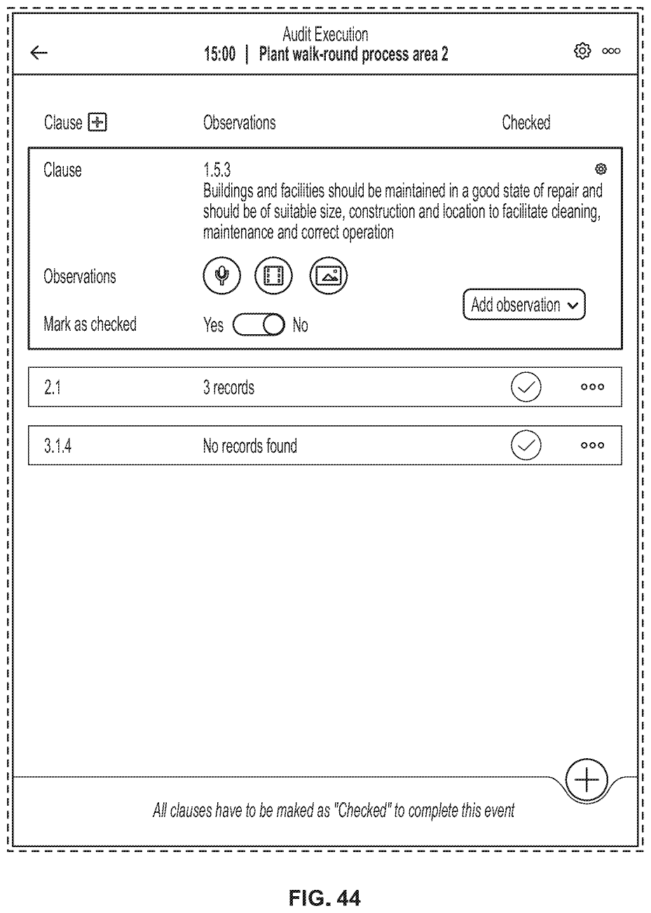

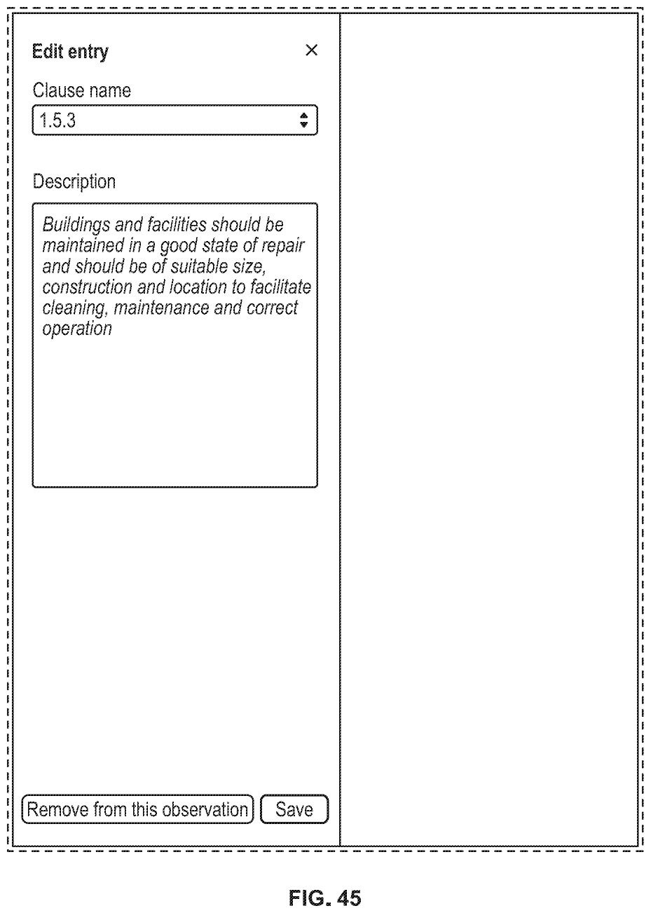

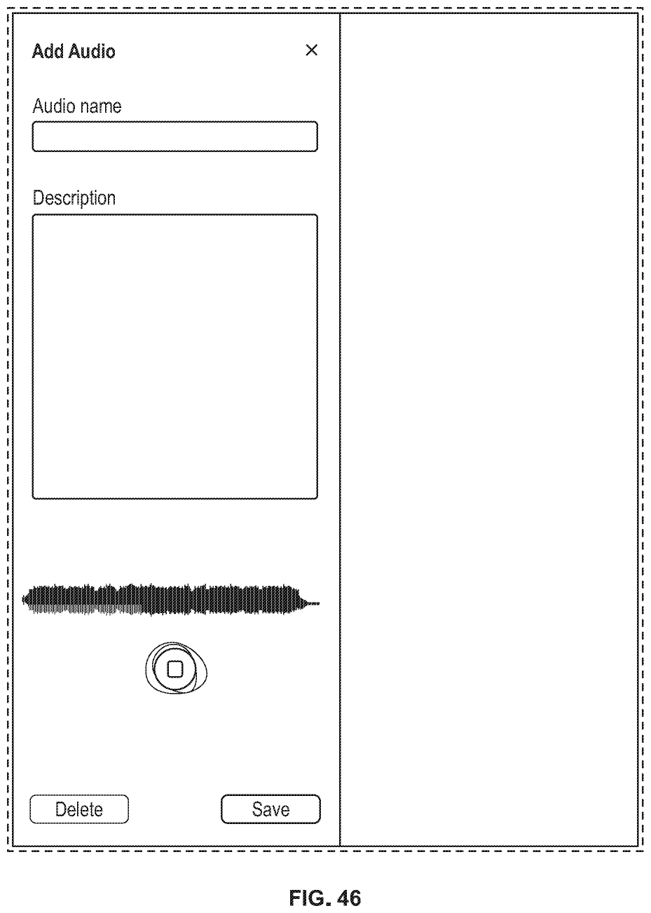

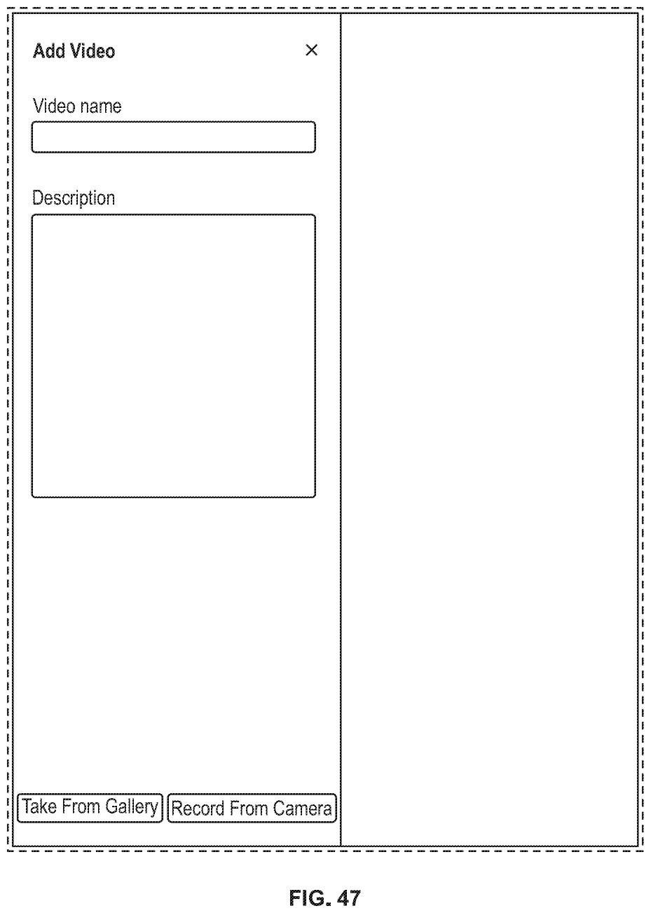

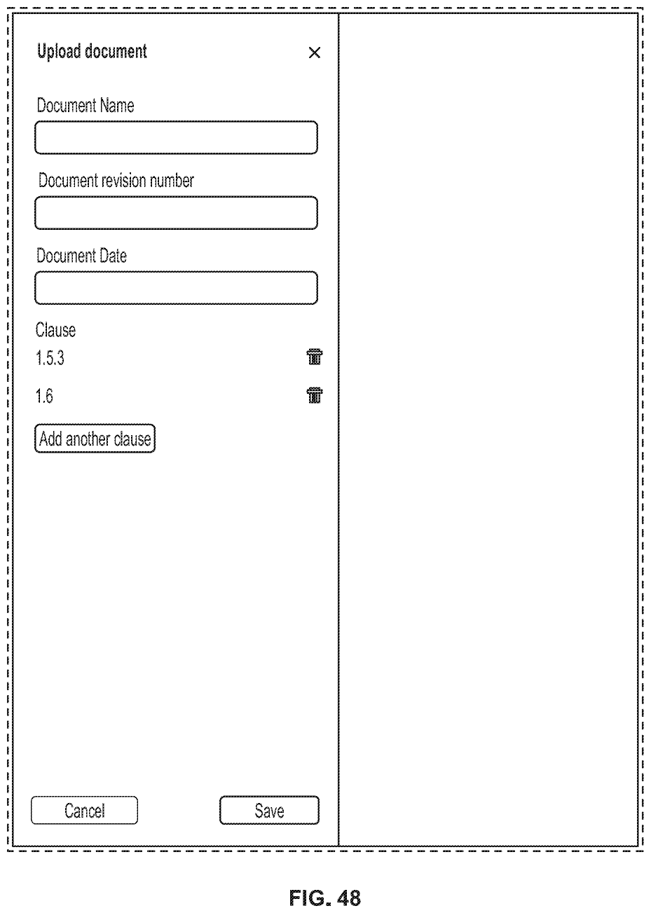

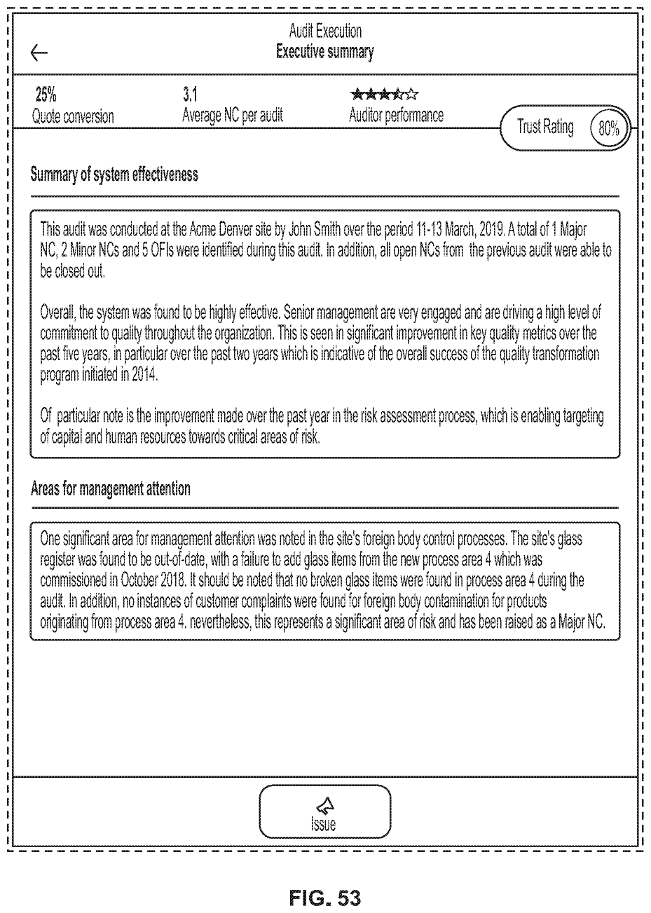

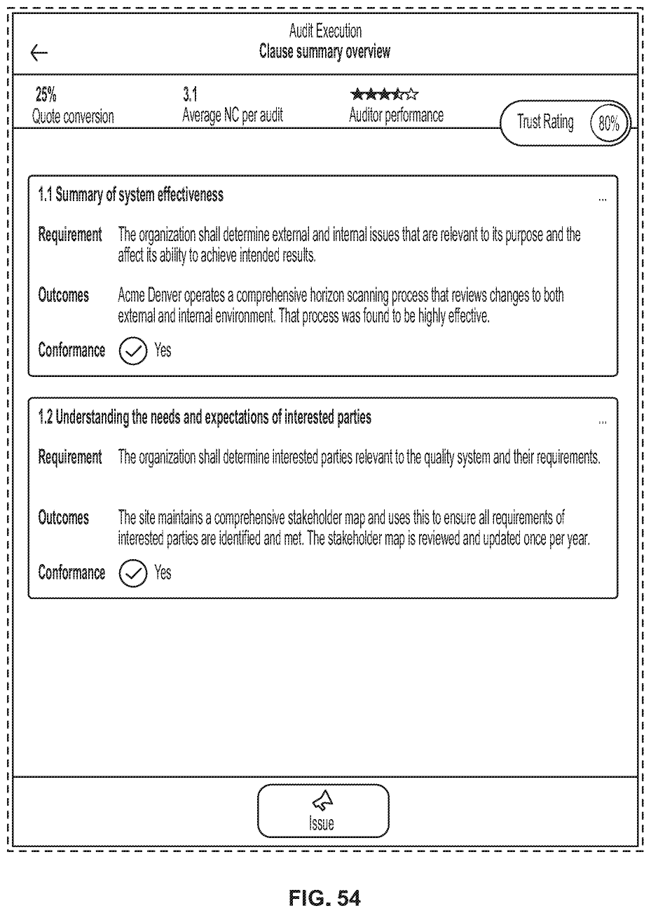

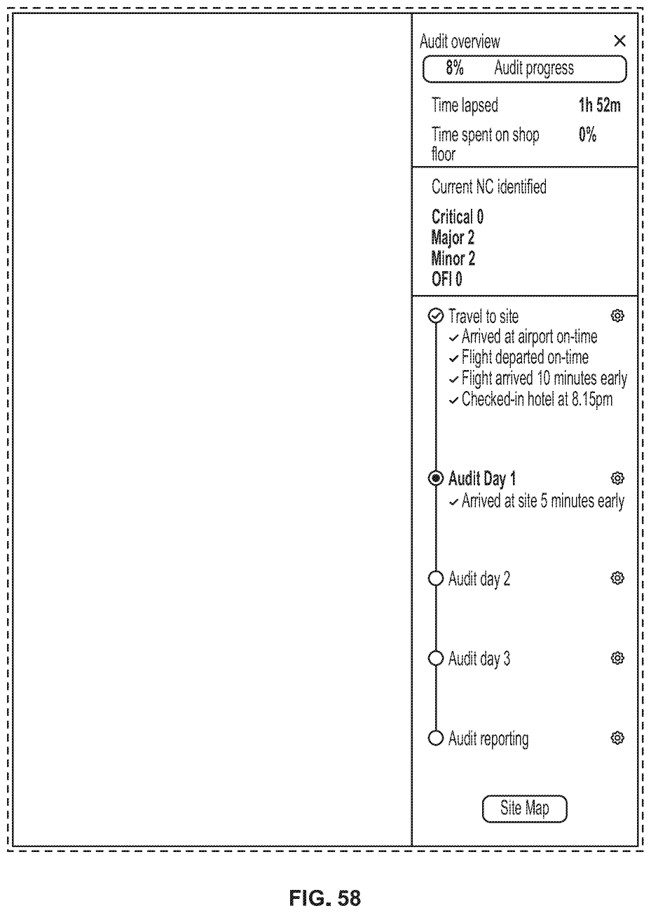

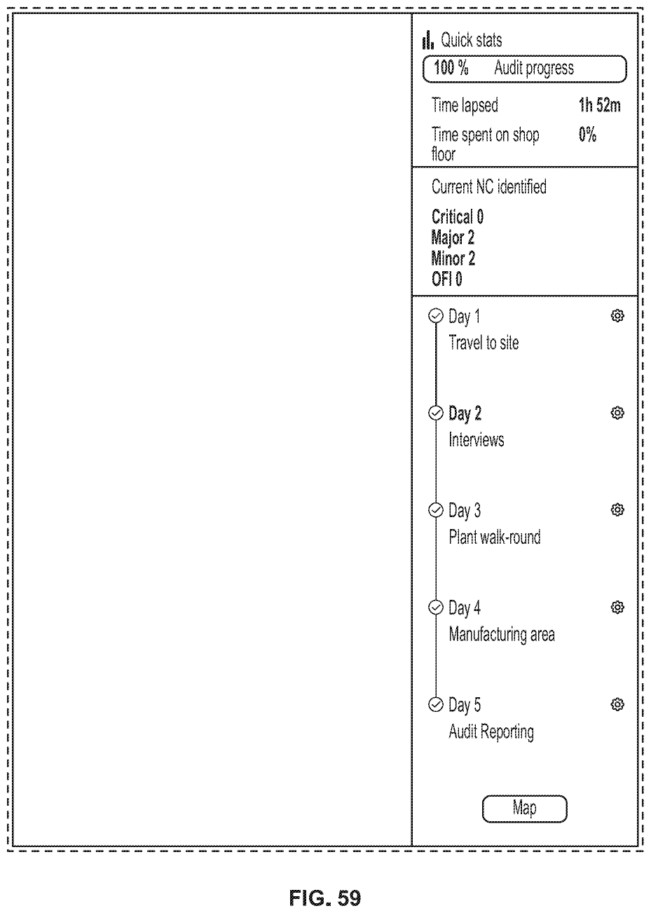

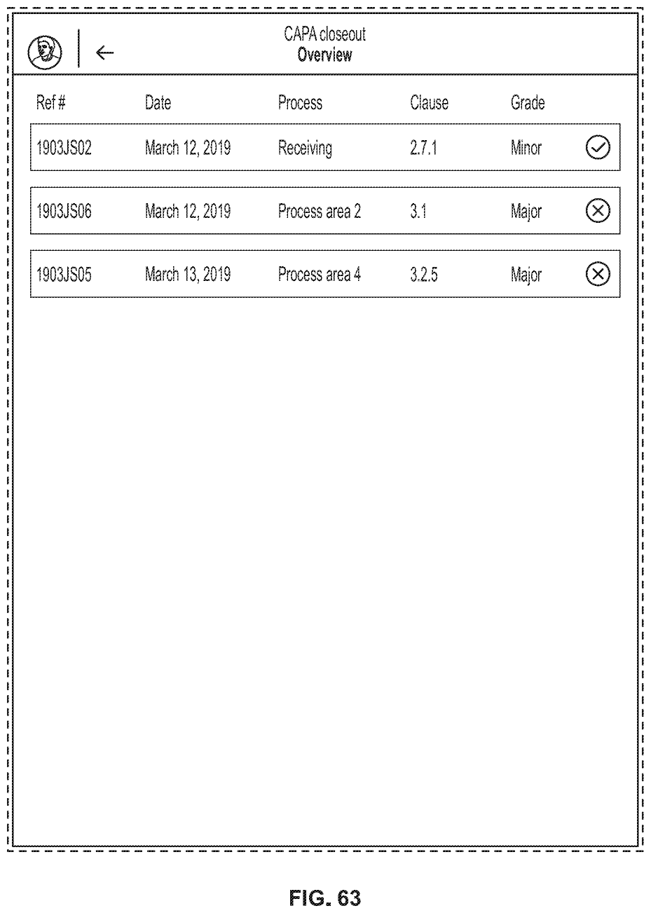

Generally, an audit includes a planning, execution and reporting stage. An exemplary planning stage is depicted in FIGS. 7 to 22, execution stage, is depicted in FIGS. 26-62, and reporting stage in FIGS. 63-77.

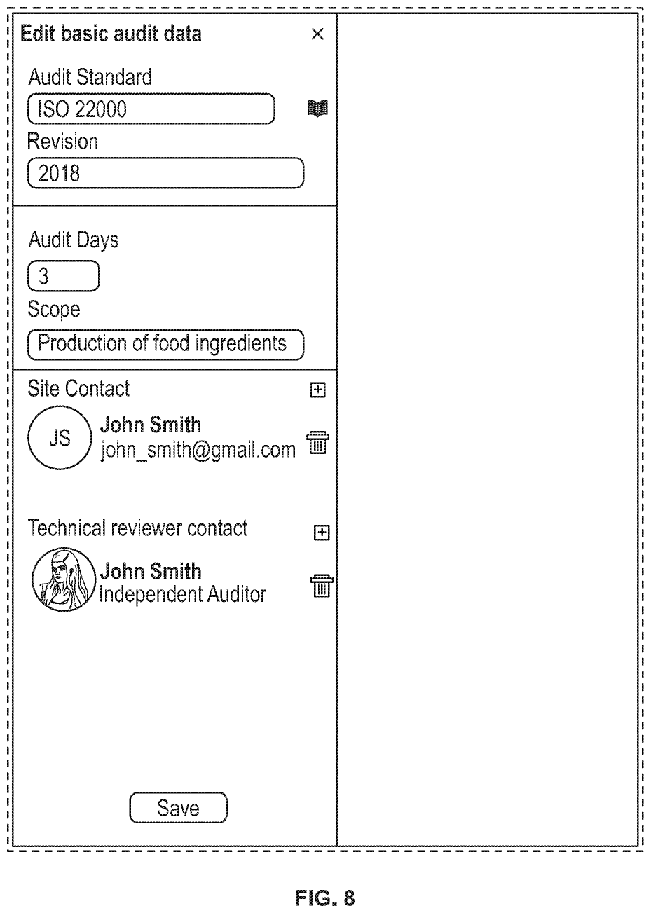

Referring to FIGS. 7-22, an auditor is provided with the capability to input audit data into device 10A. Referring to FIGS. 7 and 8, some of the data may be pre-populated from the request for quotation and/or contract with the audit requestor or auditee. Examples of the pre-populated audit data, includes site name, audit standard, site contact, scope of audit, and the like. This information may also be input into the one or more devices 10A, 10B, 10C, and/or 14. The information may also include audit business name (CB or IA) with a link to profile, customer reference number, Job/contract reference number, statement of work details, contact details for team members. Also included may be a defined criteria, such as an audit scheme or standard (e.g., A1, FSSC22000, companies for their second party audits), the standard to be audited against (e.g., EFfCI) (this may also be in put in the title line of the calendar entry), audit scope, audit dates (system is configured to generate audit days based on dates), type of audit, such as initial certification, initial certification stage 1, initial certification stage 2, surveillance, recertification, and/or NC grades to be employed for the audit. Dependent on the defined criteria default grades may be included such as: critical, major, minor, observation, opportunity for improvement (OFI).

If the audit is an AuditOne audit, parameters may be defined such as who at the customer's customer needs to see particular information, e.g., audit plan, who is notified of major non-conformity and so on. The system or device will notify auditor where the scheme/standard to be audited against does not have an associated audit report template, in which case the auditor will define an appropriate report template (using a defined generic template as the basis). Auditor may have ability to make amendments to the generic CAPA workflow if needed. The system or device provides capability to print or export audit plan for each audit job in an auditor's queue. The system or device provides capability of scheduling an audit planning meeting, i.e., following shared calendaring concept e.g., doodle or calendly.com type capability (see calendaring above). The system or device provides access to an embedded web conference tool to facilitate audit-planning meeting (the meeting should be recorded and uploaded to the system or device for record purposes). Web conference tool desirably does not require any user to download and install an app. Desirably this would be a third-party tool with calendar plug in. The system or device provides capability to distribute draft and final audit plans to nominated Site and customer contacts. If customer of a customer is allowed to see the documents given the nature of the original request issued, then they would also see the documents allowed by that original request.

The function provides capability for auditor to define list of site/customer and auditor team contacts to send each type of notification to (for alerts associated with audit plan, NC identification, CAPA, report, certificate, etc). The system or device provides capability for an auditor to change the audit plan when he/she sees fit during the audit process. Customer has capability of uploading required documents requested by the Auditor either prior to, or after, the planning meeting. If not submitted 2 weeks before the audit a notification should be sent to the customer site primary contact and daily thereafter until documents are submitted. The system or device provides the ability to markup draft audit plan with changes and send those changes back to the auditor. The auditor can review and accept/reject changes (identifying reason if they want). Exchange of drafts and comments can continue until audit plan is accepted and hence finalized. If customer of a customer is connected to the audit via audit/certificate request, the customer of a customer will receive notifications of availability of draft audit plan available for review and final audit plan approved by customer.

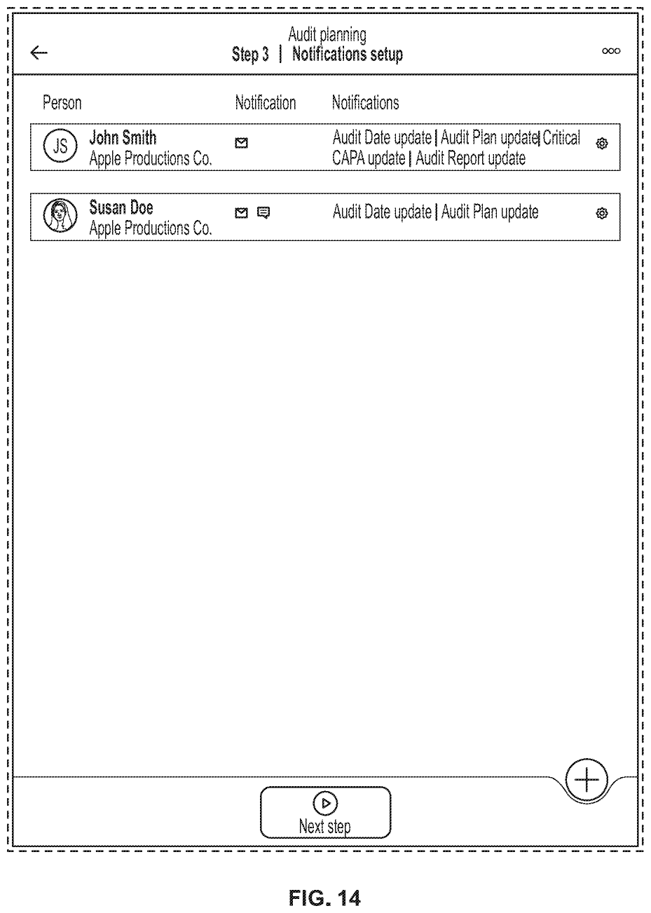

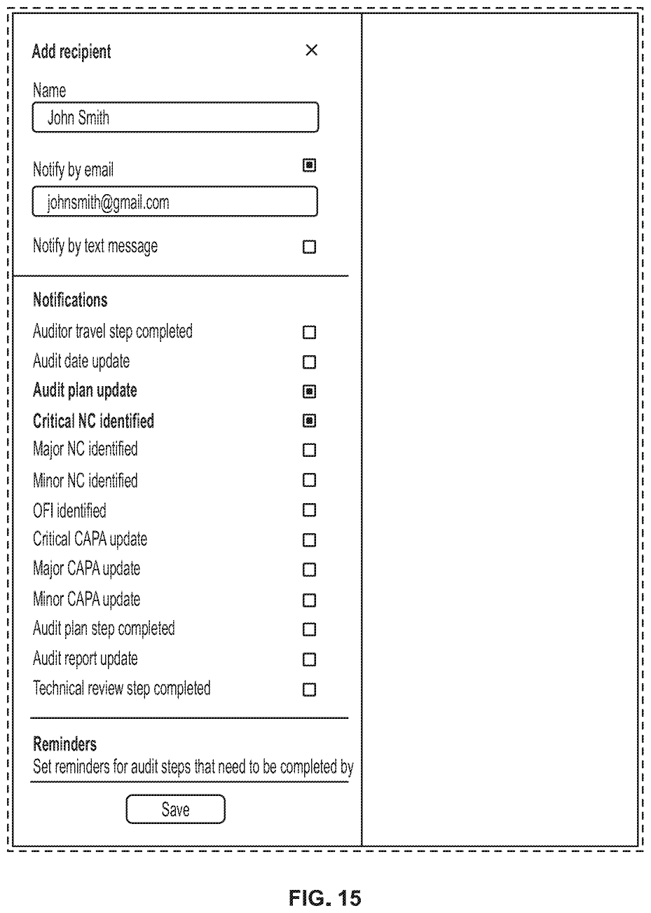

Referring to FIGS. 14 and 15, user of device may set up notifications features. As illustrated, the notification feature can identify a person to receive the notification and the content of the notification to be sent to the identified person. Notifications can be snoozed, muted or grouped as described above. Notification to specified parties can be setup or default, as illustrated in FIG. 15. For example, primary site contact may be set as a default or predetermined. Notification to the specified parties may indicate that the auditor has arrived on-site for each scheduled day of the audit (based on GPS data from auditor device).

Other notifications may include any of the following: A need to update terms of service that apply specifically to the audit module. Notification to be issued to the specified parties where the auditor does not arrive on time each day (based on the approved audit plan). Notification to the specified parties (default is primary site contact, with others as defined by Primary Site Contact) that the auditor has left the site for each scheduled day of the audit (based on GPS data from auditor cell phone). Notification to be issued to the specified parties where the auditor leaves the site early each day (based on the approved audit plan). Notification to the specified parties (as a minimum principal site contact and Brand Owner where applicable) of the total audit time spent onsite over the entire audit.

As an example, notifications may be sent to specified parties, such as site individuals who have subscribed to the notification and others, when the auditor does not meet the total duration requirement for the audit in hours (based on an 8-hour day, so for example a 3-day audit should have a total of 24 hours spent on-site).

A Notification may also comprise one or more consent forms connected with the audit. The process is similar to how one can set available times in a calendar and prevent people from scheduling meetings when not available, except in this context, the auditor is setting their working day. In so doing, the auditor has to confirm e.g., ‘You agree, confirm and consent that during the time you have identified as available, Device 14 collects location (GPS) and time data from any device used to conduct the audit, for the purposes of identifying and confirming the audit is conducted according to the defined criteria, such as a specific scheme or standard (for example, including, but not limited to, confirming that the time prescription specified in an ISO22000 or similar audit is spent on the operations floor). The notification preferably has a ‘why do this?’ clause that indicates e.g., ‘Doing this significantly enhances the validity of the audit, and will increase your trust score.’ A summary of times set by the auditor is part of the screen/message they confirm. Record of that confirmation must be maintained in system or device for Device 14 to access/use for legal purposes if/when required. Auditor should be able to edit their available times at any point. When the auditor does not use this feature, it will reduce their ‘Trust Score’. The start/stop of the plant walk-around may be time stamped and recorded recorded and mentioned in execution notes or an audit report. Notification may be issued to the specified parties (e.g., as a minimum principal site contact, brand owner where applicable and scheme owner) when the plant walk-around portion of the audit does not meet criteria, e.g., scheme requirements (where specified).

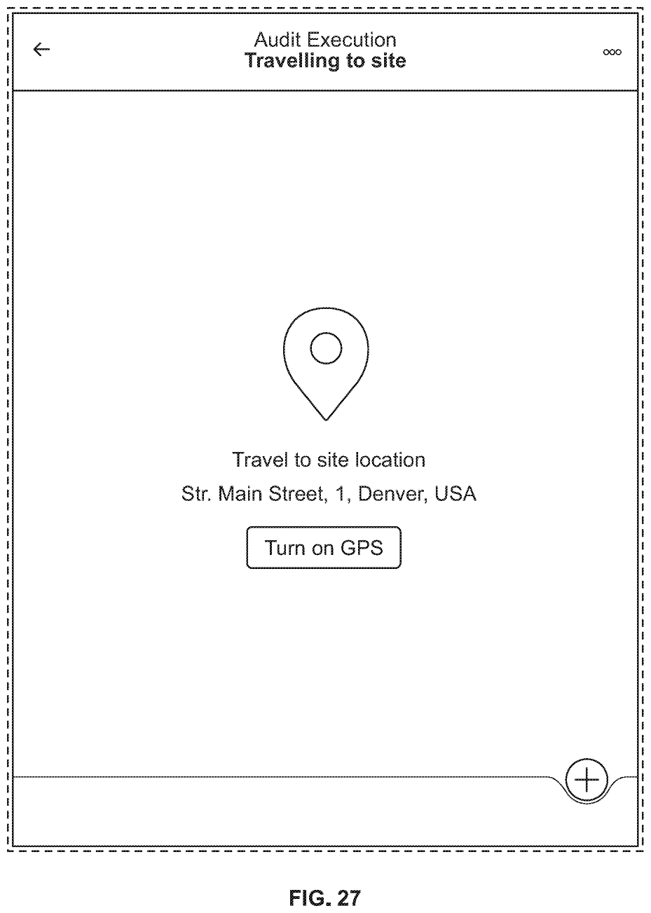

After the audit planning stage is complete, the audit execution stage begins with the arrival of the auditor at the site, as depicted in FIG. 26. When the auditor arrives on the site (FIG. 27), there is a ‘handshake’ using suitable authentication process, such as fingerprint, authentication codes, face recognition, that auditee provides to the auditor to enter the site. The device 14 may timestamp the arrival of the auditor and unlocks communication to device 14.

During the initiation of the audit execution, auditor 12A accesses an audit plan overview, as exemplified in FIG. 28. The auditor also accesses storage comprising defined criteria, such as a scheme- or audit standard-specific standardized opening meeting slide deck that auditor can download from library stored in database 32, and customize as needed. The auditor may also be provided access to embedded web conference tools to facilitate an opening audit meeting. The contents of the meeting may be recorded and transmitted to device 14.

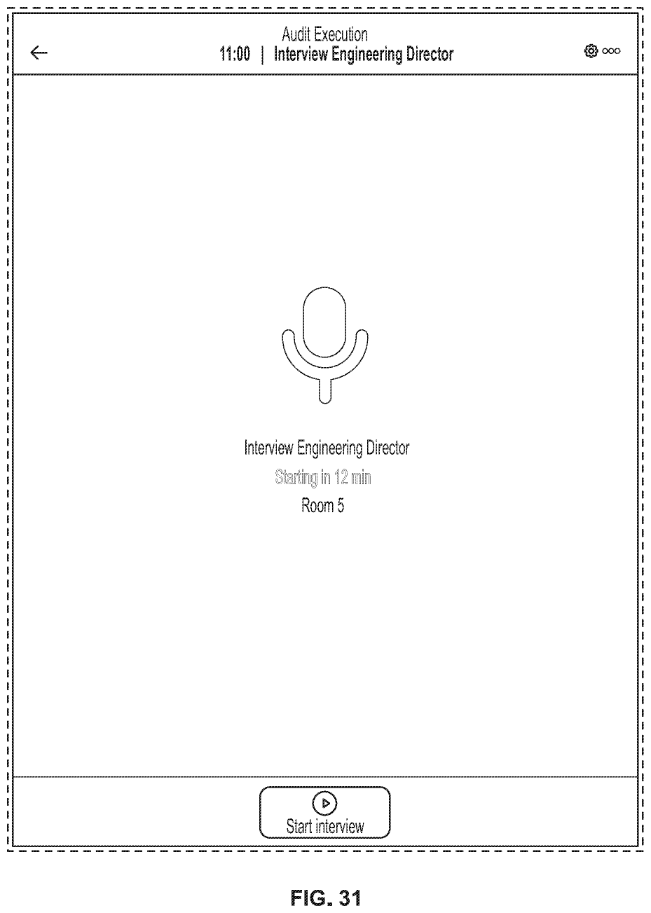

FIGS. 31-40 are screenshots of a graphical user interface (GUI) in accordance with an exemplary embodiment of the disclosed subject matter showing features of the audit execution module related to a first event of an audit comprising an interview and observations including prompts for uploading interview recordings, transcripts, data and auditor comments.

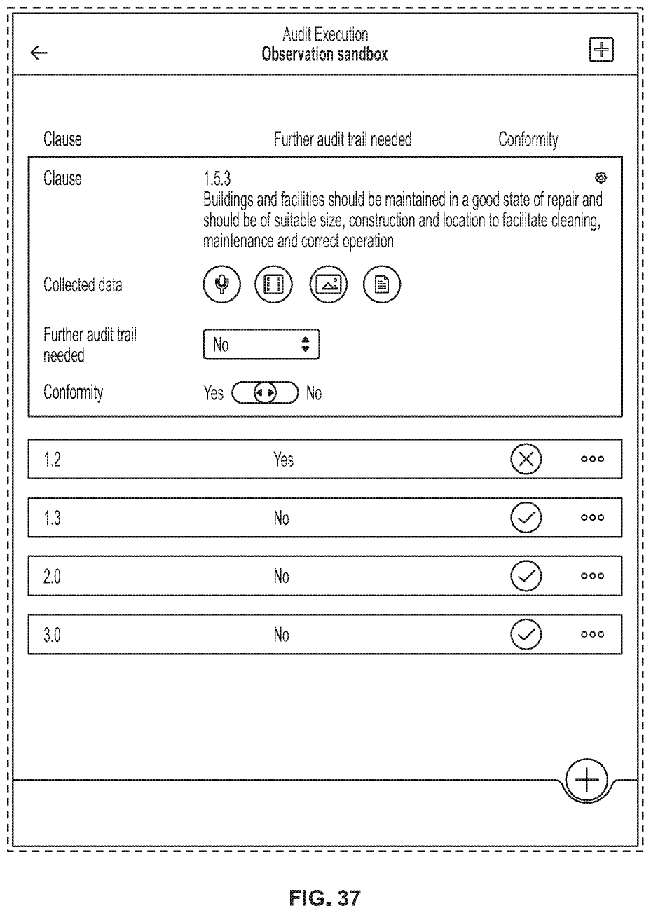

The auditor may record in device 10A audit interviews, as shown in FIGS. 31-33. This data becomes at least a portion of the behavior metadata and/or audit observations that is received by the device 14. Devices 10A and/or device 14 have software to convert audible interview recordings into text. The text or audio record is stored in database 32 and/or sandbox for subsequent availability to the auditor, technical reviewer or others for analysis. The system or device provides ability for the auditor to highlight passages of the interview of particular importance (e.g., button on the tablet to turn highlight on and then off which then emboldens specific text passages). The system or device provides ability for auditor to capture notes directly onto the tablet during the interview. Ability for the auditor to send the interviews (in text format) for technical review by qualified auditors who are online and available is provided. Quote for fixed price will be sent and can be bid/accepted by the auditors qualified for this audit standard. Technical review will be done within set time and available before auditor finalizes audit report. Clauses, transcripts and/or audio documents related to the audit process can be added to the sandbox using dropdown menus (see. FIGS. 34-36). Similarly, an Observation sandbox can be organized and populated with clauses, transcripts and/or audio documents (see. FIGS. 37-40).

Document Reviews. All documents uploaded into the system or device by the principal site contact to be available to the auditor a minimum of one week before the audit and during the audit and available in read only mode/copy. Access should not be removed after the audit has concluded. The system or device can restrict ability for auditor to print/download/screen capture or any other means of capturing data from uploaded documents provided by the Site.

The Auditor 12A has the ability to capture comments (in writing, or speech capture that is subsequently converted to text) and associate with specific document references (e.g., this comment pertains to Clause 4.5 of the Site Quality Manual). Desirably there is an ability for the auditor 12A to send the document reviews (in text format) for technical review by other qualified auditors who are online and available. Quote for fixed price may be sent and can be bid/accepted by the auditors qualified for this audit standard. Technical review will be done within set time and available before auditor finalizes audit report.

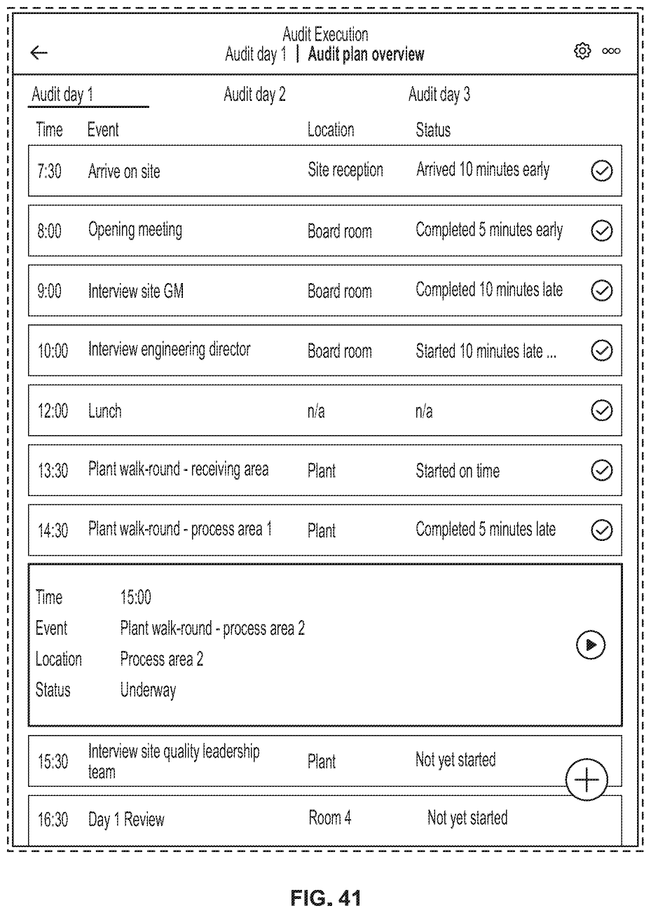

FIGS. 41-48 are screenshots of a graphical user interface (GUI) in accordance with an exemplary embodiment of the disclosed subject matter showing features of the audit execution module related to a second event of an audit comprising a location walk-around including prompts for uploading observations, video, audio, data and auditor comments.

Plant walk-around. As noted before, the start/stop of the plant walk-around is time stamped, which may authenticate and verify that the location that auditor is standing, is in a practical proximity of the location of the observed finding. In addition, the time from start to finish of the input to record an observation and a required activity at that location (e.g., drain swab) can be calculated to conform with a standard or standards and historical time lapses for the same activity to determine whether the auditor allocated less time, more time or the appropriate time to accomplish the task. This can be recorded and mentioned in execution notes or audit report, with notification to be issued to the specified parties. Auditor has access to the checklist appropriate for the defined criteria, such as scheme/standard under audit from a storage library, such as a database, with the ability to capture notes directly onto its device, e.g., tablet. The system or device provides the ability for the audit management system to load checklists. Subsequent ability to allow others to load and manage checklists using same concept as defined for templates in the Requests process (e.g., Cargill SEM). Auditor 12A has the ability to take photos and video and attach to specific checklist requirements are included in the mobile device 10A or in separate devices linked to the mobile device via a communications interface. Menus can be accessed to download observations, photos, videos, audio, notes, documents and other data similar to that described for the interview event above. Photos and videos are geo-located. photos and videos are time stamped. Auditor may have ability to capture comments (in writing, or speech capture that is subsequently converted to text) and attach to specific GMP checklist requirements. Comments are geo located. Comments are time stamped.

When a specific part of the walk-around is finished, the auditor can send or the systems sends (the auditor can override this but it will cost them in their ‘Trust Score’) the checklist that was completed for that part of the facility/audit for technical review by qualified auditors who are online and available. Quote for fixed price will be sent and can be bid/accepted by the auditors qualified for this audit standard. Technical review will be done within set time and available before auditor finalizes audit report.

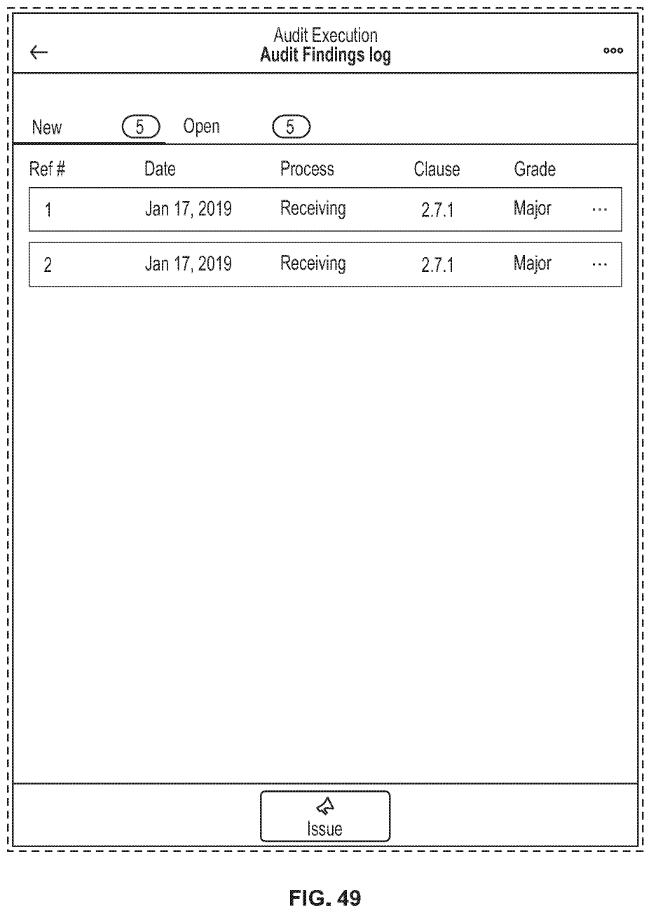

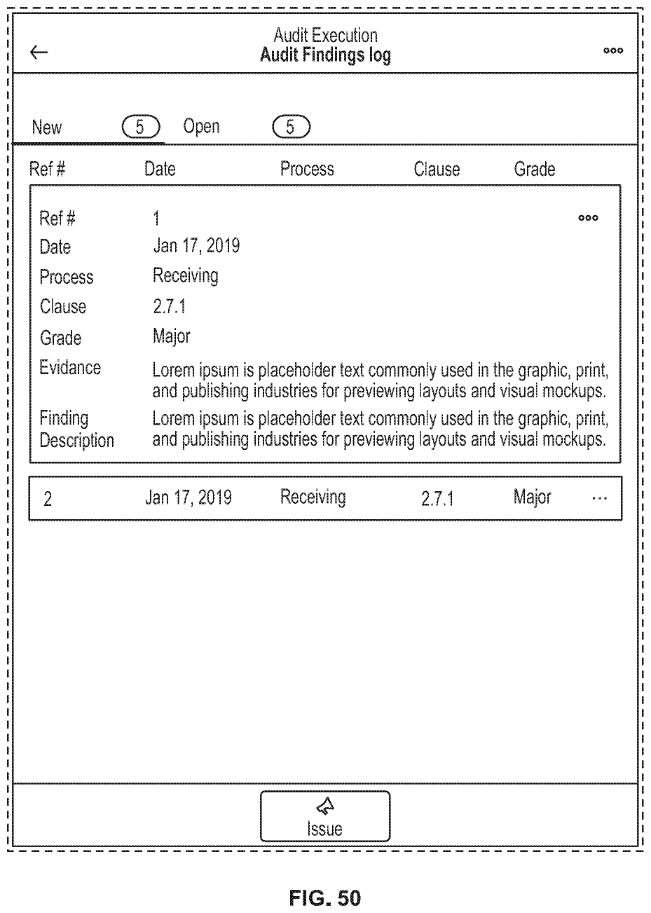

An audit findings log is generated to summarize the findings of the audit events conducted by Auditor 12A (See FIGS. 49 and 50).

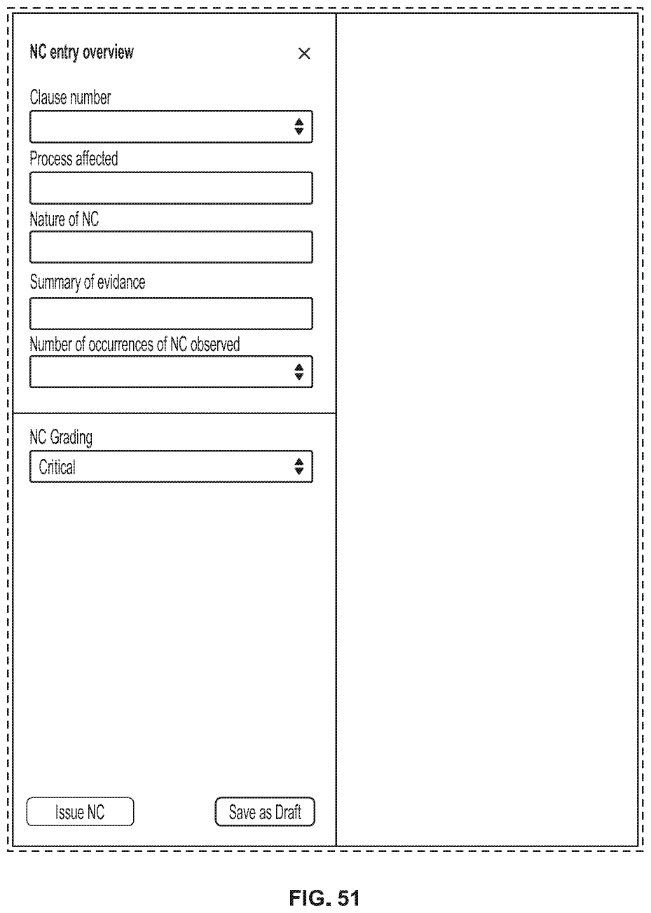

Non-Conformity (NC) Identification. The auditor has the ability to raise an NC at the time the non-conformity is found. See FIG. 51 for a screen for uploading a Non-Conformity at the time of its finding. The NC record can include: date and time of finding (auto generated/time stamped), NC Reference (auto generated, auditor initials/MMDD/sequential Number Commencing 01), Site Process Where Finding Identified, geo located based on where the auditor physically was when finding was recorded, Requirement Clause Associated with Finding (drop-down of clauses to be provided to the auditor based on Standard being audited), Nature of the NC (finding description), What evidence supports the NC (e.g., photo, section of transcript from management interview, observation, cross-reference of auditor comment, etc. The system or device provides facility for auditor to cross-reference evidence previously uploaded or upload evidence at time of NC entry). Grade (utilizing grade list setup by auditor in step 9a. ii 9). Each NC will be sent for technical review by qualified auditors who are online and available. Quote for fixed price will be sent and can be bid/accepted by the auditors qualified for this audit standard. Technical review will be done within set time and available before auditor finalizes audit report. Notification of NC record and grade (e.g., major NC just identified) to be sent to specified parties as defined in Site Contacts.

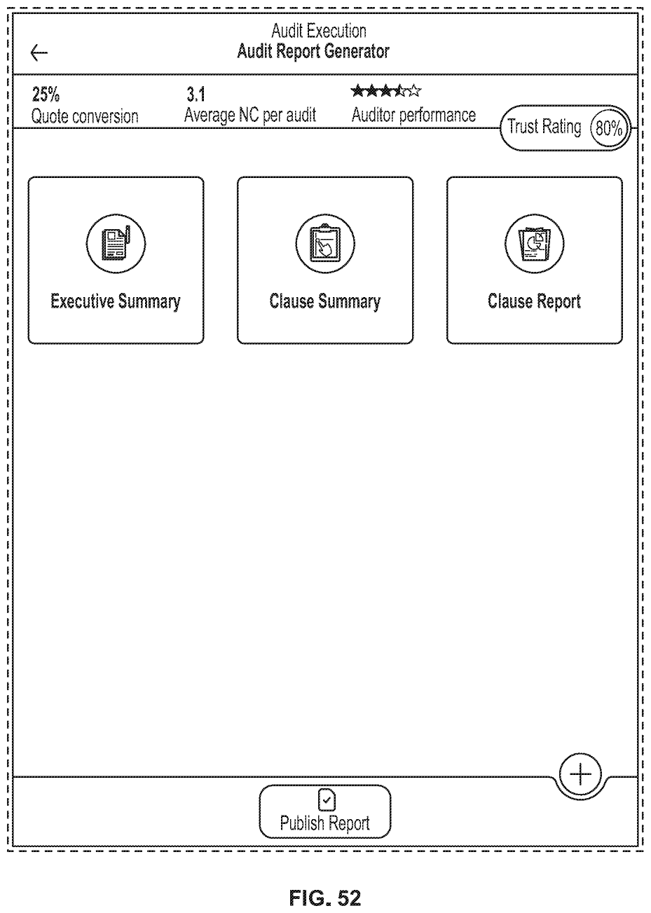

In embodiments, the audit execution module provides the Auditor 12A with the ability to generate an audit report including an executive summary and clause summary overview (see FIGS. 52-54).

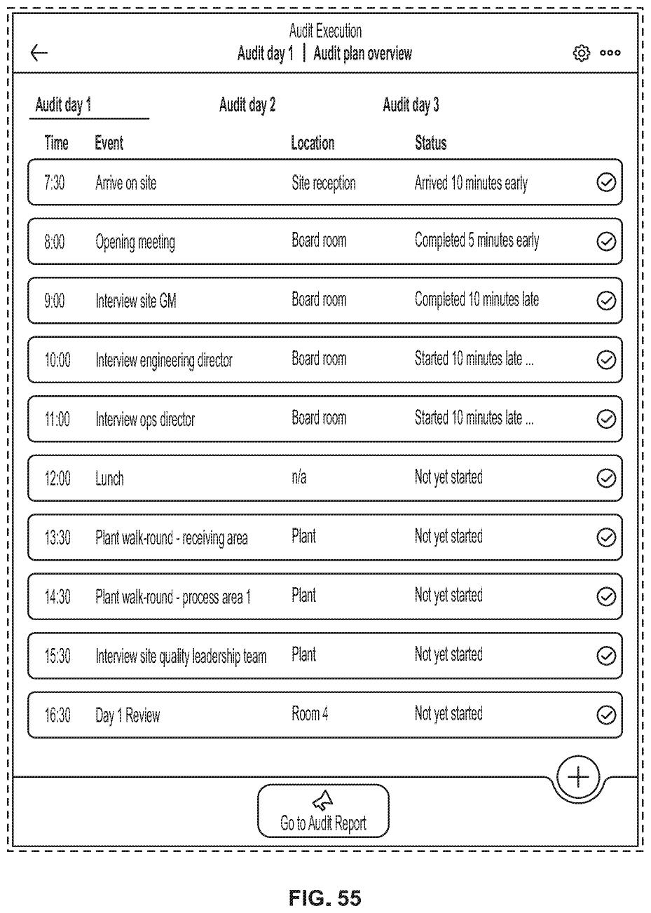

As the site visit progresses, the audit plan overview is updated during or after each audit event is conducted. The event status is time stamped and the compliance to the plan is indicated. (see FIG. 55).

As part of the communications interface, the auditor has access to messaging capability to contacts including for example, other auditors, customer personnel, site personnel related to an audit, etc. (see FIG. 56).

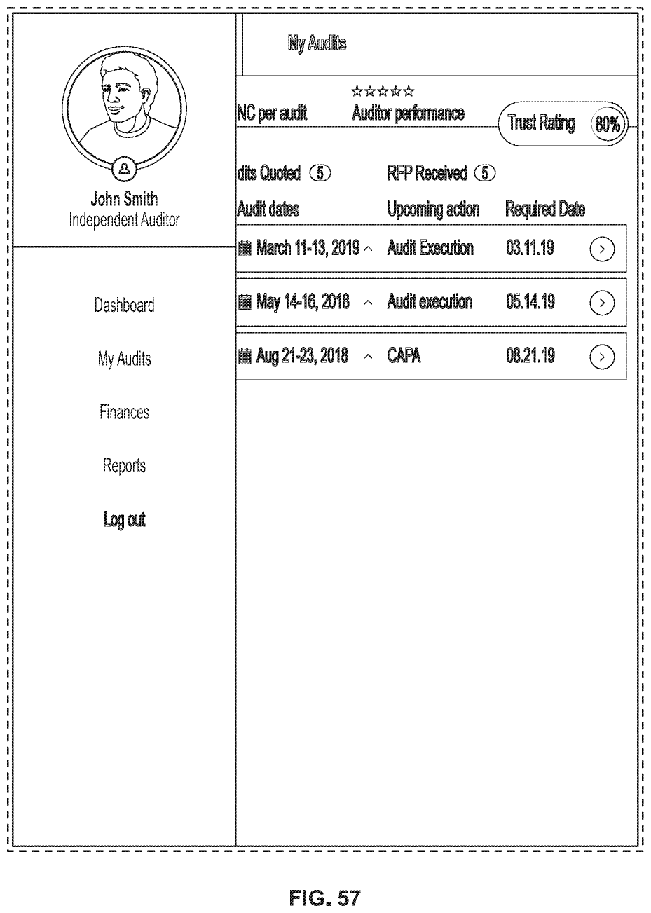

As shown in FIGS. 57-59 the auditor can access his dashboard during an audit to review the audit overview and progress information as the audit visit progresses.

As shown in FIGS. 60-62 the mobile device 10A can track the progress of an auditor through the site, including locations visited during an audit in a site map, in the map module. Locations are time-stamped and identified using GPS coordination. As discussed above, the behavior analytics module can use the tracking information to confirm that the auditor is visiting the locations specified in the audit plan.

FIGS. 63-73 show features of the CAPA Closeout module.

CAPA Generation. Each discrete NC identification triggers CAPA request to Site Principal Contact. FIG. 63 shows a screen showing an overview of clauses identified during an audit. Auditor 12A is required to identify which CAPAs will impact certification decision. Capability for Site Principal Contact to enter date by which CAPA response will be available. Notification to the specified parties (as a minimum auditor, technical reviewer and Brand Owner where applicable) once a CAPA response is uploaded by the Site Principal Contact. CAPA process to go back and forth between site principal contact and auditor until auditor approves CAPA. Auditor can approve specific items in CAPA. Auditor can reject specific items in CAPA. Must have accepted or rejected each item. Rejection requires auditor to provide a comment. Comment and rejection sent back to site contact. Site contact can amend and resend to Auditor. Auditor can accept/reject as above. Process completes once all items are accepted by auditor. Drop-down menus in the CAPA module can provide details relating to each clause in the overview (FIGS. 64-73), including details of non-compliance identification and communication between the auditor 12A and the Site Principal Contact to address the non-compliance issue. Signatures and approvals/rejections are time-stamped to show progress toward resolution. The device 10A transmits to one or more technical reviewers for final approval or verification of correctness or validity. Quote for fixed price will be sent and can be bid/accepted by the auditors qualified for this audit standard. Technical review will be done within set time and available before auditor finalizes audit report. Notification to the specified parties (as a minimum auditor, site principal contact and brand owner where applicable) once a CAPA response is approved by the trchnical Reviewer. Dependent on the defined criteria, such as a specific standard or scheme, the certificate (if applicable) cannot be issued at final stage of workflow unless all CAPAs are signed-off by technical reviewer.

Closing Meeting. Auditor can access a defined criteria, such as a scheme- or audit standard-specific standardized closing meeting slide deck (e.g., in power point) from a library in the database 32 that the auditor can download and customize as needed. Closing meeting formats can be created or customized to include information related to the standard(s) associated with the audit. There is the ability for a user to create and store these on the system or device, then leverage their own templates. The system or device can provide access to an embedded web conference tool to facilitate closing meeting (the meeting should be recorded and uploaded to the system or device for record purposes). Auditor to have the capability of scheduling the closing meeting prior to the last day of the audit, including inviting all those identified by the site principal contact. Data to be uploaded prior to the last day of the audit by the site principal contact. Notifications sent if not submitted one week before the last day of the audit and daily thereafter. An Executive Summary (see FIG. 74) can be part of the closing meeting information.

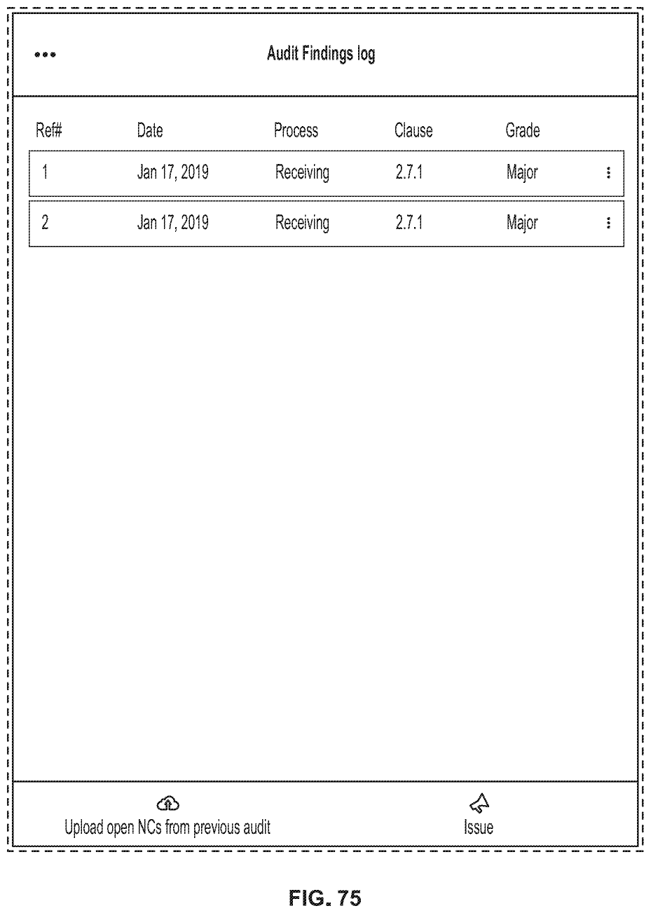

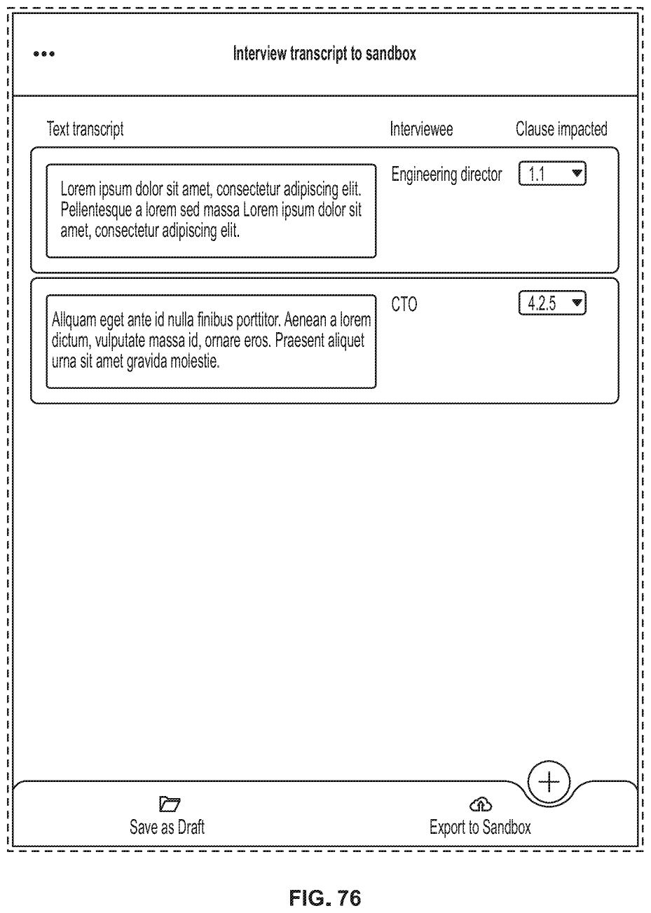

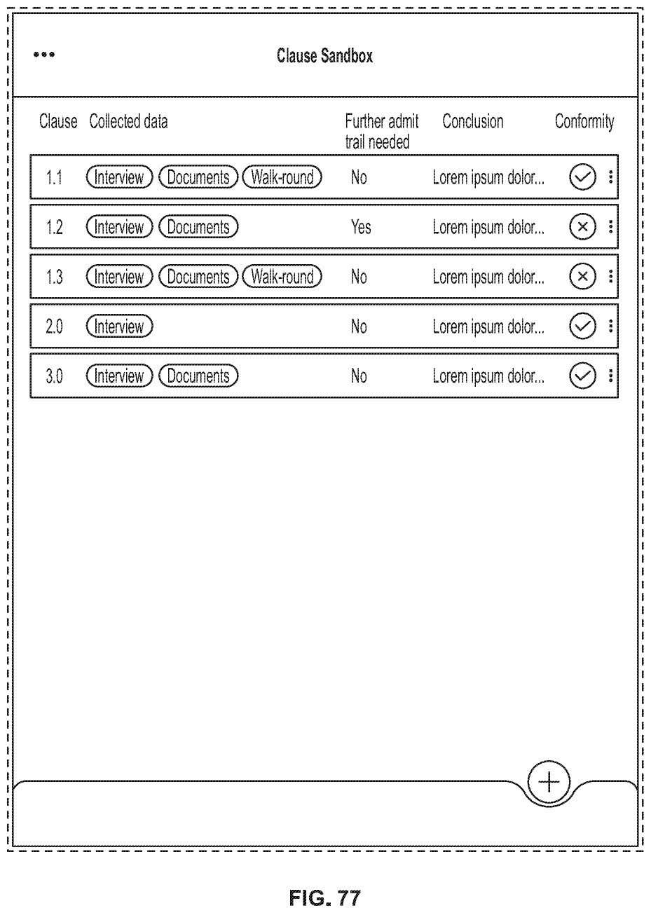

Audit Findings Log (summary of all NCs identified during the audit) to be uploaded prior to the closing meeting by the auditor (see FIG. 75). Updated Interview Sandbox and Clause Sandbox (see FIGS. 76 and 77) are available for use in the closing meeting. Notifications can be sent to the auditor if not uploaded 4 hours then every hour until 2 hours, then every 15 minutes thereafter prior to scheduled meeting time. Notifications to be sent to all closing meeting participants, Technical Reviewer and Customer's Customer (if applicable) once uploaded. “Create Findings Log” option should be available to the Auditor once “Audit Complete” is selected by the Auditor. Modify CAPA and draft report due dates as needed.

Audit Report Generation. System or device to host audit report templates for a number of defined criteria, e.g., audit schemes/standards. Auditor to have capability to define report template for audit schemes/standards where an existing template is not available (to be performed by the auditor during the planning stage (see Section 2a). Audit Report template to pre-populate with metadata already entered by auditor during planning and audit execution activities. Auditor to have capability of editing the pre-populated audit report as needed. Notification to be issued to the specified parties once draft report uploaded (as a minimum, Site Principal Contact, technical reviewer, Brand Owner (if applicable, with others optional/available to select). For audio recordings (e.g., of interviews), allow the customer/site to set an expiration of those either on certification or x weeks after certification for the specific audit. Have the auditor warned if they load an audio file of the defined expiration date of that audio for that specific audit.

In another aspect, a method is provided for creating a virtual auditor marketplace. In one embodiment, one or more auditors 12A are identified for an auditee 12B or audit requester 12C based on one or more parameters, such as location, market segment experience, and qualifications or ratings. Auditees, auditors and/or audit requesters register with the audit device 14. Device 14 may include stored information, such as audit categories, applicable laws and standards, and auditor list identifying a plurality of auditors. In certain embodiments, the audit list includes information about the auditor such as expertise and experience level, trustworthy rating (as described above), and geographical location. In operation, a registered auditee or audit requestor submits a request for quotation (RFQ) or request or purchase order for an audit. The device 14 includes processors that in response to receiving the request automatically identify one or more auditors for conducting at least a portion of the requested audit. The identity of the one or more auditors are transmitted over the network to the auditee or audit requestor. In some embodiments, the one or more auditors may include one or more technical reviewers or a group of technical reviewers, the identity of which is blind to the other auditor, auditee or audit requestor. In some embodiments, the plurality of auditors identified based on the parameters can bid on the audit request or submit a promotion to the auditee or audit requestor. Each bid being associated with an identified auditor.

In some embodiment, the method may include an e-commerce step, in which the auditee or audit requestor submitting the audit request further selects the auditor to fulfill the request, and further contracts with the auditor via a purchase request and payment through device 14. Device 14 may then transmit the purchase order and payment to auditor device 10A configured with payment software, such as Apple Wallet®.

Capability for auditor to create invoice to the system or device for all CAPA costs (labor and expenses) and audit travel expenses at the conclusion of the audit and once all CAPA responses are received and approved tying expenses into taking the flight, arriving at the hotel etc., automated reimbursement. The system or device will lock out the supplier from access to the final report and certificate until the final auditor invoice is paid. Capability for the auditor to process check payments (if all CAPAs are approved by the Technical Reviewer, the auditor uploads the invoice and the supplier raises a check all prior to the conclusion of the audit).

In one embodiment, one or more technical reviewers is assigned at the audit request state. The one or more technical reviewers may be assigned for the entire duration of the audit. In some embodiments, the one or more technical reviewers may be a group of technical reviewers that generate a consensus of approval (e.g., 80%). For example, but not limitation, in many applications the audit report generated by the system requires further technical review, for example to be verified as a true record of the audit conclusion against the audit criteria. In this regard, the system may be configured to distribute the audit report to a group of pre-qualified peers designated as “technical reviewers”. These reviewers, without knowledge of the auditor's name or the name of the organization being audited, provide objective feedback on the correctness of the audit report, against the requirements of the audit criteria. Based on a high percentage of consensus of these reviewers, all acting in isolation from each other, the technical review process results in a more trustworthy outcome than any one reviewer's opinion, which is limited by their personal bias, individual experience and competence, and avoids the potential for conflict of interest if both auditor and reviewer have a mutual employer.

In another embodiment, when an issuer sends an RFQ, an associated RFQ for a fixed price is sent to one or more qualified technical reviewers the following may occur: The one or more technical reviewers can bid to be the technical reviewer for all parts of the audit process that require technical review (quote review and technical review of audit outcome, basically they commit to the whole audit). The one or more technical reviewers can bid on one or multiple locations or sites. For example, if audit is for three locations in Europe and two locations in US, one or more technical reviewers can choose only to bid on two locations in US. For example, but not limitation, whomever bids first/accepts the RFP first will win the bid (fixed price). Future state: the one or more technical reviewers identified at this stage may not necessarily be the one available once the audit is scheduled. In this instance, the system enables an except/reassignment, and fee splitting. If no technical reviewer accepts the RFQ, the audit management system (or the standards issuer) can contact and assign one of the qualified technical reviewers to take up this task.

Once quotes are prepared, they should be sent to the technical reviewers, who may have the ability to: provide comments back to the seller (and the seller should be able to respond). Make edits to the estimates provided by the IA that relate to the line item on man days only (assuming that the GF management of the man day tables is implemented). After editing, the quote is sent send back to the seller. The seller, on receiving the technical reviewer's edits cannot edit the final quote (though can continue to send messages/comments to the TR). The seller sends the reviewed/final quote to the issuer. If the quote of an IA was accepted by the buyer/issuer, the TR stays connected to the audit for technical review of the audit outcomes. They will received the full TR fees. If the quote of a CB was accepted by the buyer/issuer, the TR is no longer connected and received the fees for the quote review only.

In another embodiment, for every step of the audit process where a technical review is required, a quote to review that particular step is sent out to all qualified auditors who are online/available. Qualified auditors can bid for each fixed price review activity. There is a clear fee schedule available on the audit management system for the different review steps, like quote review—see details under a above, (partial) report review, observation review, CAPA review etc.

In one aspect, a parallel audit architecture is described that may be implemented in hardware in conjunction with software. The architecture may be implemented using a processor and programmable logic and memory. The architecture may be implemented in a non-transitory computer readable medium residing on a computer readable storage device. The computer readable storage medium comprises instructions which, when executed by a processor coupled to the computer readable storage device, cause the processor to: process a plurality of electronic metadata including behavior and observations generated by one or more auditors. The plurality of electronic metadata may be received in real-time. For example, electronic metadata may include observations logged by the auditor during an audit of a site.

The metadata may be processed on a plurality of parallel audit processors that are instantiated on the processor. For example, observations may be processed on one audit processor while behavior metadata may be processed on a second audit processor. The processing of the metadata on the respective processors may be processed in parallel, i.e., at the same time, or serially. The electronic metadata may further include one or more unique identifiers that identifies or associates the metadata with a specific: auditor, auditee, or audit site. The received electronic metadata may be routed to one or more parallel audit processors wherein instructions which when executed by the processor cause the one or more audit processors to compare the received electronic metadata to historical electronic metadata received during an earlier time period and stored in a database. The comparison may determine if an outlier exists in the metadata. In this regard, the instructions cause the processor to generate patterns of behavior or observations from the metadata. The instructions may further cause the processor to execute an alert or notification when an outlier occurs for the received electronic metadata.

The non-transitory computer readable medium may further have instructions which cause the processor to process the plurality of electronic metadata and instructions which cause the process to obtain, from the database, previous or historical electronic metadata associated with the same auditor, auditee or audit site based on their respective unique identifiers.

In another embodiment, the non-transitory computer readable medium includes a database storing defined criteria, for example, audit standards or schemes. The non-transitory computer readable medium may further include instructions which cause the processor to process the plurality of electronic metadata and comprise instructions which cause the process to obtain, from the database, one or more defined criteria or audit schemes or standards and further comprise instructions which cause the processor to determine whether at least a portion of the electronic metadata is compliant with the one or more audit standards or schemes.

What is claimed is:

1. An audit management system comprising:
a first device comprising a processor and one or more sensors, the first device configured to monitor behavior or observation of an auditor through the one or more sensors in real-time during execution of an audit to generate audit metadata;
a second device comprising a processor and a database, the second device operatively connected to the first device through a network interface;
the second device configured to receive the audit metadata from the first device, the generated audit metadata including behavior or observations of the auditor during a period of time;
the second device configured to:
perform a data analytics operation on the received audit metadata, the data analytics operation deriving patterns of behavior or observation during the audit; and
compare the patterns of audit behavior or observation to historical patterns of audit behavior or observation stored in the database, and
determine an outlier based on the comparison.

2. The audit system of claim 1, wherein the period of time is the execution of an audit.

3. The audit system of claim 1, wherein the second device is configured to perform the data analytics operation in real-time as the audit metadata is received.

4. The audit system of claim 3, wherein the second device is configured to transmit an alert when an outlier is determined.

5. The audit system of claim 3, wherein the alert is transmitted to a technical reviewer or an auditee.

6. The audit system of claim 1, wherein the sensor is selected from the group of consisting of: gyroscope, accelerometer, image sensor or camera, proximity sensor, and microphone sensor, or a combination thereof.

7. The audit system of claim 1, wherein the audit metadata includes electronic location information, timestamp information, specific gesture information, or duration information.

8. The audit system of claim 1, wherein the outlier is an indication of fraud or other malfeasance.

9. The audit system of claim 1, wherein at least one of the first or second device is a mobile device.

10. The audit system of claim 1, wherein the processor associated with the second device is configured to receive the pattern of behavior or observation completed by a particular auditor further generates a distance or path traveled by the auditor as the locations of the particular auditor are received by the first device.

11. The audit system of claim 10, wherein the specified patterns of fraudulent audit execution indicate that the net distance traveled is less than a threshold distance stored in the historical pattern of behavior or observation.

12. The audit system of claim 1, wherein the second device is configured to receive the audit metadata, and further wherein the second device derives a trust rating associated with a particular auditor based on the comparison of the audit metadata to the historical pattern of behavior or observation of the audit metadata.

13. A method of identifying an auditor based on electronic location information and qualifications or rating information comprising:
registering, by one or more processors, an auditee with an audit management system including a networked based system or device;
registering, by one or more processors, a plurality of auditors with the audit management system;
responsive to registering the auditee, determining a location and market segment of the auditee based on electronic location information and identity of the auditee;
responsive to registering each of the plurality of auditors, determine respective locations, qualifications, and rating of each of the plurality of auditors;
receiving, over the network, a request for an audit from the auditee;
responsive to receiving the audit request, automatically identifying, by the one or more processors, one or more auditors for conducting at least a portion of an audit;
transmitting, via the network, the audit request to the one or more identified auditors for fulfilment of the audit request; and
delivery of an audit report to the auditee.

14. The method of claim 13, wherein the one or more auditors includes technical reviewer.

15. The method of claim 13, wherein the market segment is the food industry.

16. The method of claim 13, wherein the one or more identified auditors bid on the audit request.

17. The method of claim 14, wherein the technical reviewer is blind to at least one of the identity of the first auditor and auditee.

18. A non-transitory computer readable medium residing on a computer readable storage device for processing audit metadata, the computer readable storage medium comprising instructions which, when executed by a processor coupled to the computer readable storage device, cause the processor to:
process, on a plurality of parallel audit processors that are instantiated on the processor, a plurality electronic metadata including behavior and observations generated by one or more auditors, wherein each electronic metadata in the plurality of electronic metadata has one of a plurality of unique identifiers that identifies the metadata as pertaining to a specific auditor, auditee, or audit site and
route received electronic metadata to one or more parallel audit processors wherein instructions which when executed by the processor cause the one or more audit processors to compare, using the one audit processor the received electronic metadata to historical electronic metadata stored in a database to determine if an outlier exists; and
execute, using the audit processor, an alert or notification when an outlier occurs for the received electronic metadata.

19. The non-transitory computer readable medium of claim 18, wherein the instructions which cause the processor to process the plurality of electronic metadata comprise instructions which cause the process to obtain, from the database, previous electronic metadata associated with the same auditor, auditee or audit site based on the unique identifier.

20. The non-transitory computer readable medium of claim 18, wherein the database includes storage for audit standards.

21. The non-transitory computer readable medium of claim 20, wherein the instructions which cause the processor to process the plurality of electronic metadata comprise instructions which cause the process to obtain, from the database, one or more audit standards and further comprise instructions which cause the processor to determine whether at least a portion of the electronic metadata is compliant with the one or more audit standards.

22. The non-transitory computer readable medium of claim 21, wherein the electronic metadata includes observations logged by the auditor during an audit of a site.

23. An audit device comprising:
a processor and a database, the device operatively connected to a first auditor device through a network interface and configured to receive audit metadata from at least the first auditor device, wherein the audit metadata includes behavior or observations of the auditor during a period of time; and
a data analytics module configured to receive the audit metadata and patterns of behavior or observations during the period of time; an compare the patterns of behavior or observations to historical patterns of behavior or observation stored in a database to determine an outlier based on the comparison.

24. The audit device of claim 23, wherein the period of time is the time to complete an an audit of a site.

25. The audit device of claim 23, wherein the data analytics module is configured to perform the data analytics operations in real-time as the audit metadata is received from one or more audit devices.

26. The audit device of claim 25, wherein the device is configured to transmit an alert notification when an outlier is determined.

27. The audit device of claim 25, wherein the alert notification is transmitted to a technical reviewer or an auditee.

28. The audit device of claim 23, wherein the sensor is selected from the group consisting of:
gyroscope, accelerometer, image sensor or camera, proximity sensor, and microphone sensor, or a combination thereof.

29. The audit device of claim 23, wherein the audit metadata includes electronic location information, timestamp information, specific gesture information, or duration information.

30. The audit device of claim 23, wherein the outlier is an indication of fraud or other malfeasance occurring during the audit.

31. The audit device of claim 23, wherein the processor is configured to receive the pattern of behavior or observation completed by a particular auditor and further generate a distance or path traveled by the auditor as the locations of the particular auditor are received by the device.

32. The audit device of claim 31, wherein specified patterns of fraudulent audit execution indicate that the net distance traveled is less than a threshold distance stored in the historical pattern of behavior or observation.

33. The audit device of claim 23, wherein the device is configured to receive the audit metadata, and further wherein the device derives a trust rating associated with a particular auditor based on the comparison of the audit metadata to the historical pattern of behavior or observation of the audit metadata.
